(19) United States
(12) Patent Application Publication
(10) Pub. No.: US 2026/0059398 A1
(43) Pub. Date: Feb. 26, 2026

(54) METHOD AND APPARATUS FOR IMPLEMENTING AI-ML IN A WIRELESS NETWORK

(71) Applicant: Harfang IP Investment Corporation, Round Rock, TX (US)

(72) Inventor: Sushil KUMAR, Haryana (IN)

(73) Assignee: Harfang IP Investment Corporation, Round Rock, TX (US)

(21) Appl. No.: 19/104,967

(22) PCT Filed: Aug. 21, 2023
(86) PCT No.: PCT/US2023/030703

§ 371 Date: Feb. 19, 2025

(30) Foreign Application Priority Data
Aug. 19, 2022 (IN) 202211047358

(51) Int. Cl. H04W 36/00; H04L 41/16

(52) U.S. Cl. CPC H04W 36/0061; H04L 41/16

(57) ABSTRACT

A method, an apparatus, and a computer readable medium for storing instructions are described for a user terminal and a base station for updating an AI/ML configuration in case of a handover. The method performed by a user equipment comprising operating a first AI/ML configuration in a coverage area of a first base station; receiving an AI/ML configuration information indicating a second AI/ML configuration; operating the second AI/ML configuration indicated by the AI/ML configuration information in the coverage area of a second base station. Operating a first AI/ML configuration comprises operating a first AI/ML Model or a first AI/ML Model with a first AI/ML Model configuration in the coverage area of the first base station. The first AI/ML Model is associated with a first AI/ML Model identifier and the first AI/ML Model configuration is associated with a first AI/ML Model configuration identifier. Operating the second AI/ML configuration comprises operating a second AI/ML Model or the first AI/ML Model with a second configuration in the coverage area of the second base station. The second AI/ML Model is associated with a second AI/ML Model identifier and the second AI/ML Model configuration is associated with a second AI/ML Model configuration identifier. Indicating the second AI/ML configuration comprises indicating a second AI/ML Model identifier and/or a second AI/ML Model configuration identifier.

### CROSS REFERENCE TO RELATED APPLICATIONS

This application claims the benefit of India application No. 202211047358, filed Aug. 19, 2022, the contents of which are incorporated by reference as if fully set forth.

### BACKGROUND

RP-213599, TSG RAN Meeting #94e, Dec. 6-17, 2021, available at, https://www.3gpp.org/ftp/TSG_RAN/TSG_RAN/TSGR_94e/Docs/RP-213599.zip

TR 38.901 V17.0.0

O-RAN Massive MIMO Use Cases Technical Report 1.0, July 2022

Draft Minutes Report TSG RAN TSGR1_109-e, available at https://www.3gpp.org/ftp/TSG_RAN/WG1_RL1/TSGR1_109-e/Report/Draft Minutes_report_RAN1% 23109-e_v030.zip

Deep Learning-based CSI Feedback Approach for Time-varying Massive MIMO Channels by Tianqi Wang, Chao-Kai Wen, Shi Jin, Geoffrey Ye Li (Published 31 Jul. 2018)

WO2021051362A1

US20210345134A1

US20190277957A1

### SUMMARY

A method, an apparatus, and a computer readable medium for storing instructions are described for a user terminal and a base station for updating an AI/ML configuration in case of a handover. In an embodiment, a method performed by a user equipment (UE) comprising: operating a first AI/ML Model with a first AI/ML Model configuration in the coverage of a first base station (BS1); transmitting, to the BS1, one or more UE parameters including UE speed, UE location, UE trajectory information, signal quality of BS1, and signal quality of a second base station (BS2); and receiving a first signaling by the UE, from the BS1, including information regarding a second AI/ML Model configuration; wherein the first signaling is transmitted by the BS1 based on the determination of a potential handover of the UE from the coverage of the BS1 to the coverage of the BS2; wherein the determination of handover is made based on the UE parameters. The information regarding the second AI/ML Model configuration include a second AI/ML Model configuration identifier. The first signaling is received in a handover command message.

In an embodiment, a method performed by a user equipment (UE) comprising: operating a first AI/ML Model with a first AI/ML Model configuration in the coverage of a first base station (BS1); transmitting, to the BS1, one or more UE parameters including UE speed, UE location, UE trajectory information, signal quality of BS1, and signal quality of a second base station (BS2); receiving a first signaling by the UE, from the BS1, including information regarding handover to the second base station (BS2); wherein the first signaling is transmitted by the BS1 based on the determination of a potential handover of the UE from the coverage of BS1 to the coverage of a second base station (BS2); wherein the determination of handover is made based on the UE parameters; transmitting by the UE, to the BS2, PRACH; and receiving a second signaling by the UE, from the BS2, including information regarding a second AI/ML Model configuration. The information regarding the second AI/ML Model configuration include a second AI/ML Model configuration identifier. The first signaling is received in a handover command message.

In an embodiment, an apparatus comprising: an AI/ML Engine configured to operate a first AI/ML Model with a first AI/ML Model configuration in the coverage of a first base station (BS1); a transceiver configured to transmit, to the BS1, one or more UE parameters including UE speed, UE location, UE trajectory information, signal quality of BS1, and signal quality of a second base station (BS2); the transceiver configured to receive a first signaling, from the BS1, including information regarding a second AI/ML Model configuration; wherein the first signaling is transmitted by the BS1 based on the determination of a potential handover of the UE from the coverage of the BS1 to the coverage of the BS2; wherein the determination of handover is made based on the UE parameters. The information regarding the second AI/ML Model configuration include a second AI/ML Model configuration identifier. The first signaling is received in a handover command message.

In an embodiment, an apparatus comprising: an AI/ML Engine configured to operate a first AI/ML Model with a first AI/ML Model configuration in the coverage of a first base station (BS1); a transceiver configured to transmit, to the BS1, one or more UE parameters including UE speed, UE location, UE trajectory information, signal quality of BS1, and signal quality of a second base station (BS2); the transceiver configured to receive a first signaling, from the BS1, including handover information to the second base station (BS2); wherein the first signaling is transmitted by the BS1 based on the determination of a potential handover of the UE from the coverage of BS1 to the coverage of a second base station (BS2); wherein the determination of handover is made based on the UE parameters; the transceiver configured to transmit, to the BS2, PRACH; and receiving a second signaling, from the BS2, including information regarding a second AI/ML Model configuration. The information regarding the second AI/ML Model configuration include a second AI/ML Model configuration identifier. The first signaling is received in a handover command message.

In an embodiment, a method performed by a user equipment (UE) comprising: operating a first AI/ML Model or a first set of AI/ML Models in the coverage of a first base station (BS1); transmitting, to the BS1, one or more UE parameters including UE speed, UE location, UE trajectory information, signal quality of BS1, and signal quality of a second base station (BS2); and receiving a first signaling by the UE, from the BS1, including information regarding a second AI/ML Model or a second set of AI/ML Models; wherein the first signaling is transmitted by the BS1 based on the determination of a potential handover of the UE from the coverage of the BS1 to the coverage of the BS2; wherein the determination of handover is made based on the UE parameters. The information regarding the second AI/ML Model configuration include a second AI/ML Model identifier or identifiers of second set of models. The first signaling is received in a handover command message.

In an embodiment, a method performed by a user equipment (UE) comprising: operating a first AI/ML Model or a first set of AI/ML Models in the coverage of a first base station (BS1); transmitting, to the BS1, one or more UE parameters including UE speed, UE location, UE trajectory information, signal quality of BS1, and signal quality of a second base station (BS2); receiving a first signaling by the UE, from the BS1, including information regarding handover to the second base station (BS2); wherein the first signaling is transmitted by the BS1 based on the determination of a potential handover of the UE from the coverage of BS1 to the coverage of a second base station (BS2); wherein the determination of handover is made based on the UE parameters; transmitting by the UE, to the BS2, PRACH; and receiving a second signaling by the UE, from the BS2, including information regarding a second AI/ML Model or a second set of AI/ML Models. The information regarding the second AI/ML Model configuration include a second AI/ML Model identifier or identifiers of second set of models. The first signaling is received in a handover command message.

In an embodiment, an apparatus comprising: an AI/ML Engine configured to operate a first AI/ML Model or a first set of AI/ML Models in the coverage of a first base station (BS1); a transceiver configured to transmit, to the BS1, one or more UE parameters including UE speed, UE location, UE trajectory information, signal quality of BS1, and signal quality of a second base station (BS2); the transceiver configured to receive a first signaling, from the BS1, including information regarding a second AI/ML Model or a second set of AI/ML Models; wherein the first signaling is transmitted by the BS1 based on the determination of a potential handover of the UE from the coverage of the BS1 to the coverage of the BS2; wherein the determination of handover is made based on the UE parameters. The information regarding the second AI/ML Model configuration include a second AI/ML Model identifier or identifiers of second set of models. The first signaling is received in a handover command message.

In an embodiment, an apparatus comprising: an AI/ML Engine configured to operate a first AI/ML Model or a first set of AI/ML Models in the coverage of a first base station (BS1); a transceiver configured to transmit, to the BS1, one or more UE parameters including UE speed, UE location, UE trajectory information, signal quality of BS1, and signal quality of a second base station (BS2); the transceiver configured to receive a first signaling, from the BS1, including handover information to the second base station (BS2); wherein the first signaling is transmitted by the BS1 based on the determination of a potential handover of the UE from the coverage of BS1 to the coverage of a second base station (BS2); wherein the determination of handover is made based on the UE parameters; the transceiver configured to transmit, to the BS2, PRACH; and receiving a second signaling, from the BS2, including information regarding a second AI/ML Model or a second set of AI/ML Models. The information regarding the second AI/ML Model configuration include a second AI/ML Model identifier or identifiers of second set of models. The first signaling is received in a handover command message.

In an embodiment, a method performed by a user equipment comprising operating a first AI/ML configuration in a coverage area of a first base station; receiving an AI/ML configuration information indicating a second AI/ML configuration; operating the second AI/ML configuration indicated by the AI/ML configuration information in the coverage area of a second base station. Operating a first AI/ML configuration comprises operating a first AI/ML Model or a first AI/ML Model with a first AI/ML Model configuration in the coverage area of the first base station. The first AI/ML Model is associated with a first AI/ML Model identifier and the first AI/ML Model configuration is associated with a first AI/ML Model configuration identifier. Operating the second AI/ML configuration comprises operating a second AI/ML Model or the first AI/ML Model with a second configuration in the coverage area of the second base station. The second AI/ML Model is associated with a second AI/ML Model identifier and the second AI/ML Model configuration is associated with a second AI/ML Model configuration identifier. Indicating the second AI/ML configuration comprises indicating a second AI/ML Model identifier and/or a second AI/ML Model configuration identifier. The AI/ML configuration information may be received in a handover command message, or the AI/ML configuration information may be received in RACH response message. The AI/ML configuration information may be received in a message transmitted by the first base station, or the AI/ML configuration information may be received in a message transmitted by the second base station. The AI/ML configuration information is received after initiation of a handover process in the first base station for handing over the user equipment to the coverage area of the second base station, or the AI/ML configuration information is received before the initiation of a handover process in the first base station for handing over the user equipment to the coverage area of the second base station.

In an embodiment, a method performed by a first base station comprising: transmitting an AI/ML configuration information indicating a second AI/ML configuration to a user equipment operating a first AI/ML configuration in a coverage area of the first base station; wherein the second AI/ML configuration is used by the user equipment in the coverage area of a second base station. Operating the first AI/ML configuration comprises operating a first AI/ML Model or a first AI/ML Model with a first configuration in the coverage area of the first base station. The first AI/ML Model is associated with a first AI/ML Model identifier and the first AI/ML Model configuration is associated with a first AI/ML Model configuration identifier. Operating the second AI/ML configuration comprises operating a second AI/ML Model or a first AI/ML Model with a second AI/ML Model configuration in the coverage area of the second base station. The second AI/ML Model is associated with a second AI/ML Model identifier and the second AI/ML Model configuration is associated with a second AI/ML Model configuration identifier. Indicating the second AI/ML configuration comprises indicating a second AI/ML Model identifier and/or a second AI/ML Model configuration identifier. The AI/ML configuration information may be transmitted in a handover command message. The AI/ML configuration information is transmitted after initiation of a handover process in the first base station for handing over the user equipment to the coverage area of the second base station, or the AI/ML configuration information is transmitted before the initiation of a handover process in the first base station for handing over the user equipment to the coverage area of the second base station.

In an embodiment, an apparatus comprising: a memory; an AI/ML Engine configured to operate a first AI/ML configuration in a coverage area of a first base station; and a transceiver configured to receive an AI/ML configuration information including an information of a second AI/ML configuration; wherein the AI/ML Engine operate the second AI/ML configuration indicated by the AI/ML configuration information in the coverage area of a second base station. The AI/ML Engine configured to operate a first AI/ML configuration comprises execution of a first AI/ML Model or a first AI/ML Model with a first AI/ML Model configuration in the coverage area of the first base station. The first AI/ML Model is associated with a first AI/ML Model identifier and the first AI/ML Model configuration is associated with a first AI/ML Model configuration identifier. The AI/ML Engine configured to operate the second AI/ML configuration comprises execution of a second AI/ML Model or the first AI/ML Model with a second configuration in the coverage area of the second base station. The second AI/ML Model is associated with a second AI/ML Model identifier and the second AI/ML Model configuration is associated with a second AI/ML Model configuration identifier. The information of the second AI/ML configuration comprises a second AI/ML Model identifier and/or a second AI/ML Model configuration identifier. The AI/ML configuration information may be received in a handover command message, or the AI/ML configuration information may be received in RACH response message. The AI/ML configuration information may be received in a message transmitted by the first base station, or the AI/ML configuration information may be received in a message transmitted by the second base station. The AI/ML configuration information is received after initiation of a handover process in the first base station for handing over the user equipment to the coverage area of the second base station, or the AI/ML configuration information is received before the initiation of a handover process in the first base station for handing over the user equipment to the coverage area of the second base station.

In an embodiment, a first base station comprising: a memory; and a transceiver configured to transmit an AI/ML configuration information including an information of a second AI/ML configuration to a user equipment; wherein the user equipment is configured to operate a first AI/ML configuration in a coverage area of the first base station; wherein the user equipment is configured to operate the second AI/ML configuration in a coverage area of a second base station based on the transmitted information of the second AI/ML configuration. The user equipment configured to operate a first AI/ML configuration comprises operation of a first AI/ML Model or a first AI/ML Model with a first configuration in the coverage area of the first base station. The first AI/ML Model is associated with a first AI/ML Model identifier and the first AI/ML Model configuration is associated with a first AI/ML Model configuration identifier. The user equipment configured to operate the second AI/ML configuration comprises operation of a second AI/ML Model or a first AI/ML Model with a second AI/ML Model configuration in the coverage area of the second base station. The second AI/ML Model is associated with a second AI/ML Model identifier and the second AI/ML Model configuration is associated with a second AI/ML Model configuration identifier. The information of the second AI/ML configuration comprises a second AI/ML Model identifier and/or a second AI/ML Model configuration identifier. The AI/ML configuration information may be transmitted in a handover command message. The AI/ML configuration information is transmitted after initiation of a handover process in the first base station for handing over the user equipment to the coverage area of the second base station, or the AI/ML configuration information is transmitted before the initiation of a handover process in the first base station for handing over the user equipment to the coverage area of the second base station.

In an embodiment, a first non-transitory computer-readable medium comprising instructions operable to cause a processor or a plurality of processors to receive, from a base station, an AI/ML configuration information including an information of a second AI/ML configuration; a second non-transitory computer-readable medium comprising instructions operable to cause an AI/ML Engine to operate a first AI/ML configuration in a coverage area of a first base station and operate the second AI/ML configuration indicated by the AI/ML configuration information in the coverage area of a second base station. The instructions operable to cause AI/ML Engine to operate a first AI/ML configuration comprises instructions for execution of a first AI/ML Model or a first AI/ML Model with a first AI/ML Model configuration in the coverage area of the first base station. The first AI/ML Model is associated with a first AI/ML Model identifier and the first AI/ML Model configuration is associated with a first AI/ML Model configuration identifier. The instructions operable to cause the AI/ML Engine to operate the second AI/ML configuration comprises instructions for execution of a second AI/ML Model or the first AI/ML Model with a second configuration in the coverage area of the second base station. The second AI/ML Model is associated with a second AI/ML Model identifier and the second AI/ML Model configuration is associated with a second AI/ML Model configuration identifier. The information of the second AI/ML configuration comprises a second AI/ML Model identifier and/or a second AI/ML Model configuration identifier. The AI/ML configuration information may be received in a handover command message, or the AI/ML configuration information may be received in RACH response message. The AI/ML configuration information may be received in a message transmitted by the first base station, or the AI/ML configuration information may be received in a message transmitted by the second base station. The AI/ML configuration information is received after initiation of a handover process in the first base station for handing over the user equipment to the coverage area of the second base station, or the AI/ML configuration information is received before the initiation of a handover process in the first base station for handing over the user equipment to the coverage area of the second base station.

In an embodiment, a first non-transitory computer-readable medium comprising instructions operable to cause a processor or a plurality of processors to transmit an AI/ML configuration information including an information of a second AI/ML configuration to a user equipment; wherein the user equipment is configured to operate a first AI/ML configuration in a coverage area of the first base station; wherein the user equipment is configured to operate the second AI/ML configuration in a coverage area of a second base station based on the transmitted information of the second AI/ML configuration. The user equipment configured to operate a first AI/ML configuration comprises operation of a first AI/ML Model or a first AI/ML Model with a first configuration in the coverage area of the first base station. The first AI/ML Model is associated with a first AI/ML Model identifier and the first AI/ML Model configuration is associated with a first AI/ML Model configuration identifier. The user equipment configured to operate the second AI/ML configuration comprises operation of a second AI/ML Model or a first AI/ML Model with a second AI/ML Model configuration in the coverage area of the second base station. The second AI/ML Model is associated with a second AI/ML Model identifier and the second AI/ML Model configuration is associated with a second AI/ML Model configuration identifier. The information of the second AI/ML configuration comprises a second AI/ML Model identifier and/or a second AI/ML Model configuration identifier. The AI/ML configuration information may be transmitted in a handover command message. The AI/ML configuration information is transmitted after initiation of a handover process in the first base station for handing over the user equipment to the coverage area of the second base station, or the AI/ML configuration information is transmitted before the initiation of a handover process in the first base station for handing over the user equipment to the coverage area of the second base station.

In accordance with an embodiment, a method performed by a user equipment comprising: receiving an AI/ML model information from a first base station; wherein the AI/ML model information includes first information of a first plurality of AI/ML models to be used for communicating with the first base station and second information of a second plurality of AI/ML models to be used for communicating with a second base station; receiving an AI/ML model activation information from the first base station; wherein the AI/ML model activation information includes third information of one or more AI/ML models to be activated for communicating with the first base station from the first plurality of AI/ML models and fourth information of one or more AI/ML models to be activated for communicating with the second base station from the second plurality of AI/ML models; activating one or more AI/ML models from the first plurality of AI/ML models based on the received third information; activating one or more AI/ML models from the second plurality of AI/ML models based on the received fourth information; transmitting/receiving, signals or channels, to/from the first base station using the activated one or more AI/ML models from the first plurality of AI/ML models; and transmitting/receiving, signals or channels, to/from the second base station using the activated one or more AI/ML models from the second plurality of AI/ML models. The AI/ML model information is received in the RRC messages. The AI/ML model activation information is received in the physical layer messages (for example, a DCI) or a MAC layer message. The first information and second information may include one or more of identifiers or indices of the AI/ML models, identifiers or indices of AI/ML model families, or identifiers or indices of AI/ML model configurations. The third information and fourth information may include a bit pattern where each bit indicate activation/deactivation status of an AI/ML model. In the bit pattern, bits are arranged according to a predefined order of identifiers or indices AI/ML model. For example, LSB corresponds to the AI/ML model with the smallest index and MSB corresponds to the AI/ML model with the largest index. Similarly, The third information and fourth information may include a bit pattern for indicating AI/ML model configurations.

In accordance with an embodiment, a method performed by a user equipment comprising: receiving an AI/ML model information from a first base station; wherein the AI/ML model information includes first information of a first plurality of AI/ML models to be used for communicating with the first base station and second information of a second plurality of AI/ML models to be used for communicating with a second base station; receiving a first AI/ML model activation information from the first base station; wherein the first AI/ML model activation information includes information of one or more AI/ML models to be activated for communicating with the first base station from the first plurality of AI/ML models; receiving a second AI/ML model activation information from the second base station; wherein the second AI/ML model activation information includes information of one or more AI/ML models to be activated for communicating with the second base station from the second plurality of AI/ML models; activating one or more AI/ML models from the first plurality of AI/ML models based on the received first AI/ML model activation information; activating one or more AI/ML models from the second plurality of AI/ML models based on the received second AI/ML model activation information; transmitting/receiving, signals or channels, to/from the first base station using the activated one or more AI/ML models from the first plurality of AI/ML models; and transmitting/receiving, signals or channels, to/from the second base station using the activated one or more AI/ML models from the second plurality of AI/ML models. The AI/ML model information is received in the RRC messages. The first and second AI/ML model activation information is received in the respective physical layer message (for example, a DCI) or a MAC layer message. The first information and second information may include one or more of identifiers or indices of the AI/ML models, identifiers or indices of AI/ML model families, or identifiers or indices of AI/ML model configurations. The first and second AI/ML model activation information may include a bit pattern where each bit indicate activation/deactivation status of an AI/ML model. In the bit pattern, bits are arranged according to a predefined order of identifiers or indices AI/ML model. For example, LSB corresponds to the AI/ML model with the smallest index and MSB corresponds to the AI/ML model with the largest index. Similarly, The first and second AI/ML model activation information may include a bit pattern for indicating AI/ML model configurations.

In accordance with an embodiment, a method performed by a user equipment comprising: receiving a first AI/ML model information from a first base station; wherein the first AI/ML model information includes information of a first plurality of AI/ML models to be used for communicating with the first base station; receiving a second AI/ML model information from a second base station; wherein the second AI/ML model information includes information of a second plurality of AI/ML models to be used for communicating with a second base station; receiving a first AI/ML model activation information from the first base station; wherein the first AI/ML model activation information includes information of one or more AI/ML models to be activated for communicating with the first base station from the first plurality of AI/ML models; receiving a second AI/ML model activation information from the second base station; wherein the second AI/ML model activation information includes information of one or more AI/ML models to be activated for communicating with the second base station from the second plurality of AI/ML models; activating one or more AI/ML models from the first plurality of AI/ML models based on the received first AI/ML model activation information; activating one or more AI/ML models from the second plurality of AI/ML models based on the received second AI/ML model activation information; transmitting/receiving, signals or channels, to/from the first base station using the activated one or more AI/ML models from the first plurality of AI/ML models; and transmitting/receiving, signals or channels, to/from the second base station using the activated one or more AI/ML models from the second plurality of AI/ML models. The first AI/ML model information and second AI/ML model information are received in the RRC messages. The first and second AI/ML model activation information is received in the respective physical layer message (for example, a DCI) or a MAC layer message. The first AI/ML model information and second AI/ML model information may include one or more of identifiers or indices of the AI/ML models, identifiers or indices of AI/ML model families, or identifiers or indices of AI/ML model configurations. The first and second AI/ML model activation information may include a bit pattern where each bit indicate the activation/deactivation status of an AI/ML model. In the bit pattern, bits are arranged according to a predefined order of identifiers or indices AI/ML model. For example, LSB corresponds to the AI/ML model with the smallest index and MSB corresponds to the AI/ML model with the largest index. Similarly, The first and second AI/ML model activation information may include a bit pattern for indicating AI/ML model configurations.

In accordance with an embodiment, a method performed by a first base station comprising: transmitting an AI/ML model information to a user equipment; wherein the AI/ML model information includes first information of a first plurality of AI/ML models to be used for communicating with the first base station and the user equipment and second information of a second plurality of AI/ML models to be used for communicating with a second base station and the user equipment; transmitting an AI/ML model activation information to the user equipment; wherein the AI/ML model activation information includes third information of one or more AI/ML models to be activated for communicating with the user equipment and the first base station from the first plurality of AI/ML models and fourth information of one or more AI/ML models to be activated for communicating with the user equipment and the second base station from the second plurality of AI/ML models; and transmitting signals or channels, to the user equipment, to be decoded using the activated one or more AI/ML models from the first plurality of AI/ML models, or receiving signals or channels, from the user equipment generated using the activated one or more AI/ML models from the first plurality of AI/ML models. The AI/ML model information is transmitted in the RRC messages. The AI/ML model activation information is transmitted in the physical layer messages (for example, a DCI) or a MAC layer message. The first information and second information may include one or more of identifiers or indices of the AI/ML models, identifiers or indices of AI/ML model families, or identifiers or indices of AI/ML model configurations. The third information and fourth information may include a bit pattern where each bit indicate activation/deactivation status of an AI/ML model. In the bit pattern, bits are arranged according to a predefined order of identifiers or indices AI/ML model. For example, LSB corresponds to the AI/ML model with the smallest index and MSB corresponds to the AI/ML model with the largest index. Similarly, The third information and fourth information may include a bit pattern for indicating AI/ML model configurations.

In accordance with an embodiment, a method performed by a first base station comprising: transmitting an AI/ML model information to a user equipment; wherein the AI/ML model information includes a first information of a first plurality of AI/ML models to be used for communicating with the user equipment and the first base station and a second information of a second plurality of AI/ML models to be used for communicating with the user equipment and a second base station; transmitting a first AI/ML model activation information from to the user equipment; wherein the first AI/ML model activation information includes information of one or more AI/ML models to be activated for communicating with the first base station from the first plurality of AI/ML models; and transmitting signals or channels, to the user equipment, to be decoded using the activated one or more AI/ML models from the first plurality of AI/ML models, or receiving signals or channels, from the user equipment generated using the activated one or more AI/ML models from the first plurality of AI/ML models. The AI/ML model information is transmitted in the RRC messages. The first AI/ML model activation information is transmitted in the physical layer message (for example, a DCI) or a MAC layer message. The first information and second information may include one or more of identifiers or indices of the AI/ML models, identifiers or indices of AI/ML model families, or identifiers or indices of AI/ML model configurations. The first AI/ML model activation information may include a bit pattern where each bit indicate activation/deactivation status of an AI/ML model. In the bit pattern, bits are arranged according to a predefined order of identifiers or indices AI/ML model. For example, LSB corresponds to the AI/ML model with the smallest index and MSB corresponds to the AI/ML model with the largest index. Similarly, The first AI/ML model activation information may include a bit pattern for indicating AI/ML model configurations.

In accordance with an embodiment, a method performed by a first base station comprising: transmitting a first AI/ML model information to a user equipment; wherein the first AI/ML model information includes information of a first plurality of AI/ML models to be used for communicating with the user equipment and the first base station; transmitting a first AI/ML model activation information to the user equipment; wherein the first AI/ML model activation information includes information of one or more AI/ML models to be activated for communicating with the user equipment from the first plurality of AI/ML models; and transmitting signals or channels, to the user equipment, to be decoded using the activated one or more AI/ML models from the first plurality of AI/ML models, or receiving signals or channels, from the user equipment generated using the activated one or more AI/ML models from the first plurality of AI/ML models. The first AI/ML model information is transmitted in the RRC messages. The first AI/ML model activation information is transmitted in the physical layer message (for example, a DCI) or a MAC layer message. The first AI/ML model information may include one or more of identifiers or indices of the AI/ML models, identifiers or indices of AI/ML model families, or identifiers or indices of AI/ML model configurations. The first AI/ML model activation information may include a bit pattern where each bit indicate the activation/deactivation status of an AI/ML model. In the bit pattern, bits are arranged according to a predefined order of identifiers or indices AI/ML model. For example, LSB corresponds to the AI/ML model with the smallest index and MSB corresponds to the AI/ML model with the largest index. Similarly, The first AI/ML model activation information may include a bit pattern for indicating AI/ML model configurations.

In accordance with an embodiment, a user equipment comprising: an AI/ML engine configured to operate a plurality of AI/ML Models; wherein an AI/ML model is associated with an AI/ML Model family; wherein the AI/ML Model is associated with one or more AI/ML Model configurations; a transceiver configured to transmit information containing identifiers of one or more of supported AI/ML Model families, AI/ML Models and AI/ML Model configurations. In an embodiment, information containing identifiers is a bit pattern where each bit indicates an AI/ML Model families, AI/ML Models and AI/ML Model configurations in a predefined order. For example, AI/ML Models may be indicated in an increasing order where LSB bit indicates AI/ML model with the smallest index (or smallest identifier). Similarly, a separate bit pattern may be used for indicating the AI/ML Model families, or AI/ML Model configurations.

In accordance with an embodiment, a user equipment comprising: an AI/ML engine configured to operate a plurality of AI/ML Models; wherein an AI/ML model is associated with an AI/ML Model family; wherein the AI/ML Model is associated with one or more AI/ML Model configurations; a transceiver configured to receive information from a base station containing identifiers of one or more of supported AI/ML Model families, AI/ML Models and AI/ML Model configurations to be used by the user equipment. In an embodiment, information containing identifiers is a bit pattern where each bit indicates an AI/ML Model families, AI/ML Models and AI/ML Model configurations in a predefined order. For example, AI/ML Models may be indicated in an increasing order where LSB bit indicates AI/ML model with the smallest index (or smallest identifier). Similarly, a separate bit pattern may be used for indicating the AI/ML Model families, or AI/ML Model configurations.

In accordance with an embodiment, a user equipment comprising: an AI/ML engine configured to execute a processing task by using one or more AI/ML Models; a Non-AI/ML Signal Processing Module; a transceiver configured to transmit information indicating switching of the processing task from the AI/ML engine to the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if the processing task is switched from the AI/ML engine to the Non-AI/ML Signal Processing Module.

In accordance with an embodiment, a user equipment comprising: an AI/ML engine configured to execute a processing task by using one or more AI/ML Models; a Non-AI/ML Signal Processing Module; a transceiver configured to receive information from a base station indicating switching of the processing task from the AI/ML engine to the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if the processing task is switched from the AI/ML engine to the Non-AI/ML Signal Processing Module.

In accordance with an embodiment, a user equipment comprising: an AI/ML engine; a Non-AI/ML Signal Processing Module configured to execute a processing task; a transceiver configured to transmit information indicating switching of the processing task from the Non-AI/ML Signal Processing Module to the AI/ML engine. In an embodiment, information indicating switching of the processing task from the Non-AI/ML Signal Processing Module to the AI/ML engine comprises one or more of processing task identifier (or index), AI/ML model identifier (or index), AI/ML model configuration identifier (or index), or a flag bit indicating the switching. In an embodiment, the flag bit indicating the switching is set to ‘0’ if the processing task is switched from the Non-AI/ML Signal Processing Module to the AI/ML engine.

In accordance with an embodiment, a user equipment comprising: an AI/ML engine; a Non-AI/ML Signal Processing Module configured to execute a processing task; a transceiver configured to receive information from a base station indicating switching of the processing task from the Non-AI/ML Signal Processing Module to the AI/ML engine. In an embodiment, information indicating switching of the processing task from the Non-AI/ML Signal Processing Module to the AI/ML engine comprises one or more of processing task identifier (or index), AI/ML model identifier (or index), AI/ML model configuration identifier (or index), or a flag bit indicating the switching. In an embodiment, the flag bit indicating the switching is set to ‘0’ if the processing task is switched from the Non-AI/ML Signal Processing Module to the AI/ML engine.

In accordance with an embodiment, a user equipment comprising: an AI/ML engine configured to execute a first processing task by using a first AI/ML Model and a second processing task by using a second AI/ML Model; a Non-AI/ML Signal Processing Module; a transceiver configured to transmit information indicating switching of the first processing task from the AI/ML engine to the Non-AI/ML Signal Processing Module; wherein the second processing task is not switched to the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if a processing task is switched from the AI/ML engine to the Non-AI/ML Signal Processing Module.

In accordance with an embodiment, a user equipment comprising: an AI/ML engine configured to execute a first processing task by using a first AI/ML Model and a second processing task by using a second AI/ML Model; a Non-AI/ML Signal Processing Module; a transceiver configured to receive information from a base station indicating switching of the first processing task from the AI/ML engine to the Non-AI/ML Signal Processing Module; wherein the second processing task is not switched to the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if a processing task is switched from the AI/ML engine to the Non-AI/ML Signal Processing Module.

In accordance with an embodiment, a user equipment comprising: an AI/ML engine configured to execute a first processing task by using a first AI/ML Model and a second processing task by using a second AI/ML Model; a Non-AI/ML Signal Processing Module configured to execute a third processing task; a transceiver configured to transmit information indicating switching of the first processing task from the AI/ML engine to the Non-AI/ML Signal Processing Module and information indicating switching of the third processing task from the Non-AI/ML Signal Processing Module to the AI/ML engine; wherein the second processing task is not switched to the Non-AI/ML Signal Processing Module. In an embodiment, information indicating switching of the first processing task from the AI/ML engine to the Non-AI/ML Signal Processing Module and information indicating switching of the third processing task from the Non-AI/ML Signal Processing Module to the AI/ML engine comprises one or more of processing task identifiers (or indices), AI/ML model identifiers (or indices), AI/ML model configuration identifiers (or indices), or a flag bits indicating the switching. In an embodiment, the flag bits indicating the tasks switching is set to ‘101’ if the first processing task is switched from the AI/ML engine to the Non-AI/ML Signal Processing Module, the second processing task is not switched, the third processing task is switched the Non-AI/ML Signal Processing Module to the AI/ML. In an embodiment, the flag bits indicate task indices defined in a predefined order. For example, the predefined order may be set to an increasing order where LSB bit is set for task with the smallest index. In an embodiment, the flag bits indicating the tasks switching are set separately for the tasks associated with the AI/ML engine from the tasks associated with the Non-AI/ML Signal Processing Module. In an embodiment, the flag bits indicating the tasks switching are set such that MSB indicates the AI/ML engine or the Non-AI/ML Signal Processing Module, and remaining bits indicate the tasks switching. For example, “1100” indicates for AI/ML engine (MSB set to ‘1’ indicates AI/ML engine) switching third task to the AI/ML engine. Similarly, “0001” indicates for Non-AI/ML Signal Processing Module (MSB set to ‘0’ indicates Non-AI/ML Signal Processing Module) switching first task to the Non-AI/ML Signal Processing Module.

In accordance with an embodiment, a user equipment comprising: an AI/ML engine configured to execute a first processing task by using a first AI/ML Model and a second processing task by using a second AI/ML Model; a Non-AI/ML Signal Processing Module configured to execute a third processing task; a transceiver configured to receive information from a base station indicating switching of the first processing task from the AI/ML engine to the Non-AI/ML Signal Processing Module and information indicating switching of the third processing task from the Non-AI/ML Signal Processing Module to the AI/ML engine; wherein the second processing task is not switched to the Non-AI/ML Signal Processing Module. In an embodiment, information indicating switching of the first processing task from the AI/ML engine to the Non-AI/ML Signal Processing Module and information indicating switching of the third processing task from the Non-AI/ML Signal Processing Module to the AI/ML engine comprises one or more of processing task identifiers (or indices), AI/ML model identifiers (or indices), AI/ML model configuration identifiers (or indices), or a flag bits indicating the switching. In an embodiment, the flag bits indicating the tasks switching is set to ‘101’ if the first processing task is switched from the AI/ML engine to the Non-AI/ML Signal Processing Module, the second processing task is not switched, the third processing task is switched the Non-AI/ML Signal Processing Module to the AI/ML. In an embodiment, the flag bits indicate task indices defined in a predefined order. For example, the predefined order may be set to an increasing order where LSB bit is set for task with the smallest index. In an embodiment, the flag bits indicating the tasks switching are set separately for the tasks associated with the AI/ML engine from the tasks associated with the Non-AI/ML Signal Processing Module. In an embodiment, the flag bits indicating the tasks switching are set such that MSB indicates the AI/ML engine or the Non-AI/ML Signal Processing Module, and remaining bits indicate the tasks switching. For example, “1100” indicates for AI/ML engine (MSB set to ‘1’ indicates AI/ML engine) switching third task to the AI/ML engine. Similarly, “0001” indicates for Non-AI/ML Signal Processing Module (MSB set to ‘0’ indicates Non-AI/ML Signal Processing Module) switching first task to the Non-AI/ML Signal Processing Module.

In accordance with an embodiment, a base station comprising: an AI/ML engine configured to operate a plurality of AI/ML Models; wherein an AI/ML model is associated with an AI/ML Model family; wherein the AI/ML Model is associated with one or more AI/ML Model configurations; a transceiver configured to receive information containing identifiers of one or more of user equipment supported AI/ML Model families, AI/ML Models and AI/ML Model configurations; and a comparison module for comparing the user equipment supported AI/ML Model families, AI/ML Models and AI/ML Model configurations and base station supported AI/ML Model families, AI/ML Models and AI/ML Model configurations. In an embodiment, information containing identifiers is a bit pattern where each bit indicates an AI/ML Model families, AI/ML Models and AI/ML Model configurations in a predefined order. For example, AI/ML Models may be indicated in an increasing order where LSB bit indicates AI/ML model with the smallest index (or smallest identifier). Similarly, a separate bit pattern may be used for indicating the AI/ML Model families, or AI/ML Model configurations.

In accordance with an embodiment, a base station comprising: an AI/ML engine configured to operate a plurality of AI/ML Models; wherein an AI/ML model is associated with an AI/ML Model family; wherein the AI/ML Model is associated with one or more AI/ML Model configurations; a transceiver configured to transmit information containing identifiers of one or more of base station supported AI/ML Model families, AI/ML Models and AI/ML Model configurations. In an embodiment, information containing identifiers is a bit pattern where each bit indicates an AI/ML Model families, AI/ML Models and AI/ML Model configurations in a predefined order. For example, AI/ML Models may be indicated in an increasing order where LSB bit indicates AI/ML model with the smallest index (or smallest identifier). Similarly, a separate bit pattern may be used for indicating the AI/ML Model families, or AI/ML Model configurations.

In accordance with an embodiment, a base station comprising: a transceiver configured to receive information from a user equipment indicating switching of a processing task from an AI/ML engine to a Non-AI/ML Signal Processing Module; wherein the user equipment comprises the AI/ML engine configured to execute the processing task by using one or more AI/ML Models and the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if the processing task is switched from the AI/ML engine to the Non-AI/ML Signal Processing Module.

In accordance with an embodiment, a base station comprising: a transceiver configured to transmit information to a user equipment indicating switching of a processing task from an AI/ML engine to a Non-AI/ML Signal Processing Module; wherein the user equipment comprises the AI/ML engine configured to execute the processing task by using one or more AI/ML Models and the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if the processing task is switched from the AI/ML engine to the Non-AI/ML Signal Processing Module.

In accordance with an embodiment, a base station comprising: a transceiver configured to transmit information to a user equipment indicating switching of a processing task from a Non-AI/ML Signal Processing Module to an AI/ML engine; wherein the user equipment comprises the AI/ML engine and the Non-AI/ML Signal Processing Module configured to execute the processing task. In an embodiment, information indicating switching of the processing task from the Non-AI/ML Signal Processing Module to the AI/ML engine comprises one or more of processing task identifier (or index), AI/ML model identifier (or index), AI/ML model configuration identifier (or index), or a flag bit indicating the switching. In an embodiment, the flag bit indicating the switching is set to ‘0’ if the processing task is switched from the Non-AI/ML Signal Processing Module to the AI/ML engine.

In accordance with an embodiment, a base station comprising: a transceiver configured to receive information from a user equipment indicating switching of the processing task from the Non-AI/ML Signal Processing Module to the AI/ML engine; wherein the user equipment comprises the AI/ML engine and the Non-AI/ML Signal Processing Module configured to execute the processing task. In an embodiment, information indicating switching of the processing task from the Non-AI/ML Signal Processing Module to the AI/ML engine comprises one or more of processing task identifier (or index), AI/ML model identifier (or index), AI/ML model configuration identifier (or index), or a flag bit indicating the switching. In an embodiment, the flag bit indicating the switching is set to ‘0’ if the processing task is switched from the Non-AI/ML Signal Processing Module to the AI/ML engine.

In accordance with an embodiment, a base station comprising: a transceiver configured to transmit information to a user equipment indicating switching of a first processing task from an AI/ML engine to a Non-AI/ML Signal Processing Module; wherein the user equipment comprises the AI/ML engine configured to execute the first processing task by using a first AI/ML Model and the second processing task by using a second AI/ML Model and the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if a processing task is switched from the AI/ML engine to the Non-AI/ML Signal Processing Module.

In accordance with an embodiment, a base station comprising: a transceiver configured to receive information from a user equipment indicating switching of a first processing task from an AI/ML engine to a Non-AI/ML Signal Processing Module; wherein the user equipment comprises the AI/ML engine configured to execute the first processing task by using a first AI/ML Model and a second processing task by using a second AI/ML Model and the Non-AI/ML Signal Processing Module. In an embodiment, information indicating switching of the processing task from the AI/ML engine to the Non-AI/ML Signal Processing Module comprises one or more of processing task identifier (or index), AI/ML model identifier (or index), AI/ML model configuration identifier (or index), or a flag bit indicating the switching. In an embodiment, the flag bit indicating the switching is set to ‘1’ if a processing task is switched from the AI/ML engine to the Non-AI/ML Signal Processing Module.

In accordance with an embodiment, a base station comprising: a transceiver configured to receive information from a user equipment indicating switching of a first processing task from an AI/ML engine to a Non-AI/ML Signal Processing Module and information indicating switching of a third processing task from the Non-AI/ML Signal Processing Module to the AI/ML engine; wherein the user equipment comprises the AI/ML engine configured to execute the first processing task by using a first AI/ML Model and a second processing task by using a second AI/ML Model and the Non-AI/ML Signal Processing Module configured to execute the third processing task. In an embodiment, information indicating switching of the first processing task from the AI/ML engine to the Non-AI/ML Signal Processing Module and information indicating switching of the third processing task from the Non-AI/ML Signal Processing Module to the AI/ML engine comprises one or more of processing task identifiers (or indices), AI/ML model identifiers (or indices), AI/ML model configuration identifiers (or indices), or a flag bits indicating the switching. In an embodiment, the flag bits indicating the tasks switching is set to ‘101’ if the first processing task is switched from the AI/ML engine to the Non-AI/ML Signal Processing Module, the second processing task is not switched, the third processing task is switched the Non-AI/ML Signal Processing Module to the AI/ML. In an embodiment, the flag bits indicate task indices defined in a predefined order. For example, the predefined order may be set to an increasing order where LSB bit is set for task with the smallest index. In an embodiment, the flag bits indicating the tasks switching are set separately for the tasks associated with the AI/ML engine from the tasks associated with the Non-AI/ML Signal Processing Module. In an embodiment, the flag bits indicating the tasks switching are set such that MSB indicates the AI/ML engine or the Non-AI/ML Signal Processing Module, and remaining bits indicate the tasks switching. For example, “1100” indicates for AI/ML engine (MSB set to ‘1’ indicates AI/ML engine) switching third task to the AI/ML engine. Similarly, “0001” indicates for Non-AI/ML Signal Processing Module (MSB set to ‘0’ indicates Non-AI/ML Signal Processing Module) switching first task to the Non-AI/ML Signal Processing Module.

In accordance with an embodiment, a base station comprising: a transceiver configured to transmit information to a user equipment indicating switching of a first processing task from an AI/ML engine to a Non-AI/ML Signal Processing Module and information indicating switching of a third processing task from the Non-AI/ML Signal Processing Module to the AI/ML engine; wherein the user equipment comprises the AI/ML engine configured to execute the first processing task by using a first AI/ML Model and a second processing task by using a second AI/ML Model and the Non-AI/ML Signal Processing Module configured to execute the third processing task. In an embodiment, information indicating switching of the first processing task from the AI/ML engine to the Non-AI/ML Signal Processing Module and information indicating switching of the third processing task from the Non-AI/ML Signal Processing Module to the AI/ML engine comprises one or more of processing task identifiers (or indices), AI/ML model identifiers (or indices), AI/ML model configuration identifiers (or indices), or a flag bits indicating the switching. In an embodiment, the flag bits indicating the tasks switching is set to ‘101’ if the first processing task is switched from the AI/ML engine to the Non-AI/ML Signal Processing Module, the second processing task is not switched, the third processing task is switched the Non-AI/ML Signal Processing Module to the AI/ML. In an embodiment, the flag bits indicate task indices defined in a predefined order. For example, the predefined order may be set to an increasing order where LSB bit is set for task with the smallest index. In an embodiment, the flag bits indicating the tasks switching are set separately for the tasks associated with the AI/ML engine from the tasks associated with the Non-AI/ML Signal Processing Module. In an embodiment, the flag bits indicating the tasks switching are set such that MSB indicates the AI/ML engine or the Non-AI/ML Signal Processing Module, and remaining bits indicate the tasks switching. For example, “1100” indicates for AI/ML engine (MSB set to ‘1’ indicates AI/ML engine) switching third task to the AI/ML engine. Similarly, “0001” indicates for Non-AI/ML Signal Processing Module (MSB set to ‘0’ indicates Non-AI/ML Signal Processing Module) switching first task to the Non-AI/ML Signal Processing Module.

### BRIEF DESCRIPTION OF THE DRAWINGS

FIG. 1a is an architecture of a wireless radio system according to an embodiment.

FIG. 1b is a diagram of a user plane protocol stack in a wireless radio system according to an embodiment.

FIG. 1c is a diagram of a control plane protocol stack in a wireless radio system according to an embodiment.

FIG. 2 is a block diagram of a first embodiment related to a user equipment.

FIG. 3 is a block diagram of a first embodiment related to a base station.

FIG. 4 is a block diagram of an AI Engine according to an embodiment.

FIG. 5a is a block diagram of a second embodiment related to a user equipment.

FIG. 5b is a block diagram of a third embodiment related to a user equipment.

FIG. 6a is a block diagram of a second embodiment related to a base station.

FIG. 6b is a block diagram of a third embodiment related to a base station.

FIG. 7 is a flow diagram for implementing AI/ML model(s) on a base station side according to an embodiment.

FIG. 8 is a flow diagram for implementing AI/ML model(s) on a user equipment side according to an embodiment.

FIG. 9 is a flow diagram for implementing AI/ML model(s) on both base station side and user equipment side according to an embodiment.

FIG. 10 is a flow diagram for training AI/ML model(s) on a base station side according to an embodiment.

FIG. 11 is a flow diagram for training AI/ML model(s) on a user equipment side according to an embodiment.

FIG. 12 is a flow diagram for AI/ML model(s) performance monitoring and feedback according to an embodiment.

FIG. 13a is a diagram showing AI/ML model(s) and/or AI/ML model configuration(s) update before moving from one cell to another cell according to an embodiment.

FIG. 13b is a diagram showing handover prediction using AI/ML model(s) according to an embodiment.

FIG. 13c is a flowchart of a method performed by a user equipment for updating an AI/ML Model configuration during handover based on signaling from a first base station according to an embodiment.

FIG. 13d is a flowchart of a method performed by a user equipment for updating an AI/ML Model or a set of AI/ML Models during handover based on signaling from a first base station according to an embodiment.

FIG. 13e is a flowchart of a method performed by a first base station for updating an AI/ML Model configuration of a user equipment during handover according to an embodiment.

FIG. 13f is a flowchart of a method performed by a first base station for updating an AI/ML Model or a set of AI/ML Models of a user equipment during handover according to an embodiment.

FIG. 14a is a diagram showing AI/ML model(s) and/or AI/ML model configuration(s) update after moving from one cell to another cell according to an embodiment.

FIG. 14b is a flowchart of a method performed by a user equipment for updating an AI/ML Model configuration during handover based on signaling from a second base station according to an embodiment.

FIG. 14c is a flowchart of a method performed by a user equipment for updating an AI/ML Model or a set of AI/ML Models during handover based on signaling from a second base station according to an embodiment.

FIG. 14d is a flowchart of a method performed by a second base station for updating an AI/ML Model configuration of a user equipment during handover according to an embodiment.

FIG. 14e is a flowchart of a method performed by a second base station for updating an AI/ML Model or a set of AI/ML Models of a user equipment during handover according to an embodiment.

FIG. 15a is a diagram showing AI/ML model configuration(s) update while moving from one location to another location within a cell according to an embodiment.

FIG. 15b is a diagram showing AI/ML model(s) and/or AI/ML model configuration(s) update while moving from one location to another location within a cell according to an embodiment.

FIG. 16 is a flow diagram showing a first embodiment related to signaling exchange between base stations for updating/downloading AI/ML model(s) and/or AI/ML model configuration(s).

FIG. 16a is a flow diagram showing a second embodiment related to signaling exchange between base stations for updating/downloading AI/ML model(s) and/or AI/ML model configuration(s).

FIG. 17 is a flow diagram showing a third embodiment related to signaling exchange between base stations for updating/downloading AI/ML model(s) and/or AI/ML model configuration(s).

FIG. 18 is a diagram showing a first embodiment related to signaling for a user equipment in dual connectivity configuration for implementing AI/ML model(s) and/or AI/ML model configuration(s).

FIG. 18a is a diagram showing a second embodiment related to signaling for a user equipment in dual connectivity configuration for implementing AI/ML model(s) and/or AI/ML model configuration(s).

FIG. 18b is a diagram showing a third embodiment related to signaling for a user equipment in dual connectivity configuration for implementing AI/ML model(s) and/or AI/ML model configuration(s).

FIG. 18c is a diagram showing a fourth embodiment related to signaling for a user equipment in dual connectivity configuration for implementing AI/ML model(s) and/or AI/ML model configuration(s).

FIG. 19 is a diagram showing a first embodiment related to handover prediction using AI/ML model(s) and associated signaling.

FIG. 20 is a diagram showing a second embodiment related to handover prediction using AI/ML model(s) and associated signaling.

FIG. 21 is a diagram showing a third embodiment related to handover prediction using AI/ML model(s) and associated signaling.

FIG. 22 is a diagram showing a fourth embodiment related to handover prediction using AI/ML model(s) and associated signaling.

FIG. 23 is a diagram showing a fifth embodiment related to handover prediction using AI/ML model(s) and associated signaling.

FIG. 24 is a flowchart of a method performed by a user equipment for receiving downlink channels on a plurality of carriers using an AI/ML Model or a set of AI/ML Models according to an embodiment.

FIG. 25 is a flowchart of a method performed by a user equipment for receiving downlink channels on a plurality of carriers using respective AI/ML Model configurations according to an embodiment.

FIG. 26 is a flowchart of a method performed by a base station for transmitting downlink channels on a plurality of carriers using an AI/ML Model or a set of AI/ML Models according to an embodiment.

FIG. 27 is a flowchart of a method performed by a base station for transmitting downlink channels on a plurality of carriers using respective AI/ML Model configurations according to an embodiment.

### DETAILED DESCRIPTION

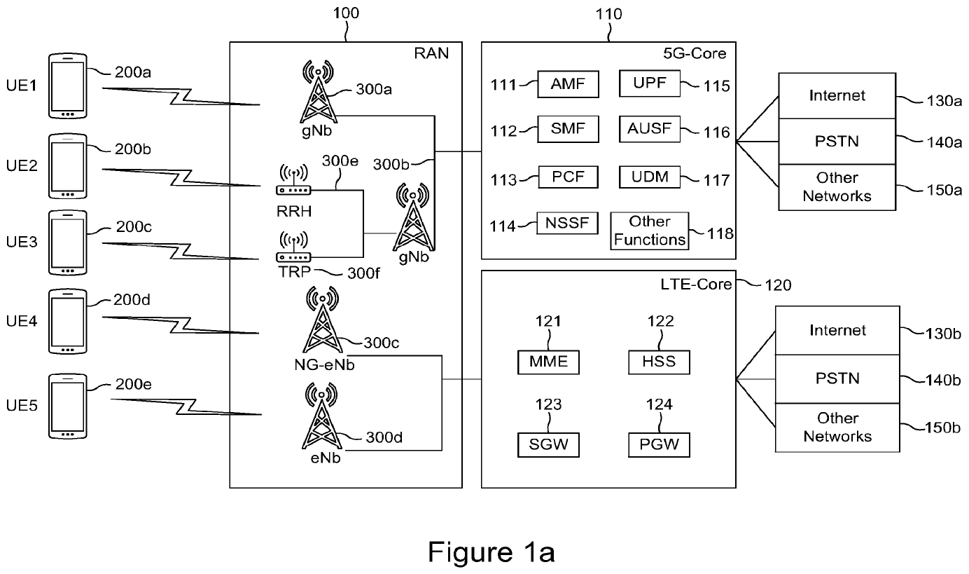

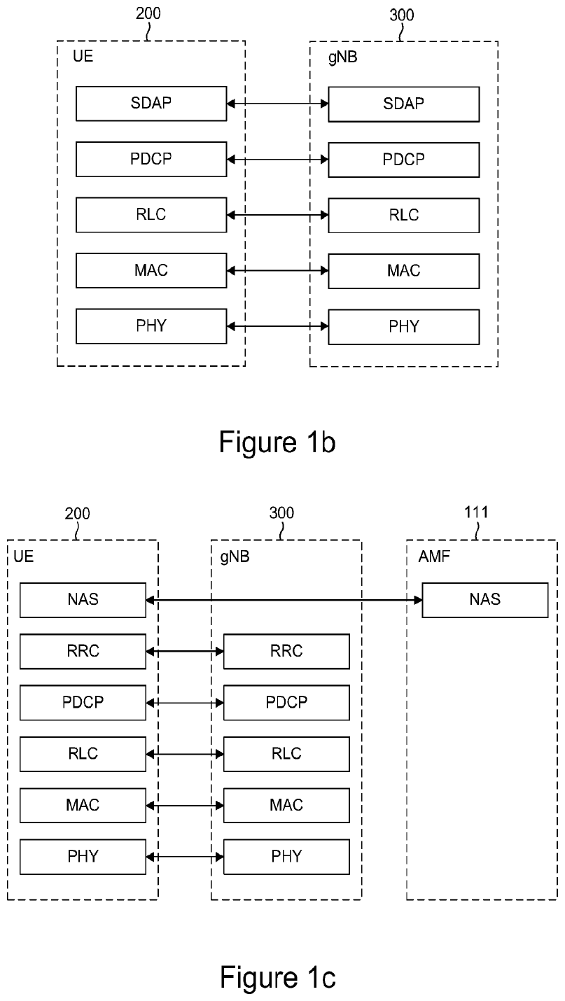

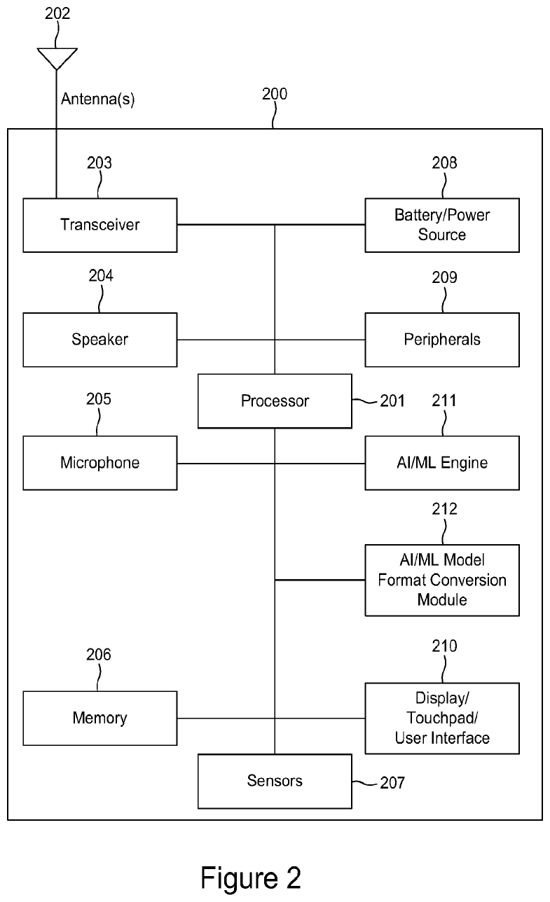

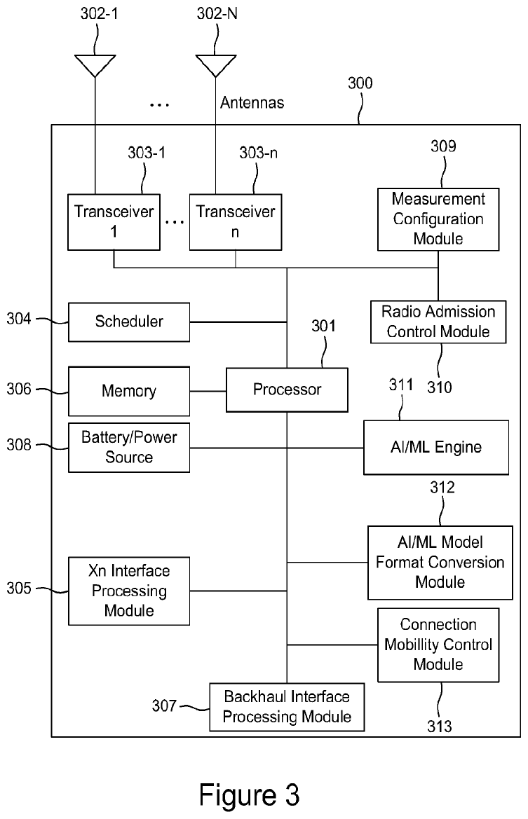

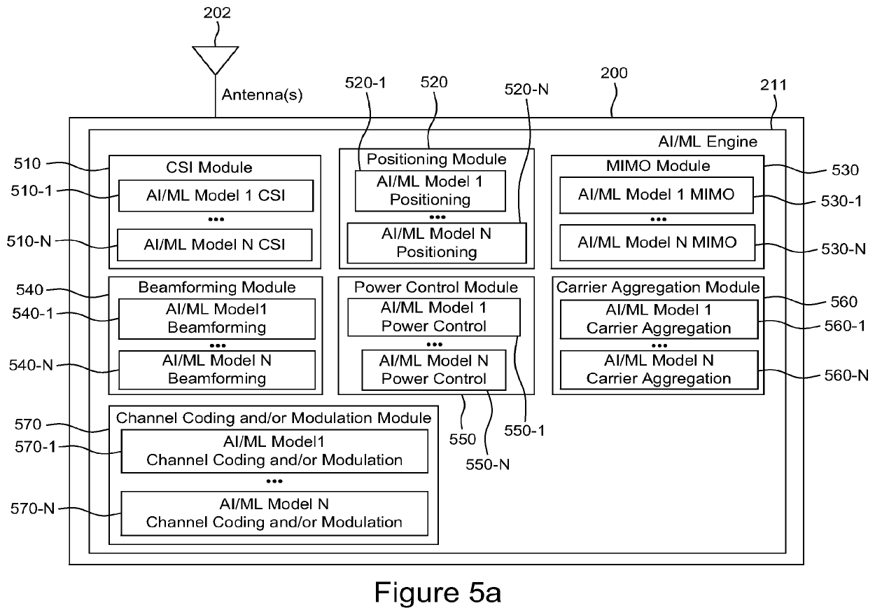

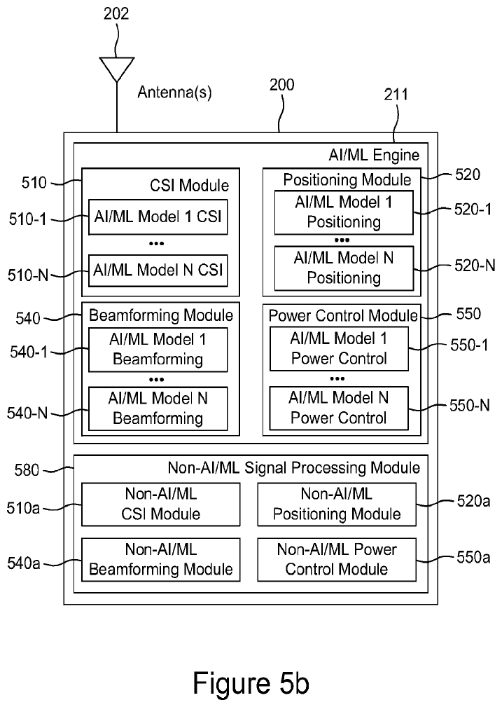

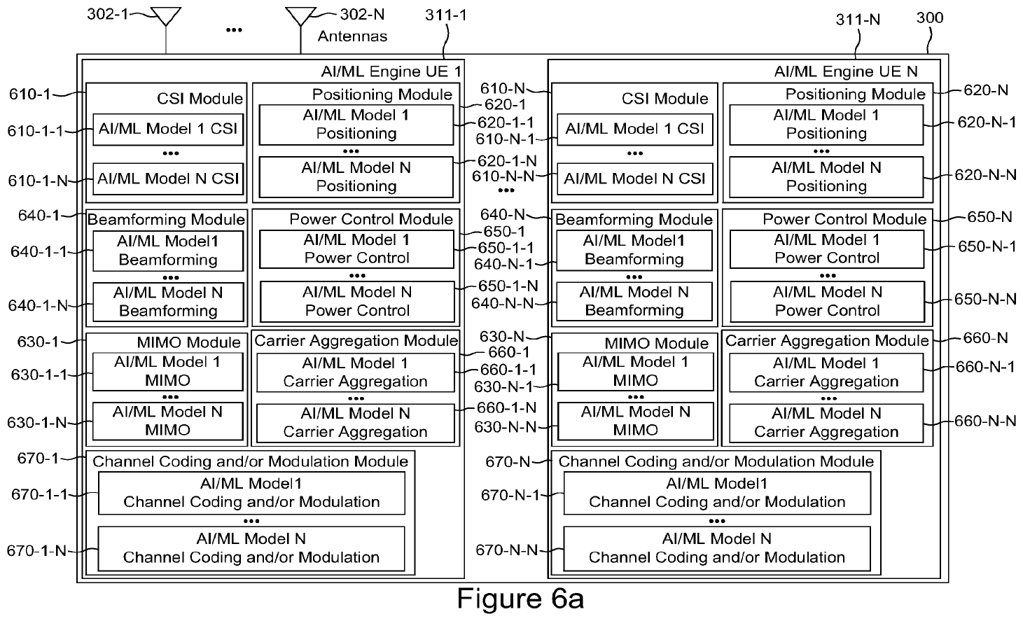

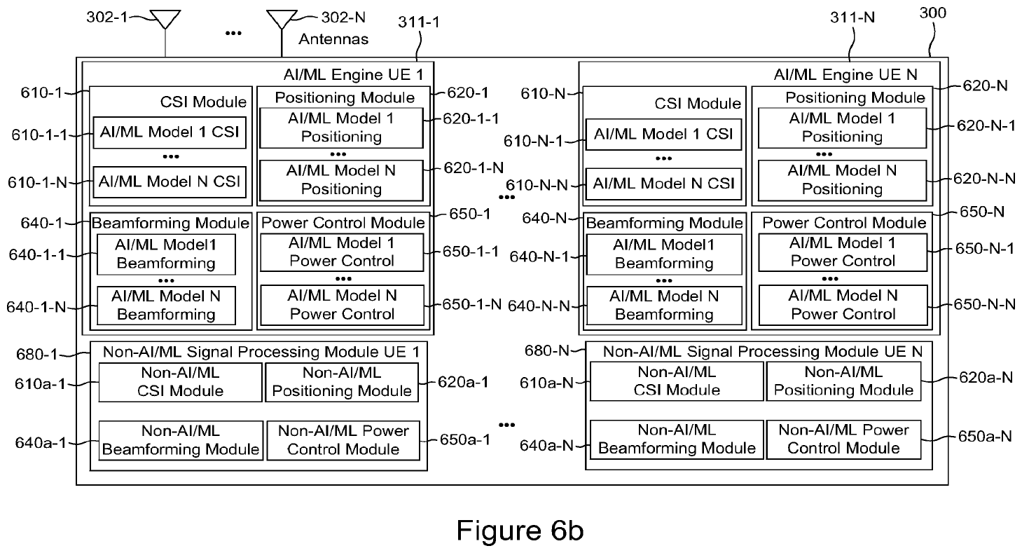

FIG. 1a is a system diagram of a wireless communication system that may be deployed to provide various communication services, such as a voice service, packet data, audio, video, and the like. The wireless communication system may include a User Equipments (UEs) (200a, 200b, 200c, 200d, 200e), RAN (100) (Radio Access Network), and a core including a 5G core (110) and/or an LTE core (120). The RAN (100) includes base stations (300a, 300b, 300c, 300d, 300e, 300f) or cells communicating with the UEs (200a, 200b, 200c, 200d, 200e). The LTE core (120) includes core network components such as MME (121), HSS (122), PGW (124), and SGW (123). The 5G core (110) includes various functions such as UPF (115), AMF (111), SMF (112), AUSF (116), NSSF (114), UDM (117), PCF (113), and other functions (118) such as NEF, NRF, AF, etc. The detailed scope and functionalities of the LTE (120) and 5G core (110) network components can be identified from the 3GPP standard specifications (including connection to internet (130a, 130b), PSTN (140a, 140b), and other networks (150a, 150b). The UEs (200a, 200b, 200c, 200d, 200e) may refer to a UE disclosed in conjunction with the description of FIG. 2, FIG. 5a or FIG. 5b and base stations (300a, 300b, 300c, 300d, 300e, 300f) may refer to a base station disclosed in conjunction with the description of FIG. 3, FIG. 6a or FIG. 6b.

Throughout the patent specification, the user equipment may be an inclusive concept indicating a terminal utilized in wireless communication, including a UE (User Equipment) (200) in long-term evolution (LTE), 5G NR, and the like.

A base station (BS) (300) or a cell may generally refer to a station communicating with a User Equipment (UE) (200). The base station (300) may also be referred to as a Node-B, an evolved Node-B (eNb) (300c, 300d), gNodeB (gNb) (300a, 300b), MeNb, SeNb, HeNb, a Sector, a Site, transmit-receive point (TRP) (300f), a Base Transceiver System (BTS), an Access Point, a Relay Node, Integrated Access and Backhaul (IAB) node, a Remote Radio Head (RRH) (300e), a Radio Unit (RU), and the like.

In the patent specification, the base station (300) or the cell may have an inclusive concept indicating a portion of an area covered and functions performed by a Node-B, an evolved Node-B (eNb) (500d), gNodeB (gNb) (500b), MeNb, SeNb, a Sector, a Site, a Base Transceiver System (BTS), an Access Point, a Relay Node, Integrated Access and Backhaul (IAB) node, a Remote Radio Head (RRH) (300e), a Radio Unit (RU), and the like. The base station (300) or cell may include various coverage areas, such as a mega cell, a macrocell, a microcell, a picocell, a femtocell, a communication range of a relay node, an RRU, an RU, and the like.

In the patent specification, a BS may also refer to Radio unit (RU) and/or Distributed Unit (DU) and/or Central Unit (CU) as per the required functionality. The person skilled in the art would appreciate that processing may be split among RU, DU, and CU as per the 3GPP and/or O-RAN specifications.

Exemplary communication between the base station (300) and UE (200) in a 5G system is disclosed in FIG. 1b for the user plane (aka data plane) protocol stack and FIG. 1c for the control plane protocol stack. A similar protocol stack also exists for UE (200) communication in an LTE system. One difference with respect to the 5G user plane protocol stack is the SDAP layer that only exists in 5G. One difference with respect to the 5G control plane protocol stack is that the NAS signalling is between UE (200) and AMF (111) whereas in LTE the NAS signalling is between UE (200) and MME (121).

As shown in FIG. 2, User Equipment (UE) (200) may include a processor (201), a transceiver (203), antenna(s) (202), a speaker (204)/microphone (205), a keypad (not shown), a display/touchpad/User interface (210), memory (non-removable memory or removable memory) (206), AI/ML Engine (211), AI/ML Model Format Conversion Module (212), a power source (208) (or battery including charging circuit), sensors (207) such as accelerometer, an e-compass, a global positioning system (GPS) chipset, NFC, and other peripherals (209) such a satellite transceiver, a digital camera (for photographs or video), a universal serial bus (USB) port, a vibration device, a hands-free headset, a Bluetooth® module, a frequency modulated (FM) radio unit, a multimedia player, a video game player module, an Internet browser, or the like. It is appreciated that the User Equipment (UE) (200) may include any sub-combination of the foregoing elements.

The processor (201) may be coupled to all or a subset of the of the following: transceiver (203), a speaker (204)/microphone (205), a keypad, a display/touchpad/User interface (210), non-removable memory or removable memory (206), a power source (208), sensors (207), and other peripherals (209).

As shown in FIG. 3, the Base station (300) may include a processor (301), a transceiver (303-1 . . . 303-n), antennas (302-1 . . . 302-n), memory (non-removable memory or removable memory) (306), AI/ML Engine (311), AI/ML Model Format Conversion Module (312), and a power source (308) (or battery including a charging circuit). The base station (300) may be configured to host modules such as a measurement configuration module (309) for channel measurements for mobility and scheduling, radio admission control module (310) for UE (200) admission control to the network, connection mobility control (313) module for handover-related processing, backhaul Interface processing module (307) for processing messages received/transmitted to the core network, Xn interface processing module (305) for processing messages received/transmitted to other base stations, and scheduler (304) for dynamic allocation of resources to UEs in both uplink and downlink. It is appreciated that the base station (300) may include any sub-combination of the foregoing elements. The base station (300) may also host a MIMO Module, a Channel Coding and/or Modulation Module, and a Carrier Aggregation Module that are not shown in FIG. 3.

The following additional modules may also be hosted by the base station (300): Radio Resource Management for inter-cell radio resource management, radio bearer control, IP header compression, encryption and integrity protection of data, selection of an AMF (111) at UE (200) attachment when no routing to an AMF (111) can be determined from the information provided by the UE (200), routing of User Plane data towards UPF(s), routing of Control Plane information towards AMF (111), connection setup and release, scheduling and transmission of paging messages (originated from the AMF (111)), scheduling and transmission of system broadcast information (originated from the AMF (111) or Operation and Maintenance), transport level packet marking in the uplink; session management; support of network slicing, QoS flow management and mapping to data radio bearers, support of UEs (200a, 200b, 200c, 200d and 200e) in RRC_INACTIVE state, distribution function for non-access stratum (NAS) messages, radio access network sharing, dual connectivity, to name a few.

The processor in a UE or BS (201 or 301) may be a general-purpose processor, a digital signal processor (DSP), a plurality of microprocessors, a single core, or a multi-core processor, one or more microprocessors in association with a DSP core, a controller, a microcontroller, Application-Specific Integrated Circuits (ASICs), Field Programmable Gate Array (FPGAs) circuits, any other type of integrated circuit (IC), or the like. The processor (201 or 201) may perform signal coding/decoding, data processing, power control, input/output processing, or any other functionality that enables the user equipment to operate in a wireless environment. The processor (201 or 201) may be coupled to a transceiver (203 or 303-1 . . . 303-n) that may be further coupled to the antenna(s) (202 or 302-1 . . . 302-n). While the processor (201 or 301) and the transceiver (203 or 303-1 . . . 303-n) may be separate components, it is appreciated that the processor (201 or 301) and the transceiver (203 or 303-1 . . . 303-n) may be integrated in an electronic package or chip.

The antenna(s) (202 or 302-1 . . . 302-n) may include a plurality of antennas or an antenna array. The antenna(s) (202 or 302-1 . . . 302-n) is/are capable of transmitting/receiving on the entire Radio spectrum including the mmWave spectrum.

The transceiver (203 or 303-1 . . . 303-n) may be configured to modulate the signals that are to be transmitted by the antenna(s) (202 or 302-1 . . . 302-n) and to demodulate the signals that are received by the antenna(s) (202 or 302-1 . . . 302-n).

The memory (206 or 306) may include a non-removable memory or a removable memory. The non-removable memory may include a random access memory (RAM), read-only memory (ROM), a hard disk, SSD, or any other type of memory storage device. The removable memory may include a subscriber identity module (SIM) card, a memory stick, a secure digital (SD) memory card, and the like. The memory (206 or 306) may be used for storing instructions used by the processor (201 or 301) for performing various user equipment functions including but not limited to cellular transmission and reception. The cellular transmission and reception functions may include transmission and reception of physical channels and signals (for example, PUSCH, PUCCH, PRACH, SRS, DMRS, PDSCH, PBCH, PDCCH, PSS, SSS, DMRS, CSI-RS, and PTRS) or may include transmission and reception of higher layer data and control signaling (for example, RRC, MAC, RLC, PDCP, NAS and SDAP).

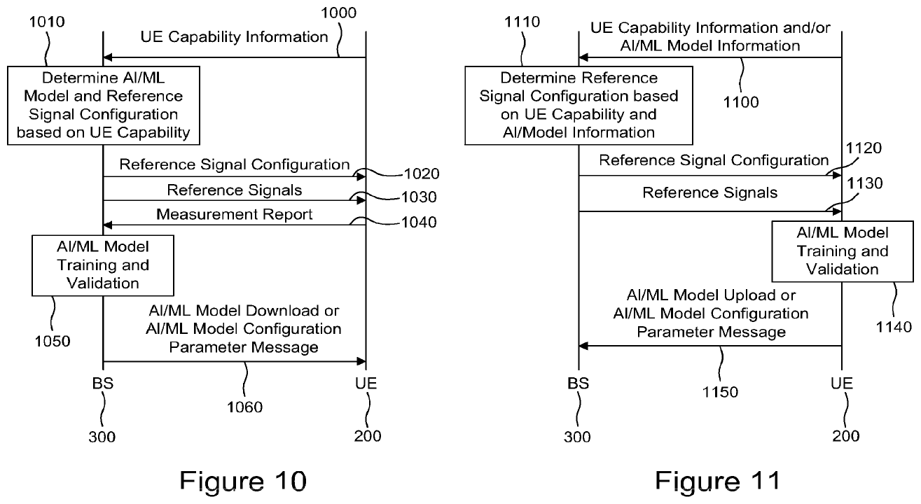

The AI/ML Model Format Conversion Module shown in FIGS. 2 and 3 (212 or 312) may operate to interconvert the formats as presented in Table 2 below (and/or variations developed with the advancements of the AI/ML technology). The AI/ML Model Format Conversion Module may be optionally present at UE (200) and/or BS (300) as noted below in conjunction with FIGS. 10,11 and 12. The AI/ML Model Format Conversion Module 212 or 312) may assist in download/upload and/or transfer of AI/ML Model(s) between a UE and BS and/or between a BS and UE.

The AI/ML Engine (Artificial Intelligence/Machine Learning Engine) (211 or 311) in a UE and/or BS may be implemented purely as software, purely as hardware, or a combination of hardware and software. When the AI/ML Engine (211 or 311) is implemented as software, the processor/GPU may be used as the hardware, when the AI/ML Engine (211 or 311) is implemented as hardware an additional AI/ML processor/GPU or a chipset may be used, and when the AI/ML Engine (211 or 311) implemented as a combination of software and hardware, the processor/GPU and/or an additional AI/ML processor/GPU or a chipset may be used as the hardware.

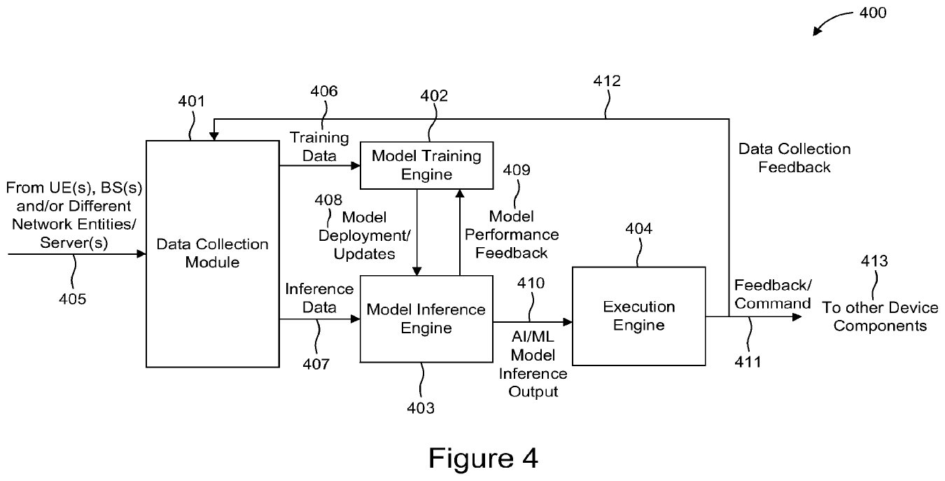

The AI/ML Engine (400) may implement the modules as disclosed in FIG. 4 and corresponds to AI/ML Engine (211 or 311) shown in FIG. 2 or 3. In this specification, AI/ML Engine (400) may be used interchangeably with AI/ML Engine (211 or 311). The components of an AI/ML engine (400) may include the following:

Data Collection module (401): provides input data to Model Training Engine (402) and Model Inference Engine (403). Such input data may include the following types of data:
Training Data (406): Data which may be used as an input for the AI/ML Model Training Engine.
Inference Data (407): Data which may be used as an input for the AI/ML Model Inference Engine.

AI/ML Model specific data preparation (e.g., data pre-processing and cleaning, formatting, and transformation) may not be carried out in the Data Collection module (401).

Examples of data (405) collected by Data Collection Module (401) may include measurements from UE(s), BS(s) and/or different network entity(s)/server(s), feedback from an Execution Engine, and/or output from an AI/ML Model. The network entity(s) may include core network entity(s). The server(s) may include network operator's server(s) or application server(s) such as location server or map server (e.g., Google Maps or Apple Maps). The description of the term “AI/ML Model” can be identified from Table 1.

Model Training Engine (402) is a function that may perform the AI/ML Model training, validation, and/or testing, that may generate AI/ML Model performance metrics as part of the AI/ML Model testing procedure. The Model Training Engine may also be responsible for data preparation (e.g., data pre-processing and cleaning, formatting, and/or transformation) based on Training Data (406) delivered by a Data Collection Module.
Model Deployment/Updates (408): May be used to initially deploy a trained, validated, and/or tested AI/ML Model to the Model Inference Engine (403) and/or to deliver an updated AI/ML Model to the Model Inference Engine (403).

Model training may involve one or more model training methods including, for example, supervised learning, unsupervised learning, semi-supervised learning, reinforcement learning, neural networks, federated learning, dictionary learning, and active learning.

Model Inference Engine (403) is a function that may run an AI/ML Model and generate an AI/ML Model inference output (e.g., predicted/estimated data, processed data or decisions) (410). The Model Inference Engine (403) may also provide Model Performance Feedback (409) to the Model Training Engine (402) when applicable. The Model Inference Engine (403) may also be responsible for data preparation (e.g., data pre-processing and cleaning, formatting, and/or transformation) based on Inference Data (407) received from a Data Collection Module (401).
Output to Execution Engine (410): The AI/ML Model inference output produced by the Model Inference Engine may be provided to the Execution Engine.
Output to Model Training Engine (409): Model Performance Feedback may be used for monitoring the performance of the AI/ML Model, when available.

The performance of a trained AI/ML Model may be evaluated by using one or more of the following example metrics:
Classification metrics
Classification metrics may be used to evaluate AI/ML Model performance for classification tasks, which may involve predicting a discrete classification label. There are many suitable classification metrics that could be used including, for example, one or more of the following:
Accuracy ratio can be used to measure the percentage of correct predictions out of a number of samples (including a total number of samples).
Precision can be used to measure the percentage of positive instances out of a number of predicted positive instances (including a total number of predicted positive instances).
Recall can be used to measure the percentage of positive instances out of a number of actual positive instances (including a total number of actual positive instances).
F1 score can be used to combine the contribution of both precision and recall, making it possible to evaluate the performance with one metric.
Confusion Matrix can be used to measure true positive (tp), true negative (tn), false positive (fp), and false negative (fn) in the predictions. The Confusion Matrix is presented in the form of a matrix where the Y-axis shows the true classes while the X-axis shows the predicted classes.
Regression metrics
Regression metrics may be used to evaluate AI/ML Model performance for regression tasks. Unlike classification tasks which classify inputs into discrete class labels, regression tasks involve predicting continuous numbers. There are many suitable metrics that could be used include, for example, one or more of the following:
Mean Absolute Error (MAE)
Mean Square Error (MSE)
Root Mean Square Error (RMSE)
normalized Mean Square Error (NMSE)
Coefficient of Determination (commonly called R-squared)
Adjusted R-squared
Metrics for online iterative optimization
Unlike classification or regression tasks, for which an AI/ML Model is trained using labelled data, online iterative optimization tasks leveraging reinforcement learning typically don't have labels to train the AI/ML Model in advance. Thus, a separate set of metrics may be used in evaluating the performance of AI/ML Models. For online iterative optimization tasks, a reinforcement learning (RL)-type of technique can be leveraged. One concern in utilizing RL is its usability or reliability/stability in addition to its final performance or average optimization performance across iterations/runs. To measure reliability, metrics quantifying performance dispersion and risk may be used.

In addition to the above, other metrics that may be considered when leveraging AI/ML-based Models include the complexity of the algorithms, overhead/cost associated with training and inference, and/or resource requirements.

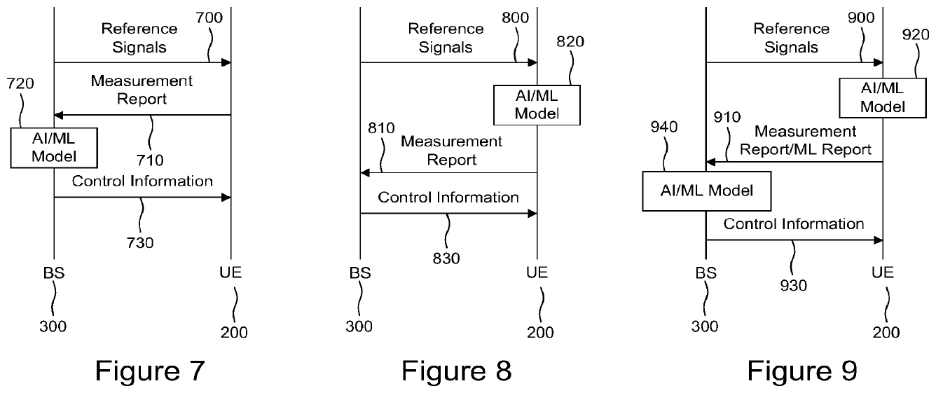

Execution Engine (404) is a function that may receive the output from the Model Inference Engine (403) and trigger or perform corresponding tasks. For example, the Execution Engine (404) may trigger feedback/commands (411) directed to other device components (413). The other device components (413) may include components within the device (UE or BS) implementing the AI/ML Engine (211 or 311) and/or entities external to the device implementing AI/ML Engine (211 or 311). Example arrangements, as further described in conjunction with embodiments shown in FIGS. 7, 8 and 9 below, include the following:
AI/ML Engine on BS (311): The Execution Engine (404) may provide instruction to a processor (301) to transmit reference signals (such as, for example, CSI-RS, DMRS, SSB signals, and Positioning Reference signals) to a UE (200). The Execution engine (404) may also provide instructions to measure reference signals for capturing the data for the AI/ML Model. The Execution Engine (404) may share AI/ML Model parameters or trained AI/ML Model with the processor (301) for transferring to a UE (200). The Execution Engine (404) may also provide feedback to be shared with the UE (200). The feedback may include data for updating the AI/ML Model used at UE (200).
AI/ML Engine on UE (211): The Execution Engine (404) may provide instructions to a processor (201) to prepare a measurement report that may be shared with a BS (300). The Execution Engine (404) may also provide instructions to measure reference signals (such as, for example, CSI-RS, DMRS, SSB signals, and Positioning Reference signals) for capturing the data for an AI/ML Model. The Execution Engine (404) may share AI/ML Model parameters or trained AI/ML Model with the processor (201) for transferring to the BS (300). The Execution engine (400) may also provide feedback data to be shared with the BS (300). The feedback may include data for updating the AI/ML Model used at the BS (300).

Data Collection Feedback (412): Is Information that may be used to derive training data (406), inference data (407) and/or to monitor the performance of the AI/ML Model and/or its impact on the network through updating of KPIs and/or performance counters.

The AI/ML Model used by the AI/ML Engine (400) may include a neural network based deep learning model. In the deep learning model, a plurality of network nodes may be arranged in different layers and may send and/or receive data according to a convolution connection relationship. Examples of the neural network model may include various deep learning techniques, such as deep neural networks (DNN), convolutional deep neural networks (CNN), recurrent neural network (RNN), recurrent Boltzmann machine (RBM), restricted Boltzmann machine (RBM), deep belief networks (DBN), LSTM, and/or deep Q-networks. Other variations or combinations may be used as an AI/ML Model in an AI/ML Engine (400).

In accordance with an embodiment as presented in FIG. 5a, a UE (200) may include one or more AI/ML modules as a part of the AI/ML engine (211) (as shown in FIG. 2) such as, for example, a CSI Module (510), a Beamforming Module (540), a Positioning Module (520), a Power Control Module (550), a MIMO Module (530), a Channel Coding and/or Modulation Module (570), and/or a Carrier Aggregation Module (560).
CSI Module (510): includes AI/ML Model(s) (510-1 . . . 510-N) using CSI-RS signals and/or their derivations as inputs for predicting/estimating future CSI-RS signals and/or channel characteristics. The CSI module (510) may also include one or more AI/ML Model(s) among AI/ML Models (510-1 . . . 510-N) for compressing CSI measurement report and/or any specific field(s) in the CSI measurement report such as, for example, PMI for transmission over a wireless interface.
Beamforming Module (540): includes AI/ML Model(s) (540-1 . . . 540-N) using reference signals such CSI-RS and/or SSB signals or their derivations as inputs for predicting/estimating future Beam Pairs. The Beamforming module (540) may also include one or more AI/ML Model(s) among the AI/ML Models (540-1 . . . 540-N) for compressing Beam measurement report and/or any specific field(s) in the Beam measurement report for transmission over a wireless interface.
Positioning Module (or UE Location Prediction Module) (520): includes AI/ML Model(s) (520-1 . . . 520-N) using reference signals such as positioning reference signals (or SRS signals for BS), and/or their derivations, and/or UE speed, and/or UE trajectory information as inputs for predicting/estimating future UE location in the cellular network.
Power Control Module (550): includes AI/ML Model(s) (550-1 . . . 550-N) using reference signals and/or historical power control data and/or their derivations as inputs for predicting/estimating future UE transmit power in the cellular network.
MIMO Module (530): includes AI/ML Model(s) (530-1 . . . 530-N) using reference signals and/or historical MIMO channel data, and/or respective derivations as inputs for predicting/estimating future MIMO channel characteristics such as, for example, number of MIMO layers, number of antennas, number of codewords.
Channel Coding and/or Modulation Module (570): includes AI/ML Model(s) (570-1 . . . 570-N) using historical channel coding and/or modulation data, and/or respective derivations as inputs for predicting/estimating future channel coding and/or modulation to be used.
Carrier Aggregation Module (560): includes AI/ML Model(s) (560-1 . . . 560-N) using historical carrier aggregation data, and/or its derivations as inputs for predicting/estimating future carrier aggregation characteristics such as, for example, transmit power of aggregated carriers, channel bandwidths of the aggregated carriers, combinations of carriers to be aggregated, activation/deactivation of the aggregated carriers, addition/release of the aggregated carriers, and/or MIMO/Channel coding/Modulation/Beamforming characteristics of the aggregated carriers.

An AI/ML module (such as 510, 520, 530, 540, 550, 560, and 570) may correspond to an AI/ML family which may include one or more AI/ML Models within a family. For example, the CSI module (510), Beamforming Module (540), Positioning Module (520), and Power Control Module (550) may include the following models:
CSI Module (or CSI family) (510)
   AI/ML Model 1 CSI (510-1)
   . . .
   AI/ML Model N CSI (510-N)
Beamforming Module (or Beamforming family) (540)
   AI/ML Model 1 Beamforming (540-1)
   . . .
   AI/ML Model N Beamforming (540-N)
Positioning Module (or Positioning family) (520)
   AI/ML Model 1 Positioning (520-1)
   . . .
   AI/ML Model N Positioning (520-N)
Power Control Module (or Power control family) (550)
   AI/ML Model 1 Power control (550-1)
   . . .
   AI/ML Model N Power control (550-N)

The number of AI/ML models in a family ‘N’ varies as per the UE and/or BS configurations. The UE configuration includes UE processing capabilities, memory capabilities, and UE requirement for AI/ML models at a given time. The BS configuration include signaling transmitted to a UE for configuring ‘N’ AI/ML models in a family at a time. Separate signaling may be transmitted for each AI/ML model family. The BS may transmit an additional signaling to include information for activating ‘M’ AI/ML models among the ‘N’ configured AI/ML models in a family at a given time.

At a given time there may be ‘M’ AI/ML Models which are active among the ‘N’ configured AI/ML models where M<=N. The N and M are integers and may include ‘0’. N=0 indicates the AI/ML model family is not configured in the UE. While M=0 and N>0 indicates no AI/ML model is active at the given time.

In accordance with an embodiment as presented in FIG. 5b, a UE (200) may include one or more AI/ML modules as a part of the AI/ML engine (211) (as shown in FIG. 2) such as, for example, a CSI Module (510), a Beamforming Module (540), a Positioning Module (520), a Power Control Module (550), a MIMO Module (530), a Channel Coding and/or Modulation Module (570), and/or a Carrier Aggregation Module (560). The MIMO Module (530), Channel Coding and/or Modulation Module (570), and Carrier Aggregation Module (560) are not shown in the figure but may be used, as per the implementation, to take advantage of AI/ML technology for the respective use cases. A UE (200) may also, include one or more modules (580) not using any AI/ML Models for processing enhancements such as, for example, a non-AI/ML CSI Module (510a), a non-AI/ML Beamforming Module (540a), a non-AI/ML Positioning Module (520a), a non-AI/ML Power Control Module (550a), a non-AI/ML conventional MIMO Module (530a), a non-AI/ML conventional Channel Coding and/or Modulation Module (570a), and/or a non-AI/ML conventional Carrier Aggregation Module (560a). A non-AI/ML conventional MIMO Module (530a), a non-AI/ML conventional Channel Coding and/or Modulation Module (570a), and/or a non-AI/ML conventional Carrier Aggregation Module are not shown in the figure but may be used, as per the implementation.

According to an embodiment, a UE (200) may switch between AI/ML Modules (510, 520, 530, 540, 550, 560, or 570) and corresponding non-AI/ML processing modules (510a, 520a, 530a, 540a, 550a, 560a, or 570a) including, for example, based on signaling received from a BS (300) or based on the AI/ML Model performance. For example, a UE (200) may switch from AI/ML CSI Module (510) (e.g., Model 1 CSI (510-1) to a non-AI/ML CSI Module (510a) for sending a CSI report to a BS (300). According to an embodiment, the UE (200) may indicate, when sending a report/feedback such as, for example, a CSI report, a Beamforming report, a Positioning related parameter report, a Power Control related parameter feedback, MIMO related parameter report, a Channel Coding and/or Modulation related parameter report, and/or a Carrier Aggregation related parameter report, whether it is generated from AI/ML Module(s) (510, 520, 530, 540, 550, 560, or 570) and/or non-AI/ML processing module(s) (510a, 520a, 530a, 540a, 550a, 560a, or 570a) using one or more specific bit(s). According to another embodiment, the UE (200) may include a flag bit in a report/feedback to indicate if AI/ML engine (211) is used or a non-AI/ML signal processing Module (580) is used when sending the report/feedback.

According to an embodiment, a UE (200) may switch from one or more AI/ML Modules (510, 520, 530, 540, 550, 560, or 570) to the corresponding one or more non-AI/ML processing modules (510a, 520a, 530a, 540a, 550a, 560a, or 570a), including, for example, based on signaling received from a BS (300) and/or based on the AI/ML Model performance measurement. For example, a UE (200) may switch from AI/ML CSI Module (510) (e.g., Model 1 CSI) to a non-AI/ML CSI Module (510a) for sending CSI report to a BS (300) without switching the AI/ML Beamforming Module (540). According to an embodiment, a UE (200) may operate in a configuration where subset of AI/ML Modules (510, 520, 530, 540, 550, 560, or 570) and subset of non-AI/ML processing modules (510a, 520a, 530a, 540a, 550a, 560a, or 570a) are used. According to an embodiment, a UE (200) may indicate, when sending a report and/or feedback such as, for example, a CSI report, a Beamforming report, a Positioning related parameter report, a Power Control related parameter feedback, MIMO related parameter report, a Channel Coding and/or Modulation related parameter report, and/or a Carrier Aggregation related parameter report, whether it is generated from AI/ML Module(s) (510, 520, 530, 540, 550, 560, or 570) and/or the non-AI/ML processing module(s) (510a, 520a, 530a, 540a, 550a, 560a, or 570a) using one or more specific bit(s). According to an embodiment, a UE (200) may indicate, when sending the report/feedback such as, for example, a CSI report, a Beamforming report, a Positioning related parameter report, a Power Control related parameter feedback, MIMO related parameter report, a Channel Coding and/or Modulation related parameter report, and/or a Carrier Aggregation related parameter report, which parameters in the report/feedback are generated from AI/ML Module(s) (510, 520, 530, 540, 550, 560, or 570) and which parameters are generated from non-AI/ML processing module(s) (510a, 520a, 530a, 540a, 550a, 560a, or 570a) using a specific bit pattern, for example, where an individual bit may indicate an AI/ML Model (or AI/ML Module) or non-AI/ML processing module(s).

In accordance with an embodiment, a UE (200) may switch from an AI/ML CSI Module (510), Beamforming Module (540), Positioning Module (520), or Power Control Module (550) to a corresponding non-AI/ML CSI Module (510a), non-AI/ML Beamforming Module (540a), non-AI/ML Positioning Module (520a), or non-AI/ML Power Control Module (550a) based on physical layer signaling and/or RRC signaling.

In accordance with an embodiment, a UE (200) may switch from a non-AI/ML CSI Module (510a), non-AI/ML Beamforming Module (540a), non-AI/ML Positioning Module (520a), or non-AI/ML Power Control Module (550a) to a corresponding AI/ML CSI Module (510), Beamforming Module (540), Positioning Module (520), or Power Control Module (550) based on physical layer signaling and/or RRC signaling.

In accordance with an embodiment, a UE (200) may switch from an AI/ML CSI Module (510), AI/ML Beamforming Module (540), AI/ML Positioning Module (520), and/or AI/ML Power Control Module (550) to a corresponding non-AI/ML CSI Module (510a), non-AI/ML beamforming Module (540a), non-AI/ML Positioning Module (520a), and/or non-AI/ML Power Control Module (550a) based on a predefined AI/ML Model performance threshold. For example, if AI/ML Model performance degrades below a threshold the UE (200) may switch to a corresponding non-AI/ML processing Module(s) (510a, 520a, 530a, 540a, 550a, 560a, or 570a). A UE (200) may indicate to a BS (300) when it switches from one or more modules to another one or more modules based on one or more threshold comparisons using a specific field or one or more bits in the uplink RRC or physical layer signaling.

In accordance with an embodiment, a UE (200) that switches to a non-AI/ML Module (510a, 520a, 530a, 540a, 550a, 560a, or 570a from an AI/ML Module (510, 520, 530, 540, 550, 560, or 570) may switch back to AI/ML Module (510, 520, 530, 540, 550, 560, or 570) based on signaling from a BS (300).

In accordance with an embodiment, a UE (200) may switch from an AI/ML Model to another AI/ML Model within an AI/ML Module (family) (510, 520, 530, 540, 550, 560, or 570), including based on a predefined AI/ML Model performance threshold. A UE (200) may indicate to a BS (300) when it switches from one AI/ML Model to another AI/ML Model based on threshold comparison using a specific field or one or more bits in the uplink RRC or physical layer signaling. A UE may optionally include an identifier of the switched AI/ML Model in the uplink signaling.

In accordance with an embodiment, AI/ML Models within an AI/ML Module (family) (510, 520, 530, 540, 550, 560, or 570) may correspond to different configurations. For example, AI/ML Model 1 CSI (510-1) may correspond to a CSI prediction with configuration 1 and AI/ML Model 2 CSI (510-2) may correspond to a CSI prediction with configuration 2. Similarly, AI/ML Model 1 Beamforming (540-1) may correspond to Beamforming prediction with configuration 1 and AI/ML Model 2 Beamforming (540-2) may correspond to Beamforming prediction with configuration 1. Similar configurations may exist for the Positioning Module, Power Control Module, MIMO Module, Channel Coding and/or Modulation Module, or a Carrier Aggregation Module as well.

In accordance with an embodiment, AI/ML Models within an AI/ML Module (family) (510, 520, 530, 540, 550, 560, or 570) may correspond to different categories of AI/ML Models for the same parameter. For example, AI/ML Model 1 CSI (510-1) may correspond to a CSI prediction category, and AI/ML Model 2 CSI (510-2) may correspond to a CSI compression category, CSI being a parameter. Similarly, AI/ML Model 1 Beamforming (540-1) may correspond to a time domain Beamforming prediction category, and AI/ML Model 2 Beamforming (540-2) may correspond to spatial domain Beamforming prediction category, Beamforming being a parameter. Similar configurations may exist for the Positioning Module, Power Control Module, MIMO Module, Channel Coding and/or Modulation Module, or a Carrier Aggregation Module.

In accordance with an embodiment as presented in FIG. 6a, a BS (300) may include one or more AI/ML modules (610, 620, 630, 640, 650, 660, or 670) for each UE (UE1 . . . . UE N) as a part of the AI/ML engine (311) (as shown in FIG. 3) such as, for example for UE 1, a CSI Module (610-1), Beamforming Module (640-1), Positioning Module (620-1), Power control module (650-1), MIMO Module (630-1), Channel Coding and/or Modulation Module (670-1), and/or Carrier Aggregation Module (660-1). Similarly, for other UEs such AI/ML modules may be configured. An AI/ML module may correspond to an AI/ML family which includes one or more AI/ML Models within a family. Further, a BS (300) may have one or more of such AI/ML Modules associated with one or more UEs (e.g., those supporting AI/ML Modules in the coverage area of the BS), which may include separate configurations for UEs which supports AI/ML Model(s) in the coverage area of the BS (300). The details of functionalities of modules in FIG. 6a may be identified from the description of FIG. 5a which are equally applicable here.

In accordance with an embodiment as presented in FIG. 6b, a BS (300) may include one or more AI/ML modules (610, 620, 630, 640, 650, 660, or 670) for each UE (UE1 . . . . UE N) as a part of the AI/ML engine (311) (as shown in FIG. 3) such as, for example for UE-1, a CSI Module (610-1), Beamforming Module (640-1), Positioning Module (620-1), Power control module (650-1), MIMO Module (630-1), Channel Coding and/or Modulation Module (670-1), and/or Carrier Aggregation Module (660-1). The MIMO Module (630-1), Channel Coding and/or Modulation Module (670-1), and Carrier Aggregation Module (660-1) are not shown in the figure but may be used, as per the implementation, to take advantage of AI/ML technology for the respective use cases. Similarly, for other UEs such AI/ML modules may be configured. An AI/ML module may correspond to an AI/ML family which includes one or more AI/ML Models within a family. Further, a BS (311) may have one or more of such AI/ML Modules associated with one or more UEs (e.g., those supporting AI/ML Modules in the coverage area of the BS), which may include separate configurations for UEs which supports AI/ML Model(s) in the coverage area of the BS (311). The details of functionalities of modules in FIG. 6b may be identified from the description of FIG. 5a or 5b which are equally applicable here.

In the context of FIGS. 5 and 6, AI/ML Model Configurations may include one or more of an AI/ML Model version number, an identifier or indicator (or index) of an AI/ML Model, an identifier or indicator (or index) of a configuration of an AI/ML Model, details of performance metrics to be used, AI/ML Model parameters (such as one or more of coefficients, weights, biases, number of AI/ML tasks, AI/ML task identifier(s) (or index(s)), classifier (such as, for example, Regression, KNN, Vector machine, Decision Tree, or Principal component), and/or cluster centroids in clustering), or hyper-parameters such as one or more of number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer).

In an embodiment in the context of FIGS. 5 and 6, different AI/ML Model Configurations may correspond to different situations such as, for example, high or low mobility/speed UE operation, low or high-power UE operation, good or bad coverage UE operation, and/or high or low interference UE operation.

According to an embodiment, and in the context of FIGS. 5 and 6, any subsets of AI/ML Modules may be used based on UE capabilities and operator configurations. According to other embodiments the modules may be combined or split as needed. For example, a CSI module (510, 610) may be split into a CSI Prediction Module and a CSI Compression Module. Similarly, in FIG. 6b, non-AI/ML Signal Processing Module UE 1 (680-1) may be combined with non-AI/ML Signal Processing Module UE 2 (680-2). The AI/ML Modules or non-AI-ML processing modules may be implemented using purely software, purely hardware, or a combination of hardware and software.

Table 1 provides description of the common terms used in the present application related to AI/ML technology deployment in the radio access network (RAN) involving a UE (200) and/or a BS (300).

TABLE 1

| Terminology | Description |
|---|---|
| Data collection | A process of collecting data by the network nodes, management entity, and/or UE for the |
| | purpose of AI/ML Model training, data analytics and inference |
| AI/ML Model | A data driven algorithm that may apply AI/ML techniques to generate a set of outputs |
| | based on a set of inputs. An AI/ML Model may include a deep neural network, a classical |
| | model such as regression, SVM, decision trees, and/or any other data driven algorithm. |
| AI/ML Model | A process to train an AI/ML Model by learning the input/output relationship in a data driven |
| training | manner and obtain the trained AI/ML Model for inference |
| AI/ML Inference | A process of using a trained AI/ML Model to produce a set of |
| | outputs based on a set of inputs |
| AI/ML Model | A subprocess of training, to evaluate the quality of an AI/ML Model using a dataset |
| validation | different from one used for AI/ML Model training, that may help selecting AI/ML Model |
| | parameters that generalize beyond the dataset used for AI/ML Model training. |
| Online training | In online training, the AI/ML Model may be updated sequentially on arrival of new data. |
| Offline training | In offline training, the AI/ML Model may be obtained once after |
| | the whole dataset have been collected. |
| On-UE training | Online/offline training at the UE |
| On-BS training | Online/offline training at the network |
| UE-side AI/ML | An AI/ML Model whose inference may be performed entirely at the UE |
| Model | |
| BS-side AI/ML | An AI/ML Model whose inference may be performed entirely at the network |
| Model | |
| Single-sided | A UE-side AI/ML Model or a BS-side AI/ML Model |
| AI/ML | |
| Dual-sided AI/ML | A paired AI/ML Model(s) over which joint inference may be performed, where joint |
| | inference comprises AI/ML Inference whose inference is performed jointly across the UE |
| | and the network, i.e., the first part of inference may be firstly performed by UE and then |
| | the remaining part may be performed by BS, or vice versa. |
| Model transfer | The Model transfer may include delivery of an AI/ML Model over the air interface where |
| | parameters of an AI/ML Model structure may be known at the receiving end. The Model |
| | transfer may also include delivery of a new AI/ML Model over the air interface, where |
| | parameters of an AI/ML Model structure may not be known at the receiving end. The |
| | delivery may contain a full AI/ML Model or a partial AI/ML Model. |
| Model download | Model transfer from the network to UE |
| Model upload | Model transfer from UE to the network |
| Model deployment | Delivery of a developed and tested AI/ML Model runtime image to a target UE/BS where |
| | inference may be performed. |
| Federated | A machine learning technique that trains an AI/ML Model across multiple decentralized |
| learning/ | edge nodes (e.g., UEs, BSs) where each may perform local AI/ML Model training using |
| federated training | local data samples. The technique may require multiple AI/ML Model |
| | exchanges, but no exchange of local data samples may be needed. |
| Model | A procedure that monitors the inference performance of the AI/ML Model |
| Performance | |
| monitoring | |
| Model update | Retraining or fine tuning of an AI/ML Model, via online/offline training, to improve the |
| | AI/ML Model inference performance. |
| Supervised | A process of training an AI/ML Model from input and its |
| learning | corresponding labels. |
| Unsupervised | A process of training an AI/ML Model without labelled data e.g., clustering is a common |
| learning | example of this. |
| Semi-supervised | A process of training an AI/ML Model with a mix of labelled data |
| learning | and unlabeled data |
| Reinforcement | A process of training an AI/ML Model from input (a.k.a. state) and a feedback signal (a.k.a. |
| Learning (RL) | reward) resulting from the AI/ML Model's output (a.k.a. action) in an environment the |
| | AI/ML Model is interacting with. |

### AI/ML Implementation in the RAN

In accordance with an embodiment, AI/ML Models may be implemented in the following configurations:
Single-sided AI/ML functionality at the BS/NW only,
Single-sided AI/ML functionality at the UE only,
Dual-sided joint AI/ML functionality at both the UE and BS/NW (joint operation).

A single-sided AI/ML implementation is one where an AI/ML Model training process need not include details of the air interface. For example, consider an AI/ML Model for enhancing Beam management operating in the UE. If the output of the AI/ML Model is signaled over the air interface as part of a CSI report or beam management report, then the BS can interpret the content of the CSI report without using the AI/ML Model. The BS does not need an AI/ML Model to be jointly trained with the UE's AI/ML Model to decode the CSI report.

In accordance with an embodiment as shown in FIG. 7, an AI/ML Model may be implemented on a BS (300) (BS-side AI/ML Model), for example a BS (300) as described above in conjunction with FIGS. 3 and/or 6. According to this embodiment, a UE (200) may send one or more measurement reports (710) based on received reference signals (700). Measurement reports (700) may include, for example, one or more of a CSI report (including one or more of CQI (Channel Quality Information), PMI (Precoding Matrix Indicator), CRI (CSI-RS Resource Indicator), SSBRI (SS/PBCH Resource Block Indicator), LI (Layer Indicator), RI (Rank Indicator) and/or L1-RSRP), a Beam measurement report (including one or more of Beam pairs, Beam IDs, CSI resources, measured RSRPs, and/or measured SINRs), a UE location, a UE speed, and/or a neighbouring cell report (including one or more of neighbour cell IDs, neighbour cell frequencies, neighbour cell RSRP, neighbour cell RSRQ, and/or neighbour SINR). A BS (300) may provide information contained in a measurement report(s) (710) to appropriate AI/ML Model(s) (720) which in turn may generate one or more BS inferences. These one or more BS inferences may be used to predict one or more BS decisions including scheduling, modulation and coding rate, number of MIMO layers, number of antennas, Beam pairs, UE location, channel conditions, optimal UE transmission power, and potential handover conditions, for example. Further, a BS (300) may transmit to a UE control information (730) indicating a BS decision. The control information (730) may indicate one or more of scheduling, modulation and coding rate, number of MIMO layers, number of antennas, Beam pairs, optimal UE transmission power, handover command, and reference signal resources information, reference signal resource pattern, and a measurement report request, for example.

In accordance with an embodiment as shown in FIG. 7, an AI/ML Model may be implemented on a BS (300) (BS-side AI/ML Model), for example a BS (300) as described above in conjunction with FIGS. 3 and/or 6. According to this embodiment, a BS (300) may receive data (710) from a plurality of UEs in its coverage for feeding to its AI/ML Model. A BS (300) may use the AI/ML Model to predict the decisions for new UE(s) coming into the BS coverage area or a UE moving from one location to a new location in the coverage area. A BS (300) may feed the real-time information and/or past information of the UEs in its coverage to predict one or more BS decisions for new UE(s) or UE(s) moving from one location to a new location in its coverage including, for example, resource scheduling information, MIMO parameters (such as, for example, number of layers, number of antenna ports, or number of codewords), Modulation and Coding Scheme, Bandwidth part(s), UE Transmit Power, waveform type (CP-OFDM or DFST-s-OFDM), numerology/sub-carrier spacing, handover decision and/or information of UE transmit/receive Beam pairs. Further, a BS (300) may transmit to a new UE(s) or UE(s) moving from one location to a new location in its coverage UE control information (730) indicating a BS decision.

In accordance with an embodiment as shown in FIG. 8, an AI/ML Model may be implemented on a UE (200) (UE-side AI/ML Model), for example a UE (200) as described above in conjunction with FIGS. 2 and/or 5. According to this embodiment, a UE (200) may receive the reference signals (800) from a BS (300) and estimate, for example, the channel characteristics and/or beam characteristics using the AI/ML Model(s) (820). Based on the output of a UE inference a UE (200) may transmit one or more measurement reports (810). The measurement report(s) (810) may include one or more of a CSI report (including one or more of CQI (Channel Quality Information), PMI (Precoding Matrix Indicator), CRI (CSI-RS Resource Indicator), SSBRI (SS/PBCH Resource Block Indicator), LI (Layer Indicator), RI (Rank Indicator) and/or L1-RSRP), a Beam measurement report (including one or more of Beam pairs, Beam IDs, CSI resources, measured RSRPs, and/or measured SINRs), UE location, UE speed, and/or a neighbouring cell report (including one or more of neighbour cell IDs, neighbour cell frequencies, neighbour cell RSRP, neighbour cell RSRQ, and/or neighbour cell SINR), for example. The measurement report(s) (810) may include an indicator that report is generated using an AI/ML module or an AI/ML model and may optionally include one or more of an AI/ML Model identifier (or index), AI/ML Module identifier (or AI/ML Model family identifier (or index), or an AI/ML Model Configuration identifier (or index). Based on received measurement report(s) (810) a BS (300) may make decisions regarding one or more of scheduling, modulation and coding rate, number of MIMO layers, number of antennas, Beam pairs, UE location, channel conditions, optimal UE transmission power, and potential handover conditions, for example. A BS (300) may transmit to a UE control information (830) indicating a BS decision. The control information (830) may indicate one or more of scheduling, modulation and coding rate, number of MIMO layers, number of antennas, Beam pairs, optimal UE transmission power, handover command, reference signal resources information, reference signal resource pattern, measurement report request, for example.

A dual-sided or joint AI/ML implementation is one where the AI/ML Model is trained for joint use in both a UE and a BS, taking into account the air interface. For example, consider a CSI implementation where an AI/ML-based encoder in a UE compresses downlink CSI-RS based channel (feature) estimates and an AI/ML-based decoder in a BS decompresses those estimates. In this instance, the CSI report signaled over the uplink may only be decodable by an appropriately trained AI/ML Model in a BS.

To limit system complexity in a dual-sided or joint AI/ML implementation, it may be desirable that:
A BS side AI/ML Model can achieve good performance with many different UE-side AI/ML Models developed by different vendors, and
A UE CSI AI/ML Model can achieve good performance with many different BS-side AI/ML Models developed by different vendors.

In accordance with an embodiment shown in FIG. 9, an AI/ML Model, or aspects thereof, may be implemented on both UE (200) and BS (300), for example a UE (200) as described above in conjunction with FIGS. 2 and/or 5, and a BS (300) as described above in conjunction with FIGS. 3 and/or 6. According to this embodiment, a UE (200) may receive reference signals (900) from a BS (300) and estimate channel characteristics and/or Beam characteristics using one or more AI/ML Model(s) (920). Based on an output of a UE Model Inference Engine a UE (200) may transmit a measurement report (910). A measurement report (910) may include one or more of the CSI report (including one or more of CQI (Channel Quality Information), PMI (Precoding Matrix Indicator), CRI (CSI-RS Resource Indicator), SSBRI (SS/PBCH Resource Block Indicator), LI (Layer Indicator), RI (Rank Indicator) and/or L1-RSRP), Beam measurement report (including one or more of Beam pairs, Beam IDs, CSI resources, measured RSRPs, and/or measured SINRs), UE location, UE speed, and/or neighboring cell report (including one or more of neighbor cell IDs, neighbor cell frequencies, neighbor cell RSRP, neighbor cell RSRQ, and/or neighbor cell SINR). The measurement report(s) (910) may include an indicator that report is generated using an AI/ML module or an AI/ML model and may optionally include one or more of an AI/ML Model identifier (or index), AI/ML Module identifier (or AI/ML Model family identifier (or index)), or an AI/ML Model Configuration identifier (or index). A BS (300) may provide information contained in a measurement report (910) to AI/ML Model(s) (940) and, based on an output of one or more BS Model(s) Inference Engine(s), BS (300) may predict one or more BS decisions including, for example, scheduling, modulation and coding rate, number of MIMO layers, number of antennas, Beam pairs, UE location, channel conditions, optimal UE transmission power, potential handover situation, UE AI/ML Model re-training, UE AI/ML Model switching, UE AI/ML Model update, UE AI/ML Model activation/deactivation, and/or UE AI/ML Model replacement, for example. The BS (300) may transmit to the UE control information (930) indicating a BS decision. Control information (930) may indicate, for example, one or more of scheduling, modulation and coding rate, number of MIMO layers, number of antennas, Beam pairs, optimal UE transmission power, handover request, reference signal resources information, reference signal resource pattern, measurement report request, UE AI/ML Model re-training request, UE AI/ML Model or AI/ML Model configuration switching request, AI/ML Model or AI/ML Engine to non-AI/ML signal processing module switching request, UE AI/ML Model update request, UE AI/ML Model activation/deactivation request, UE AI/ML Model performance parameters (such as AI/ML Model performance threshold), UE location request, UE speed request, UE Direction (or trajectory) vectors, and/or UE AI/ML Model replacement request.

In accordance with an embodiment shown in FIG. 9, an AI/ML Model, or aspects thereof, may be implemented on both UE (200) and BS (300), for example, a UE (200) as described above in conjunction with FIGS. 2 and/or 5, and a BS (300) as described above in conjunction with FIGS. 3 and/or 6. According to this embodiment, a BS (300) may receive data from a plurality of UEs in its coverage for feeding to its AI/ML Model (940). A BS (300) may use an AI/ML Model to predict the decisions for new UE(s) coming into the BS coverage area or a UE moving from one location to a new location in the coverage area. A BS (300) may provide real-time information and/or past information of UEs in its coverage to predict one or more BS decisions for new UE(s) or UE(s) moving from one location to a new location in its coverage including, for example, resource scheduling information, MIMO parameters (such as, for example, number of layers, number of antenna ports, or number of codewords), Modulation and Coding Scheme, Bandwidth part(s), UE Transmit Power, waveform type (CP-OFDM or DFST-s-OFDM), numerology/sub-carrier spacing, handover decision and/or information of UE transmit/receive Beam pairs, reference signal resources information, reference signal resource pattern, measurement report request, UE AI/ML Model re-training request, UE AI/ML Model or AI/ML Model configuration switching request, AI/ML Model or AI/ML Engine to non-AI/ML signal processing module switching request, UE AI/ML Model update request, UE AI/ML Model activation/deactivation request, UE AI/ML Model performance parameters (such as AI/ML Model performance threshold), UE location request, UE speed request, UE Direction (or trajectory) vectors, and/or UE AI/ML Model replacement request . . .

According to embodiments, dual-sided AI/ML Models may be deployed in a RAN (including a BS and a UE) with the following collaboration configurations:
Category 1: No collaboration between UE and BS
Category 2: Signaling-based collaboration between UE and BS without AI/ML Model transfer.
Category 3: Signaling-based collaboration between UE and BS with AI/ML Model transfer.
Category 4: Joint (UE and BS) AI/ML Model training and/or inference

UE and BS described in context of Category 2, Category 3 and Category 4 may refer to a UE (200) as described above in conjunction with FIGS. 2 and/or 5, and a BS (300) as described above in conjunction with FIGS. 3 and/or 6.

In Category 1, the application of AI/ML may be purely implementation-based. AI/ML Model(s) may be trained and/or used at either UE or BS but there are no information exchanges between a UE and BS for AI/ML purposes.

A Category 1 type deployment may be useful in the following scenarios:
CSI report with time prediction: based on a CSI report of a UE, a BS may predict a future channel.
Beam prediction in the time domain: like CSI prediction, a BS may predict a future beam quality based on a beam report of a UE.
AI/ML based OTDOA estimate at a UE with training and inference transparent to the NW.

In Category 2, signaling information is exchanged over an air-interface to facilitate AI/ML operations, e.g., training and/or inference to enable the application of AI/ML on BS and/or UE. However, there is no Model transfer between them.

The signaling may include RRC layer signaling, physical layer signaling, or MAC layer signaling, or combinations thereof to exchange information such as:
UE to BS signaling may include one or more of the following for example:
   A measurement report including CQI (Channel Quality Information), PMI (Precoding Matrix Indicator), CRI (CSI-RS Resource Indicator), SSBRI (SS/PBCH Resource Block Indicator), LI (Layer Indicator), RI (Rank Indicator) and/or L1-RSRP.
   An AI/ML Report including details of the AI/ML Model used by UE such as weights, number of layers, number of nodes per layer, or hidden nodes.
   AUE may signal parameters such as, for example, an AI/ML Model indicator (or index), AI/ML Model family indicator (or index), AI/ML Model configuration indicator (or index), an AI/ML Model family, an AI/ML Model or AI/ML Model configuration activation or deactivation request, and/or a request for switching an AI/ML Model or AI/ML Model configuration.
   A UE may also signal UE speed and/or UE location and/or direction (or trajectory) vector(s).
BS to UE signaling may include one or more of the following for example:
   An AI/ML Report including details of an AI/ML Model to be used by UE which may include, for example, weights, number of layers, number of nodes per layer, or hidden nodes.
   A BS may signal parameters such as an AI/ML Model indicator (or index), AI/ML Model family indicator (or index), AI/ML Model configuration indicator (or index), an AI/ML Model family, an AI/ML Model or AI/ML Model configuration activation or deactivation request, and/or a request for switching AI/ML Model or AI/ML Model configuration.
   A BS may also request a UE measurement report, speed, and/or location and/or direction (or trajectory) vector(s).

An AI/ML Model indicator (or index) may indicate an AI/ML Model being used or to be used. It may indicate an AI/ML Model within a family of AI/ML Models.

In accordance with an embodiment, one or more bits of an AI/ML Model indicator (or index) may indicate a family of AI/ML Models and one or more bits may indicate a specific AI/ML Model within an AI/ML Model family. For example, in the case of a 4-bit AI/ML Model indicator, 2 bits may indicate AI/ML Model family and 2 bits may indicate a specific AI/ML Model within the AI/ML Model family. Other amounts of bits and encodings could be used for this purpose. In accordance with another embodiment, one or more bits of an AI/ML Model indicator (or index) may indicate a family of AI/ML Models, other one or more bits may indicate a specific AI/ML Model within an AI/ML Model family, and yet other one or more bits may indicate AI/ML Model configuration. For example, in the case of a 6-bit AI/ML Model indicator (or index), 2 bits may indicate AI/ML Model family, 2 bits may indicate a specific AI/ML Model within the AI/ML Model family, and 2 bits may indicate a specific AI/ML Model configuration within the specific AI/ML Model. Other amounts of bits and encodings could also be used for this purpose.

An AI/ML Model family, an AI/ML Model or AI/ML Model configuration activation/deactivation status may indicate a status of an AI/ML Model family, an AI/ML Model or AI/ML Model configuration, for example, whether it is activated or deactivated.

In accordance with an embodiment, an AI/ML Model or AI/ML Model configuration activation/deactivation status may indicate the activation and/or deactivation status of multiple AI/ML Models or AI/ML Model configurations simultaneously. For example, a UE may indicate the status of all the AI/ML Models or AI/ML Model configurations in a bit pattern, where an individual bit may correspond to an AI/ML Model or an AI/ML Model configuration.

In accordance with an embodiment, an AI/ML Model activation/deactivation status may indicate the activation and/or deactivation status of multiple AI/ML Model families simultaneously. For example, a UE may indicate the status of which AI/ML Model families are activated and/or deactivated using a bit pattern, where an individual bit may correspond to an AI/ML Model family.

The AI/ML Model activation/deactivation request may indicate activation and/or deactivation of a specific AI/ML Model or an AI/ML Model family.

In accordance with an embodiment, an AI/ML Model or AI/ML Model configuration activation/deactivation request may indicate activation and/or deactivation of multiple AI/ML Models simultaneously. For example, the BS may request UE to activate and/or deactivate multiple AI/ML Models or AI/ML Model configurations using a bit pattern, where an individual bit may correspond to an AI/ML Model or AI/ML Model configuration.

In accordance with an embodiment, an AI/ML Model activation/deactivation request may indicate activation and/or deactivation of multiple AI/ML Model families simultaneously. For example, the BS may request UE to activate and/or deactivate multiple AI/ML Model families using a bit pattern, where each bit may correspond to an AI/ML Model family.

Other combinations or a subset of information may be used for such signaling.

A Category 2 type deployment may be useful in the following scenarios:
Reference signal overhead reduction for channel estimation using CSI compression.
Beam prediction in spatial/time domain: UE may measure qualities of a small number of beam pairs and estimate qualities of more (including all in an embodiment) beam pairs or best beam pairs.
Positioning accuracy may be improved by signaling BS antenna information or calibration information to UE.

In Category 2 type deployment for AI/ML Model training, a UE may send UE capabilities and/or a BS may send reference signal patterns.

In a Category 3 type deployment: on top of category 2, an air-interface may be further enhanced to allow the transfer of AI/ML Models between a UE and a BS. In this category, an AI/ML Model can be trained on one side of the network and delivered to the other side for inference/execution. However, there is no joint AI/ML operation between the two sides.

The AI/ML Model size could range from some KBs to hundreds of MBs. Considering the overhead of AI/ML Model transfer, it may be useful to define the format of AI/ML Model exchange as well as the corresponding signaling.

### AI/ML Model Transfer:

According to an embodiment, a BS may send RRC signaling and/or physical layer signaling to a UE including AI/ML Model configuration information and a UE may upload and/or download an AI/ML Model based on the received AI/ML Model configuration information. AI/ML configuration information may include, for example, one or more of details of performance metric to be used, AI/ML Model format (or file type), AI/ML Model parameters such as one or more of coefficients, weights, biases, number of AI/ML tasks, AI/ML task identifier(s), classifier (such as Regression, KNN, Vector machine, Decision Tree, Principal component, for example), cluster centroids in clustering, and/or hyper-parameters such as number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, Tan h), choice of an optimization algorithm (e.g., gradient descent, stochastic gradient descent, or Adam optimizer). AI/ML configuration information may also include details of AI/ML Model download and/or upload location such as, for example, a server address, URL for upload and/or download, details of API for downloading and/or uploading, or details of application for uploading and/or downloading.

According to an embodiment, a UE may download an AI/ML Model based on received AI/ML configuration information over an application layer. The downloading may be done using an API.

According to an embodiment, a UE may download an AI/ML Model based on received AI/ML configuration information using a predefined URL created by a UE based on the received configuration information and parameters.

According to an embodiment, a UE may download an AI/ML Model from a core network entity, or an edge server based on received AI/ML configuration information.

According to an embodiment, a UE may download an AI/ML Model from a UE manufacturer's server. A UE may reach a UE manufacturer's server using pre-stored information.

According to an embodiment, a UE may upload an AI/ML Model based on received AI/ML configuration information over an application layer. The uploading may be done using an API.

According to an embodiment, a UE may upload an AI/ML Model to a core network entity, or an edge server based on received AI/ML configuration information.

According to an embodiment, a UE may upload an AI/ML Model to a network operator's server. A UE may reach the network operator's server using pre-stored information.

### AI/ML Model Transfer Format:

A common format for exchanging/transferring AI/ML Models may be defined to make UE manufacturer or network operator specific proprietary AI/ML Models compatible with each other. An example of a common format may include Open Neural Network Exchange (ONNX), an open-source AI/ML format, more details are available at https://onnx.ai/. A trained AI/ML Model file may contain information on one or more of the parameters such as, for example, number of layers, weights/bias, quantization being used, and/or details of the loss function, of the deep neural network.

An AI/ML Model may be saved in a file format depending on the machine learning framework used. Table 2 lists example frameworks and file formats for storing AI/ML Models. A new AI/ML Model file format may be developed for use in a wireless environment, however, the person skilled in the art would understand that the AI/ML Model parameters may remain similar.

TABLE 2

| Framework | File Format | File extension |
|---|---|---|
| PyTorch | ONNX | .onnx |
| PyTorch | Torch Script | .pt |
| Keras | H5 | .h5 |
| iOS Core ML | Apple ML Model | .mlmodel |
| TensorFlow | Protobuf | .pb |
| Scikit-learn | Pickled Python | .pkl |
| Scikit-learn | PMML | .pmml |

In accordance with an embodiment, a BS may implement a format conversion module (312) for converting an AI/ML Model uploaded by a UE and/or for converting an AI/ML Model to be downloaded to the UE. For example, a Model Format Conversion Module as shown in FIGS. 2 and 3 may operate to interconvert the formats as presented in Table 2 (or its variations developed with the advancements of the AI/ML technology). For instance, a BS may convert the AI/ML Model to a .mlmodel file before downloading it to an Apple smartphone.

A Category 3 type deployment may be useful in the following scenarios:
CSI Prediction with AI/ML Model from BS: BS may send an AI/ML Model to a UE and a UE may use this AI/ML Model to predict the future channel.
Beam prediction in spatial/time domain with AI/ML Model from BS: a BS may send an AI/ML Model that matches its beam pattern and wireless environment to a UE. A UE may use this AI/ML Model to find the best beam pairs.
AI/ML Model for positioning accuracy may be trained/aggregated at a BS for an environment and distributed to a UE to expedite training at a UE.

In a Category 3 type deployment for AI/ML Model training, information may be exchanged between UE and BS. The information may include hyperparameters for training. The hyperparameters are parameters whose values may control the learning process and determine the values of AI/ML Model parameters that a learning algorithm ends up learning. Hyperparameters may be used during AI/ML Model training when it is being trained but they are not part of the resulting AI/ML Model. For example, a number of hidden layers, a Number of activation units in each layer, a drop-out rate (dropout probability), a Number of iterations (epochs), a Number of clusters in a clustering task, a Kernel or filter size in convolutional layers, a Pooling size, a Batch size, a Learning rate in optimization algorithms (e.g. gradient descent), an optimization algorithm (e.g., stochastic gradient descent, gradient descent, or Adam optimizer), an activation function in a neural network (nn) layer (e.g. Sigmoid, ReLU, Tan h), a choice of cost or loss function of the AI/ML Model, and/or a Train-test split ratio.

In a Category 4 type deployment: on top of category 3, joint AI/ML operations between UE and BS may be used, e.g., AI/ML Model training and/or inference (e.g., federated learning algorithms or autoencoder-type of AI/ML Models).

In a Category 4 type deployment joint AI/ML operation AI/ML Models may be split into multiple parts where both BS and UE may be involved in training the AI/ML Model. For example, in a CSI feedback enhancement use case, to reduce CSI feedback overhead, autoencoder-like or transformer-like AI/ML Model-based compression and recovery may be applied, where a UE is the encoder, a BS is a decoder, and a joint AI/ML Model training and a joint AI/ML Model inference may be expected. This type of AI/ML operation may require tight collaboration between a UE and BS since intermediate data (e.g., compressed CSI/PMI) may need to be exchanged.

A Category 4 type deployment may be useful in the following scenarios:
CSI Payload overhead reduction: That is, UE may encode the channel information by AI/ML Model to generate PMI. Then BS may use the matched AI/ML Model to decode PMI.
Beam information compression in spatial/time domain with AI/ML based encoder and decoder: UE may use the AI/ML Model to compress the Beam information, which may be decoded by BS.
UE side positioning AI/ML Model may extract features from UE's measurements and report to the BS for feeding to the BS side AI/ML Model for determining UE's position.

In a Category 4 deployment for AI/ML Model training, periodic training information may be exchanged between UE and BS. The information may include gradient or loss function results.

In a Category 4 type deployment joint AI/ML operation AI/ML Models may be split into multiple parts, and tasks may be dynamically divided between the UE (for example, a UE described in conjunction with FIGS. 2 and/or 5) and the base station (for example, as described in conjunction with FIGS. 3 and/or 6). For example, if a UE's current battery is low, UE's overall processing load is high, larger number of AI/ML tasks are executed currently or scheduled, or currently executed or scheduled AI/ML tasks are complex, the UE may request the base station to split the tasks in such a way that UE processing load is reduced. The UE may send a request indicating one or more of a current task splitting ratio, a desired task splitting ratio, AI/ML Model indicator (or index), AI/ML configuration indicator (or index), AI/ML task indicator (or index), a reason for change in the current task splitting ratio (for example: battery status, memory status, current processing load indicator, or task complexity indicator) to the base station. Based on the received request the base station may change the current task splitting ratio between the UE and the base station to a new task splitting ratio and send control information to the UE indicating the new task splitting ratio. The new task splitting ratio may or may not be same as the desired task splitting ratio. The control information may also include one or more of AI/ML Model indicator (or index), AI/ML configuration indicator (or index), number of tasks, AI/ML task indicators (or indices) for currently executed or scheduled AI/ML tasks to be stopped by the UE, AI/ML task indicators (or indices) for tasks to be moved to base station for execution, or a request for sending the data for tasks to be executed by the base station. The UE, after receiving the control information from the base station performs one or more of stop the AI/ML tasks indicated by the base station, share the data for the tasks to be executed at the base station.

### AI/ML Model Deployment Scope

In accordance with an embodiment, a scope of AI/ML Model deployment (for example, as described in conjunction with FIG. 7 or 9) may be configured as per the following example configurations:
AI/ML Model applicable per UE
AI/ML Model applicable per UE group
AI/ML Model applicable per BS (or Cell)

The complexity of implementing an AI/ML Model applicable per UE may be higher than implementing AI/ML Model applicable per UE group, which is higher than AI/ML Model applicable per BS (or Cell). However, at the cost of implementation complexity improved gain may be achieved when implementing AI/ML Model applicable per UE or per UE group.

According to an embodiment, a BS (300) (for example, as described in conjunction with FIGS. 3 and/or 6) may generate unicast signaling specific to an AI/ML Model when implementing an AI/ML Model per UE. The signaling may include a UE identifier that is specific to a UE and the AI/ML Model configurations. Further, details of AI/ML Model configurations could be identified from the other sections of this patent specification.

According to an embodiment, a BS (300) (for example, as described in conjunction with FIGS. 3 and/or 6) may transmit signaling specific to an AI/ML Model to multiple UEs simultaneously when implementing AI/ML Model per UE. Signaling may include multiple UE identifiers corresponding to different UEs and AI/ML Model configurations. Further, details of AI/ML Model configurations can be identified from the other sections of this patent specification.

According to an embodiment, a BS (300) (for example, as described in conjunction with FIGS. 3 and/or 6) may generate multicast signaling specific to AI/ML Model when implementing AI/ML Model per UE group. The signaling may include a group identifier common for a group of UEs and the AI/ML Model configurations. Further, the details of AI/ML Model configurations can be identified from the other sections of this patent specification.

According to an embodiment, a BS (300) (for example, as described in conjunction with FIGS. 3 and/or 6) may generate broadcast signaling specific to an AI/ML Model when implementing AI/ML Model per BS (or Cell). Signaling may include a cell identifier and/or a BS identifier which is common for UEs implementing AI/ML Models in the cell and AI/ML Model configurations. Further, the details of AI/ML Model configurations can be identified from the other sections of this patent specification.

### AI/ML Data Collection Framework

According to an embodiment, a BS (300) (for example, as described in conjunction with FIGS. 3 and/or 6) may collect and maintain historical data of UEs and create a cell map based on one or more of the following example parameters:
Time
Frequency
Location
Spatial Orientation

A Time parameter of a cell map may refer to the time of day. Time parameters may be associated with the number of UEs in each location within a BS coverage (or cell). For example, during the daytime in a high street market more UEs may be present as compared to the night-time. Similarly, during certain hours in a day, a given location may have a greater number of UEs. This information may be beneficial to BS in scheduling resources for UEs and estimating channel conditions.

In an embodiment, a Time parameter may also refer to a timestamp of data collection. The timestamp may be used to predict the future values of a parameter. For example, data collected between the duration of T1 to T2 may be used to predict the characteristics of a wireless channel for the duration of T3 to T4, where T1<T2<T3<T4. The parameter could refer to CSI-prediction, Beam pair prediction, location prediction, transmit power prediction, MIMO related parameters prediction, a Channel Coding and/or Modulation prediction, and/or a Carrier Aggregation related parameters prediction.

A Frequency parameter of a cell map may refer to any of frequency bands, configured channel bandwidth, bandwidth parts (BWPs), number of subcarriers, or subcarrier spacing.

A Location parameter of a cell map may refer to a 2D UE location in the cell or a 3D UE location in the cell. A 3D UE location may also include the height of a UE from ground or sea level. For example, if UE is present in a high-rise building, 3D location may be more useful in estimating the channel conditions, whereas if UE is standing or moving on a road 2D location may be more useful in estimating the channel conditions.

A Spatial Orientation parameter of a cell map may refer to the direction of UE transmission or reception from a BS. Spatial orientation may refer to either a 2D orientation or a 3D orientation. For example, if a UE is in a dual connectivity mode or if it is communicating with multiple TRPs, there may be two or more spatial orientations for the UE each directing towards the BSs/TRPs. The Spatial Orientation may be represented in angles such as, for example, angle of arrival (AoA) or angle of departure (AoD).

Collected data may be associated with a Geographical Map of the cell. A geographical map may be helpful in identifying the non-line of sight (NLOS) conditions for a UE and predicting various parameters such as channel conditions, location, and/or beam related parameters of a moving UE, for example. A geographical map may be a 3D map or a 2D map.

A data collection framework may be used to collect information such as, for example, RSRP/RSRQ/SINR, UE/BS Beam-related information, UE trajectories, and/or UE speed. Table 3 below provides an exemplary table that may be maintained by BS for collecting data for feeding to the AI/ML Model.

TABLE 3

| | | | | | | | Beam | |
|---|---|---|---|---|---|---|---|---|
| | | Frequency | CC | | Spatial | CSI- | Pair | UE |
| | Time | Band | Frequency | Location | Orientation | RSRP | (Beam | Speed |
| UE 1 | T1 | 2100 MHz | 20 MHZ | Latitude: X | AoA: 30° | X DBm | #1 | 10 |
| | | Band | | Longitude: Y | AoD: 10° | | and #4 | KM/H |
| UE 1 | T2 | 2100 MHz | 20 MHZ | Latitude: U | AoA: 30° | Y DBm | #10 | 20 |
| | | Band | | Longitude: V | AoD: 20° | | and | KM/H |
| | | | | | | | #20 | |
| UE 1 | T3 | 2100 MHz | 20 MHZ | Latitude: K | AoA: 35° | Z DBm | #11 | 50 |
| | | Band | | Longitude: S | AoD: 15° | | and | KM/H |
| | | | | | | | #22 | |
| . . . | . . . | . . . | | . . . | . . . | | | |
| UE N | T1 | 3700 MHz | 20 MHZ | Latitude: A | AoA: 20° | N DBm | #1 | 40 |
| | | Band | | Longitude: | AoD: 10° | | and #6 | KM/H |
| | | | | B | | | | |
| UE N | T2 | 3700 MHz | 20 MHZ | Latitude: C | AoA: 10° | P DBm | #12 | 60 |
| | | Band | | Longitude: | AoD: 20° | | and | KM/H |
| | | | | D | | | #21 | |
| UE N | T3 | 2100 MHz | 20 MHZ | Latitude: U | AoA: 30° | K DBm | #10 | 80 |
| | | Band | | Longitude: V | AoD: 20° | | and | KM/H |
| | | | | | | | #20 | |

Table 3 may be modified by adding and/or removing parameters to cater to different scenarios without departing from the broader spirit of the invention.

Further, a UE may also maintain a table like Table 3 for providing information to a UE side AI/ML Model for generating inferences.

Data collection and storage at a BS: According to an embodiment a BS may collect, and store data received from UEs according to a data collection framework.

### Data Collection and Storage Based on Reference Signals:

According to an embodiment a BS may collect data according to a data collection framework based on a reference signals (e.g., SRS, and DMRS) received from the UEs. A BS may estimate values based on received reference signals and store the estimated values together with associated Time, Frequency, Location, and/or Spatial Orientation information. Data collection may be performed on demand, periodically, or continuously as per its configuration. Further, collected data may be stored at a BS, a node in the core network, and/or a server of a network operator.
Estimated values may include one or more of the following:
   RSRP/RSRQ/RSSI
   Channel Quality
   Beam related parameters
   MIMO related parameters
   Interference and noise related parameters

### Data Collection and Storage Based on Measurement Reports or UE Feedback:

According to an embodiment a BS may collect data according to a data collection framework based on measurement reports and/or feedback received from UEs. A BS may extract values from received measurement reports and/or feedback and store the values together with associated Time, Frequency, Location, and/or Spatial Orientation information. A data collection step may be performed on demand, periodically, or continuously as per the configuration. Further, collected data may be stored at a BS, a node in the core network, and/or a server of a network operator.
In an embodiment, a UE (200) may provide the following to the BS (200):
   UE location information including coordinates (2D or 3D coordinates), UE Speed, UE direction or trajectory vectors or Serving cell ID.
   UE measurement report including Beam level or cell level measurements of UE measured RSRPs, RSRQs, SINRs, or SNRs.

Data collection and storage at UE: According to an embodiment a UE (200) may collect, and store data received from Base station(s) (300) according to a data collection framework.

### AI/ML Model Configurations:

According to an embodiment, a UE (200) and/or Base station (300) may be deployed with a single AI/ML Model, a family of AI/ML Models, a set of AI/ML Models, and/or a set of families of AI/ML Models. As shown in FIG. 5 for a UE (200) and FIG. 6 for a BS (300), a set of families of AI/ML Models correspond to multiple AI/ML Model families. For example, a CSI module may represent AI/ML Model Family 1, Beamforming module may represent AI/ML Model family 2, Positioning module may represent AI/ML Model family 3, and Power control module may represent AI/ML Model family 4.

A family of AI/ML Models may include different configurations of an AI/ML Model for a particular function or different AI/ML Models for a particular function. For example, the function may correspond to any one of CSI Prediction, CSI compression, Beam management, positioning, or power control.

A set of AI/ML Models may include two or more AI/ML Models for a particular function. For example, the function may correspond to any one of CSI Prediction, CSI compression, Beam management, positioning, or power control.

A set of families of AI/ML Models may include two or more AI/ML Model families for a particular function. For example, the function may correspond to any one of CSI Prediction, CSI compression, Beam management, positioning, or power control. Each family may correspond to different configurations of an AI/ML Model and there may be two or more AI/ML Models for the particular function, or each family may correspond to different type of input. The input may correspond to the reference signal inputs such as CSI-RS, DMRS, SSB, SRS, or PT-RS. For example, a set of families of AI/ML Models corresponds to downlink, where a first family corresponds to the two or more AI/ML Model taking CSI-RS as the input and a second family may corresponds to the two or more AI/ML Model taking SSB signals as the input.

In accordance with an embodiment, an example of different configurations of an AI/ML Model may include a first configuration of the AI/ML Model corresponding to a high SNR situation and another configuration of the AI/ML Model corresponding to a low SNR situation. Adaptation of the same AI/ML Model for different situations by adjustment of various AI/ML Model parameters corresponds to the different configurations of the AI/ML Model. Another example of different configurations of an AI/ML Model may include a first configuration of the AI/ML Model corresponding to high mobility situation and another configuration of the AI/ML Model corresponding to low mobility situation.

In accordance with an embodiment, an AI/ML Model in a family of AI/ML Models may be trained to target a specific propagation environment of wireless signals, for example LOS and NLOS scenarios, indoors and outdoors scenarios, slow and fast-moving scenarios. In different scenarios, the characteristics of wireless channels can be diverse, for example, the multipath distribution characteristics and the channel sparsity could be very different. AI/ML is good at learning channel characteristics in a data-driven manner and performing a variety of signal processing tasks more efficiently. An AI/ML Model in a family of AI/ML Models may be trained with a scenario specific training dataset, and a suitable AI/ML Model could be selected from the family of AI/ML Models for inference to adapt to various scenarios.

The broader concepts are not limited to the set of AI/ML Modules and/or Models disclosed in the descriptions as there may be additional AI/ML Modules and/or Models as per the need and requirements of the network operator and UE manufacturers.

### Signaling for AI/ML Model Training

In accordance with an embodiment as presented in FIG. 10, an AI/ML Model may be trained on BS (on-BS training), such as the BS (300) described in conjunction with FIGS. 3 and/or 6, a UE (200) (for example, a UE described in conjunction with FIGS. 2 and/or 5), may download a trained AI/ML Model or receive parameters of a trained AI/ML Model. The BS (300) may receive UE capability information (1000), which may contain one or more of the following:
UE processing capability (AI/ML processor configuration such as, for example, type of processor, type of processor configuration, or number of operations per second), memory configuration (size or available space). The UE processing capability may include a UE training processing capability or a UE inference processing capability.
Indication for supported AI/ML Model formats. For example, AI/ML Model formats as shown in table 2.
Indication for support of collaboration categories:
   Category 1: No collaboration between UE and BS.
   Category 2: Signaling-based collaboration between UE and BS without AI/ML Model transfer.
   Category 3: Signaling-based collaboration between UE and BS with AI/ML Model transfer.
   Category 4: Joint (UE and BS) AI/ML Model training and/or inference.
UE Category as defined by 3GPP indicating supported UE features. UE category may include UE types such as a reduced capability UE, URLLC UE or an eMBB UE.
Configured AI/ML Model families such as, for example, CSI Compression, CSI prediction, Beam prediction, Positioning, Power Control. The AI/ML Model family may be represented by a unique identifier.
Configured AI/ML Models per family such as identifier(s) of AI/ML Model(s) or identifier(s) of AI/ML Model configuration(s) within an AI/ML Model family.
Configured AI/ML Model configuration(s) including one or more supported AI/ML features such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer).

Based on received UE capability information a BS (300) may determine an AI/ML Model and reference signal configuration (1010) and transmit RRC signaling and/or physical layer signaling indicating reference signal configuration (1020) which may include, for example one or more of reference signal pattern, reference signal resources, periodicity, resource offset, and/or antenna ports. The BS (300) may also transmit a trigger signaling as a part of reference signal configuration (1020) or as a separate signaling. The trigger signaling include trigger information for indicating to the UE (200) to start collecting data for AI/ML Model training at the BS (300). After transmitting reference signal configuration information (1020) and/or trigger signaling, a BS (300) may transmit reference signals (1030) to a UE (200) for one or more of, for example, channel estimation, CSI reporting, beam measurements, determining positioning, and/or measuring power. Based on received reference signals (1030) a UE (200) may transmit a measurement report (1040) to a BS (300) indicating such measurements including one or more of, for example, CSI report, channel eigen vectors, beam measurement report, positioning report, power measurement report, UE location, UE direction (or trajectory) vectors, and/or UE speed. A BS (300) may use the received measurement report for training and validation of the AI/ML Model (1050). Once the AI/ML Model is trained and validated (1050), a BS (300) may transmit a message (1060) to a UE (200) containing information to download the AI/ML Model or a message (1060) to a UE (200) containing AI/ML Model configuration parameters including trained AI/ML Model parameters such as, for example, weights, biases, number of AI/ML tasks, AI/ML task identifier(s), and/or cluster centroids in case of clustering. A UE (200) may download the AI/ML Model using AI/ML Model download information (1060) or receive AI/ML Model configuration parameters contained in the message (1060). An AI/ML Model download information (1060) may include a URL to be used for downloading. A BS (300) may transmit a message (1060) to a UE (200) containing information to download an AI/ML Model or a message (1060) to a UE (200) containing AI/ML Model configuration parameters using a physical layer signaling and/or RRC signaling.

An AI/ML Model training may include Supervised learning, Unsupervised learning, Semi-supervised learning, or Reinforcement Learning (RL). The advantage of training on BS is that BS may gather training data from multiple UEs, or the BS may simulate the training data.

In accordance with an embodiment as presented in FIG. 11, an AI/ML Model may be trained on a UE (200) (on-UE training) and a UE (200) may upload an AI/ML Model or transmit trained AI/ML Model parameters to a BS (300). A BS (300) may receive UE capability information and/or AI/ML Model information (1100). UE capability information or AI/ML Model information (1100) may contain one or more of the following for example:
UE processing capability (AI/ML processor configuration such as, for example, type of processor, type of processor configuration, or number of operations per second), memory configuration (size or available space). The UE processing capability may include a UE training processing capability or a UE inference processing capability.
Indication for supported AI/ML Model formats. For example, AI/ML Model formats as shown in table 2.
Indication for support of collaboration categories:
   Category 1: No collaboration between UE and BS.
   Category 2: Signaling-based collaboration between UE and BS without AI/ML Model transfer.
   Category 3: Signaling-based collaboration between UE and BS with AI/ML Model transfer.
   Category 4: Joint (UE and BS) AI/ML Model training and/or inference.
UE Category as defined by 3GPP indicating supported UE features. UE category may include UE types such as a reduced capability UE, URLLC UE or an eMBB UE.
Configured AI/ML Model families such as, for example, CSI Compression, CSI prediction, Beam prediction, Positioning, Power Control. AI/ML Model families may be represented by a unique identifier.
Configured AI/ML Models per family such as identifier(s) of AI/ML Model(s) or identifier(s) of AI/ML Model configuration(s) within AI/ML Model families.
Configured AI/ML Model configuration(s) including information regarding one or more supported AI/ML features such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), and/or choice of optimization algorithm (e.g., gradient descent, stochastic gradient descent, or Adam optimizer).

Based on received UE capability information and/or AI/ML Model information (1100), a BS (300) may determine an AI/ML Model and reference signal configuration (1110) and transmit RRC signaling or physical layer signaling indicating a reference signal configuration (1120) which may include one or more of reference signal pattern, reference signal resources, periodicity, resource offset, and/or antenna ports. The BS (300) may also transmit a trigger signaling as a part of reference signal configuration (1120) or as a separate signaling. The trigger signaling include trigger information for indicating to the UE (200) to start collecting data for AI/ML Model training at the UE (200). After transmitting the reference signal configuration (1120), a BS (300) may transmit reference signals (1130) to UE (200) for training and validation of the AI/ML Model (1140). Once the AI/ML Model is trained and validated (1140), the UE (200) may transmit a message (1150) to the BS (300) containing AI/ML Model upload information or a message (1150) to the BS (300) containing AI/ML Model configuration parameters including, for example, AI/ML Model Family identifier, AI/ML Model Identifier, AI/ML Model Configuration identifier, trained AI/ML Model parameters such as weights, biases, number of AI/ML tasks, AI/ML task identifier(s), and/or cluster centroids in case of clustering, and/or hyper-parameters used during the training (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)). The UE (200) may upload the AI/ML Model to a predefined location or transmit AI/ML Model configuration parameters contained in the message (1150). The AI/ML Model upload information may include an indicator indicating a successful AI/ML Model uploaded by UE (200). The UE (200) may transmit a message (1150) to the BS (300) containing AI/ML Model upload information and/or a message (1150) to the BS (300) containing AI/ML Model configuration parameters using a physical layer signaling or RRC signaling.

The AI/ML Model training may include Supervised learning, Unsupervised learning, Semi-supervised learning, and/or Reinforcement Learning (RL).

### Signaling for AI/ML Model Update

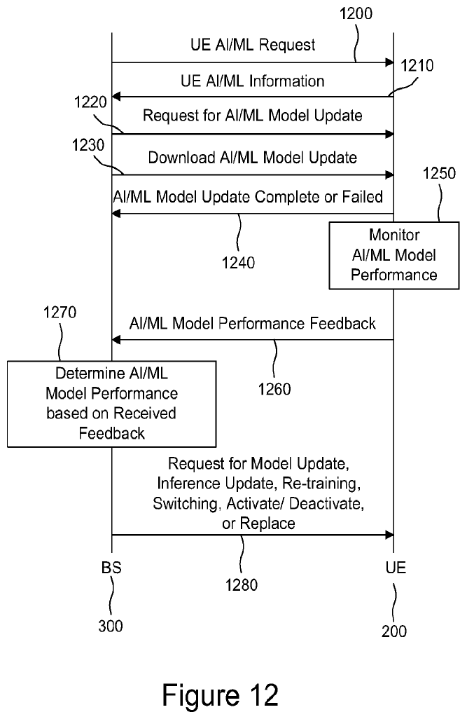

In accordance with an embodiment as presented in FIG. 12, a BS (300) (for example, as described in conjunction with FIGS. 3 and/or 6) may request a UE (200) (for example, as described in conjunction with FIGS. 2 and/or 5) for its AI/ML capability and/or information of supported/configured AI/ML Models in a UE AI/ML request (1200). The UE (200) may respond with AI/ML information (1210) containing one or more of the following:
UE processing capability (AI/ML processor configuration such as, for example, type of processor, type of processor configuration, or number of operations per second), memory configuration (size or available space). The UE processing capability may include a UE training processing capability or a UE inference processing capability.
Indication for supported AI/ML Model formats. For example, AI/ML Model formats as shown in table 2.
Indication for support of collaboration categories:
   Category 1: No collaboration between UE and BS.
   Category 2: Signaling-based collaboration between UE and BS without AI/ML Model transfer.
   Category 3: Signaling-based collaboration between UE and BS with AI/ML Model transfer.
   Category 4: Joint (UE and BS) AI/ML Model training and/or inference.
UE Category as defined by 3GPP indicating supported UE features. UE category may include UE types such as a reduced capability UE, URLLC UE or an eMBB UE.
Configured AI/ML Model families such as, for example, CSI Compression, CSI prediction, Beam prediction, Positioning, Power Control. AI/ML Model families may be represented by a unique identifier.
Configured AI/ML Models per family such as, for example, identifier(s) of AI/ML Model(s) and/or identifier(s) of AI/ML Model configuration(s) within AI/ML Model families.
Configured AI/ML Model configuration(s) including one or more supported AI/ML features such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), and/or choice of optimization algorithm (e.g., gradient descent, stochastic gradient descent, or Adam optimizer).

Based on received AI/ML information (1210) from a UE (200) a BS (300) may determine if UE supported/configured AI/ML Models are to be updated. An update may include an installation of new AI/ML Model(s) or AI/ML Model family(s), and/or re-configuration of an existing AI/ML Model(s) or AI/ML Model family(s) based on UE capabilities. A BS (300) may transmit a request for AI/ML Model update (1220) to a UE (200) containing whether to install a new AI/ML Model and/or re-configure an existing one. An AI/ML Model update request (1220) may include an identifier AI/ML Model(s), AI/ML Model configuration(s) and/or AI/ML Model family(s).

A UE (200) may, based on the received request for AI/ML Model update (1220), download (1230) and install an AI/ML Model(s), AI/ML Model configuration(s) and/or AI/ML Model family(s) indicated in the request (1220). A UE (200) may download (1230) an AI/ML Model(s), AI/ML Model configuration(s) and/or AI/ML Model family(s) from any of a BS (1220), a core network entity responsible for AI/ML Models in the RAN network, an edge server, or a network operator's server. The location from where the AI/ML Model(s) and/or AI/ML Model family(s) are to be downloaded may be indicated in the request (1220).

After AI/ML Model(s), AI/ML Model configuration(s) and/or AI/ML Model family(s) are downloaded and installed (1230), a UE (200) may send an acknowledgment (1240) to a BS (300) indicating whether an AI/ML Model(s), AI/ML Model configuration(s), and/or AI/ML Model family(s) is downloaded, and installation was successful or failed. In case of failure, a UE (200) may indicate which AI/ML Model(s), AI/ML Model configuration(s) and/or AI/ML Model family(s) was not successfully downloaded or installed (1230). A UE (200) may indicate success or failure by using a bit pattern indicating AI/ML Model(s), AI/ML Model configuration(s) and/or AI/ML Model family(s).

After an AI/ML Model(s), AI/ML Model configuration(s) and/or AI/ML Model family(s) is successfully installed (1230), a UE (200) may start monitoring the performance (1250) of AI/ML Model(s) or AI/ML Model configuration(s) across AI/ML Model families, if there are more than one AI/ML Model family installed, otherwise a UE (200) may start monitoring the performance (1250) of installed AI/ML Model(s) or AI/ML Model configuration(s). Based on the monitored performance (1250), a UE (200) may share the AI/ML Model performance feedback (1260) with a BS (300). The AI/ML Model performance feedback (1260) may include identifier(s) of AI/ML Model(s), AI/ML Model configuration(s) and/or AI/ML Model family(s). The AI/ML Model performance feedback (1260) may also include performance parameter corresponding to indicated AI/ML Models or AI/ML Model configuration(s) such as Classification metrics (e.g., Accuracy ratio, Precision, Recall, F1 score, or Confusion Matrix), Regression metrics (e.g., Mean Absolute Error (MAE), Mean Square Error (MSE), Root Mean Square Error (RMSE), normalized Mean Square Error (NMSE), Coefficient of Determination (commonly called R-squared), and/or Adjusted R-squared) and/or metrics for online iterative optimization such as optimization performance across iterations/runs.

A BS (300) may determine the AI/ML Model(s), AI/ML Model configuration(s) and/or AI/ML Model family(s) performance (1270) based on received performance feedback (1260) from a UE (200). Based on the determination of performance (1270) and comparing with required performance thresholds of received performance metrics a BS (300) may decide whether to update one or more AI/ML Model(s), AI/ML Model configuration(s) and/or AI/ML Model family(s), update the inference of one or more AI/ML Model(s), AI/ML Model configuration(s) and/or AI/ML Model family(s), re-train one or more AI/ML Model(s), AI/ML Model configuration(s) and/or AI/ML Model family(s), replace one or more AI/ML Model(s), AI/ML Model configuration(s) and/or AI/ML Model family(s), switch one or more AI/ML Model(s), AI/ML Model configuration(s) and/or AI/ML Model family(s), and/or activate/deactivate one or more AI/ML Model(s), AI/ML Model configuration(s) and/or AI/ML Model family(s).

A BS (300) may transmit to a UE (200) a request (1280) for updating one or more AI/ML Model(s), AI/ML Model configuration(s) and/or AI/ML Model family(s), updating the inference of one or more AI/ML Model(s), AI/ML Model configuration(s) and/or AI/ML Model family(s), re-training one or more AI/ML Model(s), AI/ML Model configuration(s) and/or AI/ML Model family(s), replacing one or more AI/ML Model(s) or AI/ML Model configuration(s), switching one or more AI/ML Model(s) or AI/ML Model configuration(s), or activating/deactivating one or more AI/ML Model(s), AI/ML Model configuration(s) and/or AI/ML Model family(s). The request (1280) may include the identifier(s) of indicated AI/ML Model(s) or AI/ML Model configuration(s) and request type indicating whether it is a request for an AI/ML Model(s) or AI/ML Model configuration(s) update, inference update, re-training, replacing, switching, and/or activating/deactivating.

### AI/ML Model Update/Re-Configuration in Case of UE Mobility

In accordance with an embodiment, AI/ML Model(s) may be deployed in a cell-centric or BS-centric arrangement i.e., a cells or BSs may be configured with a different AI/ML Model(s), a different AI/ML Model family(s) and/or a different AI/ML Model configuration(s).

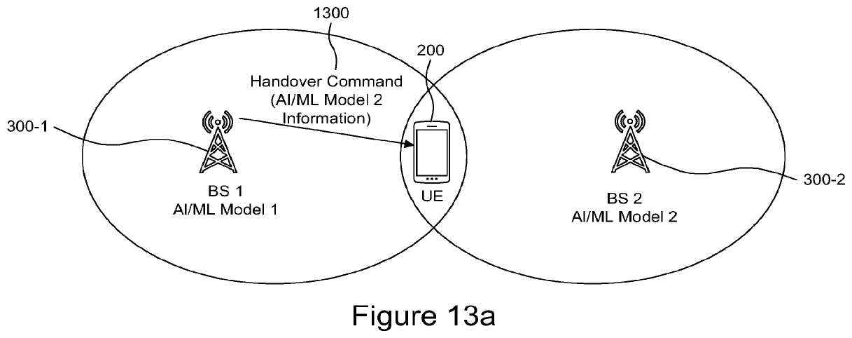

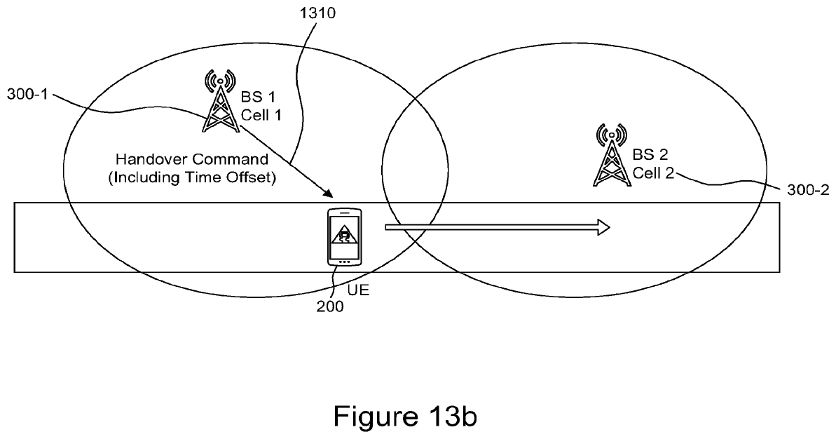

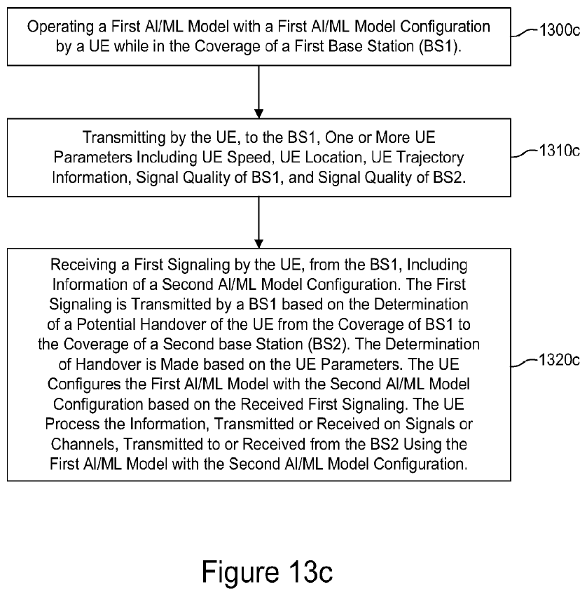

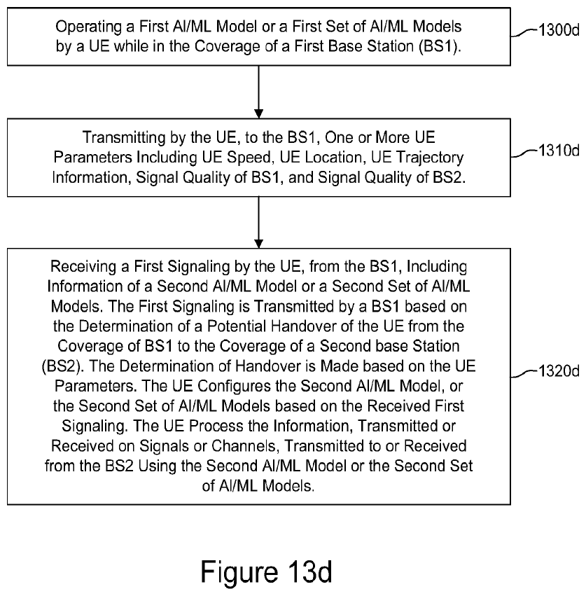

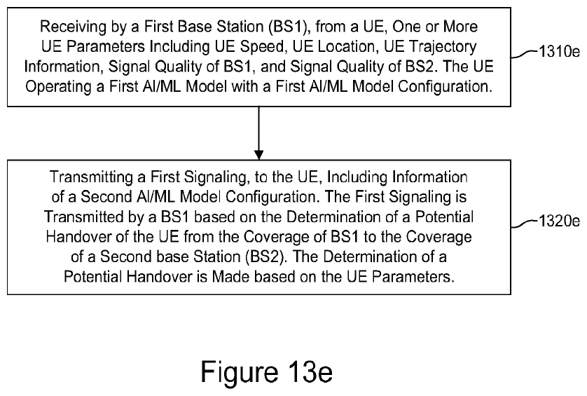

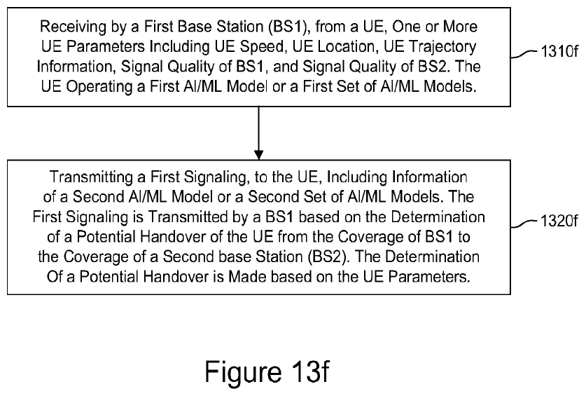

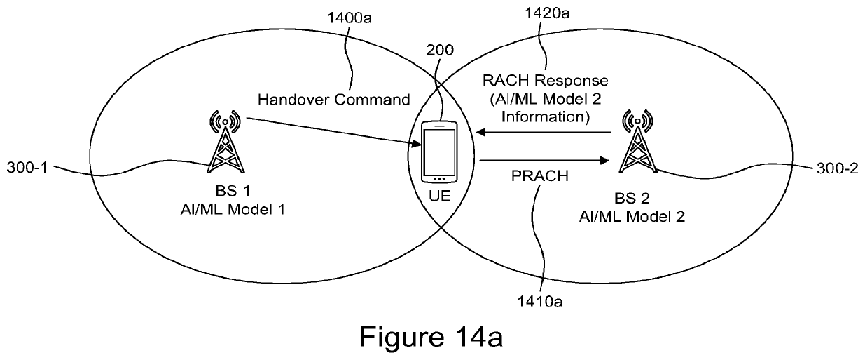

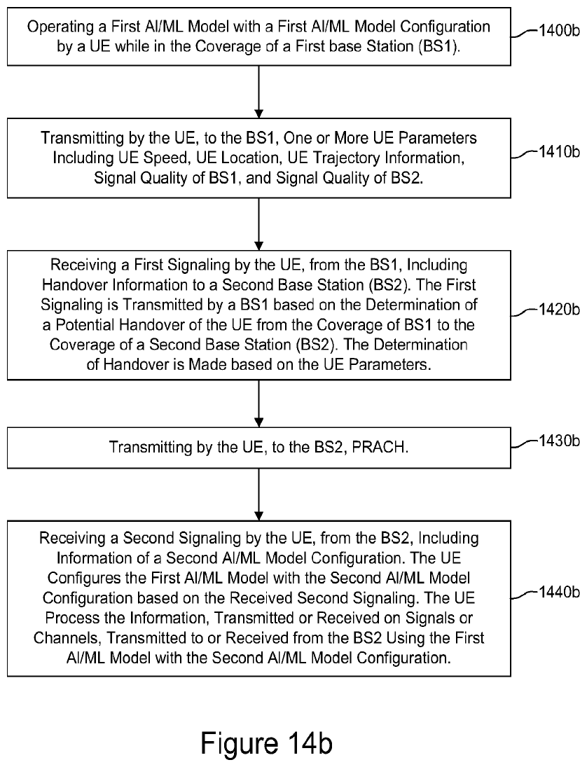

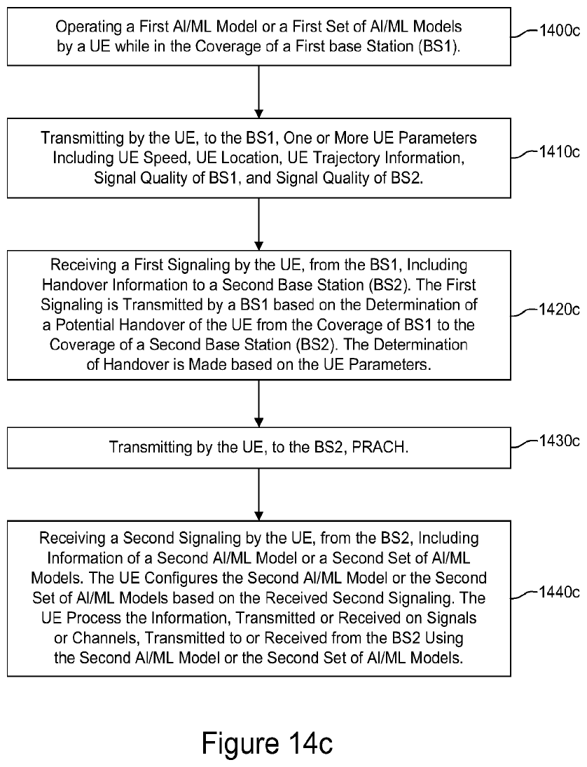

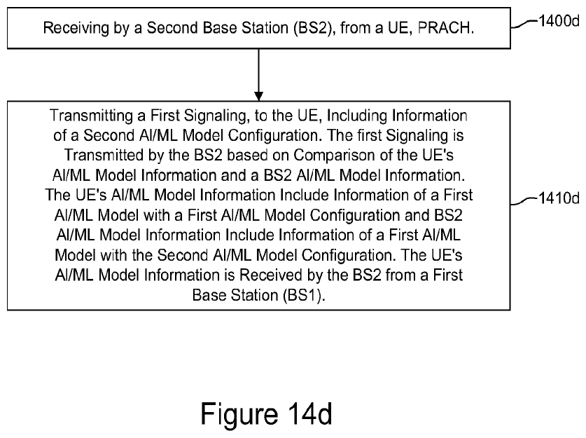

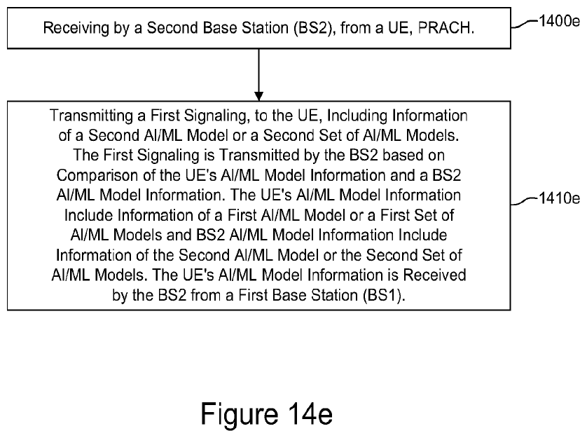

As shown in FIGS. 13a and 14a, a first BS (BS1) (300-1) (for example, BS1 may refer to a BS as described above in conjunction with FIGS. 3 and/or 6) may be configured with a first AI/ML Model (AI/ML Model 1) and a second BS (BS2) (300-2) (for example, BS 2 may refer to a BS as described above in conjunction with FIGS. 3 and/or 6) may be configured with a second AI/ML Model (AI/ML Model 2). AI/ML Models 1 and 2 of FIGS. 13a and 14a may represent any of a single AI/ML Model, configuration of AI/ML Model, a family of AI/ML Models, a set of AI/ML Models, and/or a set of families of AI/ML Models. For example, AI/ML Model 1 may represent a CSI AI/ML Model, a configuration of an AI/ML Model, a family of CSI AI/ML Models, a set of AI/ML Models including two or more AI/ML Models including CSI, Beamforming, Power control, and/or Positioning, a set of families of AI/ML Model families including two or more AI/ML Model families including CSI, Beamforming, Power control, and/or Positioning. Similarly, AI/ML Model 2 may represent a CSI AI/ML Model, a configuration of an AI/ML Model, a family of CSI AI/ML Models, a set of AI/ML Models including two or more AI/ML Models including CSI, Beamforming, Power control, and/or Positioning, a set of families of AI/ML Model families including two or more AI/ML Model families including CSI, Beamforming, Power control, and/or Positioning.

In accordance with an embodiment as shown in FIG. 13a, when a UE (200) (for example, a UE as described above in conjunction with FIGS. 2 and/or 5) hands over from the BS1 (300-1) to BS2 (300-2) (for example, BS1 or BS 2 may refer to a BS as described above in conjunction with FIGS. 3 and/or 6), the UE (200) may be provided with information regarding the AI/ML Model(s) used by BS2 (300-2). AI/ML Model 2 information may be provided in a handover command (1300). AI/ML Model 2 information may include one or more of the AI/ML Model version number, identifier(s) or indicator(s) (or index(s)) of AI/ML Model(s), identifier(s) or indicator(s) of configuration of AI/ML Model(s), identifier(s) or indicator(s) of a family of AI/ML Models, identifier(s) or indicator(s) (or index(s)) of a set of AI/ML Models, and/or identifier(s) or indicator(s) (or index(s) of a set of families of AI/ML Models, details of performance metric being used, AI/ML Model parameters (such as, for example, one or more of coefficients, weights, biases, number of AI/ML tasks, AI/ML task identifier(s) (or index(s)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)). A UE (200) may receive a handover command (1300) including AI/ML Model 2 information and configure its AI/ML Model(s) according to AI/ML Model 2 information.

In accordance with an embodiment as shown in FIG. 13a, AI/ML Model information may be provided via the RRC, MAC or physical layer signaling. The person having skill in the art would understand that AI/ML Model information may be transmitted in messages other than the handover command (1300) in case of transmission over MAC or physical layer.

In accordance with an embodiment, when a UE (for example, a UE as described above in conjunction with FIGS. 2 and/or 5) is about to handover from the coverage of BS1 to BS2 (for example, BS1 or BS 2 may refer to a BS as described above in conjunction with FIGS. 3 and/or 6) or when a handover process is initiated, the BS1 may transmit and the UE may receive a signaling containing the information of AI/ML Model(s) and/or AI/ML Model configuration(s) to be used in the coverage of BS2. The UE's AI/ML engine (for example, AI/ML engine (211) in FIGS. 2 and/or 5) in the coverage of BS1 may operate or use a first AI/ML model having a first AI/ML Model configuration. The signaling may be received by the UE in a handover command (such as handover command (1300) in FIG. 13a) or the signaling may be received by the UE in other RRC, MAC or physical layer messages. The signaling may be provided in advance of the handover process initiation or it may be provided in a handover trigger message. The information of AI/ML Model(s) and/or AI/ML Model configuration(s) to be used in the coverage of BS2 include information of a second AI/ML model and/or a second AI/ML Model configuration. The information of the second AI/ML Model may include one or more of the AI/ML Model version number, identifier or index of the second AI/ML Model, identifier or index of a family of second AI/ML Model, download information of a second AI/ML Model (for example, URL information). The information of the second AI/ML Model configuration may include one or more of the identifier or index of second AI/ML Model configuration, download information of a second AI/ML Model configuration (for example, URL information), second AI/ML Model parameters (such as, for example, one or more of coefficients, weights, biases, number of AI/ML tasks, AI/ML task identifier(s) (or index(s)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)). In case the download information is included in the signaling, the UE may download the indicated second AI/ML model or the second AI/ML Model configuration from the indicated download location or from a predefined download location if download location is not indicated. The predefined download location may include the location of server storing AI/ML models and corresponding AI/ML Model configuration information. Based on the received information of a second AI/ML model and/or a second AI/ML Model configuration, the UE switches the operation of the AI/ML engine from the first AI/ML model having the first AI/ML Model configuration to the second AI/ML model and the second AI/ML Model configuration or the UE switches the operation of the AI/ML engine from the first AI/ML model having the first AI/ML Model configuration to the first AI/ML model and the second AI/ML Model configuration (if only the second AI/ML Model configuration is received in the signaling received by the UE from BS1). After switching to the second AI/ML model and the second AI/ML Model configuration or to the first AI/ML model and the second AI/ML Model configuration, the UE sends an uplink signaling to the BS2 to indicate the updated configuration. The uplink signaling include information of the switched configuration.

In accordance with an embodiment, when a UE (for example, a UE as described above in conjunction with FIGS. 2 and/or 5) is about to handover from the coverage of BS1 to BS2 (for example, BS1 or BS 2 may refer to a BS as described above in conjunction with FIGS. 3 and/or 6) or when a handover process is initiated, the BS1 may transmit and the UE may receive a signaling containing the information of AI/ML Model(s) to be used in the coverage of BS2. The UE's AI/ML engine (for example, AI/ML engine (211) in FIGS. 2 and/or 5) in the coverage of BS1 may operate or use a first AI/ML model or a first set of AI/ML models. The signaling may be received by the UE in a handover command (such as handover command (1300) in FIG. 13a) or the signaling may be received by the UE in other RRC, MAC or physical layer messages. The signaling may be provided in advance of the handover process initiation or it may be provided in a handover trigger message. The information of AI/ML Model(s) to be used in the coverage of BS2 include information of a second AI/ML model or a second set of AI/ML Models. The information of the second AI/ML Model may include one or more of the AI/ML Model version number of second AI/ML Model, identifier or index of the second AI/ML Model, identifier or index of a family of second AI/ML Model, download information of a second AI/ML Model (for example, URL information). The information of the second set of AI/ML Models may include one or more of the AI/ML Model version numbers of second set of AI/ML Models, identifiers or indices of the second set of AI/ML Models, identifiers or indices of the families of second set of AI/ML Models, download information of the second set of AI/ML Models. In case the download information is included in the signaling, the UE may download the indicated second AI/ML model or the second set of AI/ML models from the indicated download location or from a predefined download location if download location is not indicated. The predefined download location may include the location of server storing AI/ML models and corresponding information. The identifiers or indices of a second set of AI/ML Models and identifiers or indices of the families of second set of AI/ML Models may be indicated by a bit pattern where each bit corresponds to an AI/ML Model or an AI/ML model family in a predefined order. The predefined order may be an increasing order of AI/ML model indices or AI/ML model family indices starting from a smallest index. Based on the received information of a second AI/ML model or the second set of AI/ML Models, the UE switches the operation of the AI/ML engine from the first AI/ML model to the second AI/ML model or from the first set of AI/ML Models to the second set of AI/ML Models. After switching to the second AI/ML model or the second set of AI/ML Models, the UE sends an uplink signaling to the BS2 to indicate the updated configuration. The uplink signaling include information of the second AI/ML model or the second set of AI/ML Models.

In accordance with an embodiment as shown in FIG. 13b, a BS (300-1) (for example, a BS as described above in conjunction with FIGS. 3 and/or 6) may transmit a handover command to a UE (200) (for example, a UE as described above in conjunction with FIGS. 2 and/or 5) based on predicted UE location determined based on the UE speed and/or trajectory information (using a Positioning Module (620) at BS (300-1)). A handover command (1310) may include a time offset parameter indicating the time after which UE may handover to another BS (300-2). A handover command may implicitly or explicitly indicate to a UE (200) that the UE may stop/not perform the neighbor cell measurements.

In accordance with an embodiment as shown in FIG. 13c, a UE (for example, a UE as described above in conjunction with FIGS. 2 and/or 5) operates a first AI/ML Model with a first AI/ML Model configuration while in the coverage of a first base station (BS1) (1300c). The UE operates an AI/ML engine (for example, AI/ML Engine (211)) with the first AI/ML Model with the first AI/ML Model configuration. The UE transmits, to the BS1, one or more UE parameters including UE speed, UE location, UE trajectory information, signal quality of BS1, and signal quality of BS2 (1310c). The BS1 or BS2 may refer to a BS as described above in conjunction with FIGS. 3 and/or 6. After sending the UE parameters, the UE receives a first signaling, from the BS1, including information of a second AI/ML Model configuration (1320c). The first signaling is transmitted by a BS1 based on the determination of a potential handover of the UE from the coverage of BS1 to the coverage of a second base station (BS2). The determination of handover is made based on the UE parameters. The BS1 use the AI/ML engine and positioning module to predict the future location of the UE by using the received UE parameters and/or reference signals transmitted by the UE in the uplink. If the future location is identified to be in a coverage of base station (for example, BS2) other than the BS1, BS1 may initiate a handover process or predict initiation of a handover process after a time offset in the BS1 and transmit the first signaling to the UE. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. When the first signaling is received, the UE may still be present in the coverage of BS1 and the first signaling may include a time offset parameter to initiate the handover process in the UE after a predefined time. The UE may adjust the received time offset parameter to initiate the handover process depending on the changes in one or more of the UE speed, trajectory, signal quality of BS1, and signal quality of BS2. The UE may use an AI/ML Model for handover prediction for adjusting the time offset parameter for initiating the handover process. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The UE may configure the first AI/ML Model with the second AI/ML Model configuration indicated in the received first signaling. After the configuration of the first AI/ML Model with the second AI/ML Model configuration by the UE, the UE start processing the information, transmitted, or received on signals or channels, transmitted to or received from the BS2 using the first AI/ML Model with the second AI/ML Model configuration. The first signaling may be received in a handover command message received in the RRC layer.

In accordance with an embodiment as shown in FIG. 13d, a UE (for example, a UE as described above in conjunction with FIGS. 2 and/or 5) operates a first AI/ML Model or a first set of AI/ML Models while in the coverage of a first base station (BS1) (1300d). The UE operates an AI/ML engine (for example, AI/ML Engine (211)) with the first AI/ML Model or the first set of AI/ML Models. The UE transmits, to the BS1, one or more UE parameters including UE speed, UE location, UE trajectory information, signal quality of BS1, and signal quality of BS2 (1310d). The BS1 or BS2 may refer to a BS as described above in conjunction with FIGS. 3 and/or 6. After sending the UE parameters, the UE receives a first signaling, from the BS1, including information of a second AI/ML Model or a second set of AI/ML Models. The first signaling is transmitted by a BS1 based on the determination of a potential handover of the UE from the coverage of BS1 to the coverage of a second base station (BS2). The determination of handover is made based on the UE parameters (1320d). The BS1 use the AI/ML engine and positioning module to predict the future location of the UE by using the received UE parameters and/or reference signals transmitted by the UE in the uplink. If the future location is identified to be in a coverage of base station (for example, BS2) other than the BS1, BS1 may initiate a handover process or predict initiation of a handover process after a time offset in the BS1 and transmit the first signaling to the UE. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. When the first signaling is received, the UE may still be present in the coverage of BS1 and the first signaling may include a time offset parameter to initiate the handover process in the UE after a predefined time. The UE may adjust the received time offset parameter to initiate the handover process depending on the changes in one or more of the UE speed, trajectory, signal quality of BS1, and signal quality of BS2. The UE may use an AI/ML Model for handover prediction for adjusting the time offset parameter for initiating the handover process. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The UE may configure the second AI/ML Model, or the second set of AI/ML Models indicated in the received first signaling. After the configuration of the second AI/ML Model or the second set of AI/ML Models by the UE, the UE start processing the information, transmitted, or received on signals or channels, transmitted to or received from the BS2 using the second AI/ML Model or the second set of AI/ML Models. The first signaling may be received in a handover command message received in the RRC layer.

In accordance with an embodiment as shown in FIG. 13e, a first base station (BS1 (for example, BS1 may refer to a BS as described above in conjunction with FIGS. 3 and/or 6.) receives, from a UE, one or more UE parameters including UE speed, UE location, UE trajectory information, signal quality of BS1, and signal quality of BS2. The UE operating a first AI/ML Model with a first AI/ML Model configuration (1310e). The BS1 use the AI/ML engine and positioning module to predict the future location of the UE by using the received UE parameters and/or reference signals transmitted by the UE in the uplink. If the future location is identified to be in a coverage of base station other than the BS1 (for example, a second base station (BS2)), BS1 may initiate a handover process or predict initiation of a handover process after a time offset in the BS1 and transmit a first signaling to the UE. The BS1 transmits a first signaling, to the UE, including information of a second AI/ML Model configuration. The first signaling is transmitted by the BS1 based on the determination of a potential handover of the UE from the coverage of BS1 to the coverage of a second base station (BS2). The determination of a potential handover is made based on the UE parameters and/or reference signals transmitted by the UE in the uplink (1320e). BS2 may refer to a BS as described above in conjunction with FIGS. 3 and/or 6. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. The first signaling may include a time offset parameter to initiate the handover process in the UE after a predefined time. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The AI/ML Model to be used for handover prediction or the AI/ML Model configuration to be used for handover prediction may be used by the UE to adjust the time offset parameter to initiate the handover process in the UE.

In accordance with an embodiment as shown in FIG. 13f, a first base station (BS1 (for example, BS1 may refer to a BS as described above in conjunction with FIGS. 3 and/or 6.)) receives, from a UE, one or more UE parameters including UE speed, UE location, UE trajectory information, signal quality of BS1, and signal quality of BS2. The UE operating a first AI/ML Model or a first set of AI/ML Models (1310f). The BS1 use the AI/ML engine and positioning module to predict the future location of the UE by using the received UE parameters and/or reference signals transmitted by the UE in the uplink. If the future location is identified to be in a coverage of base station other than the BS1 (for example, a second base station (BS2)), BS1 may initiate a handover process or predict initiation of a handover process after a time offset in the BS1 and transmit a first signaling to the UE. The BS1 transmits a first signaling, to the UE, including information of a second AI/ML Model or a second set of AI/ML Models. The first signaling is transmitted by the BS1 based on the determination of a potential handover of the UE from the coverage of BS1 to the coverage of a second base station (BS2). The determination of a potential handover is made based on the UE parameters and/or reference signals transmitted by the UE in the uplink (1320f). BS2 may refer to a BS as described above in conjunction with FIGS. 3 and/or 6. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. The first signaling may include a time offset parameter to initiate the handover process in the UE after a predefined time. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The AI/ML Model to be used for handover prediction or the AI/ML Model configuration to be used for handover prediction may be used by the UE to adjust the time offset parameter to initiate the handover process in the UE.

In accordance with an embodiment, a UE (for example, a UE as described above in conjunction with FIGS. 2 and/or 5) operates a first AI/ML Model with a first AI/ML Model configuration while in the coverage of a first base station (BS1). The UE operates an AI/ML engine (for example, AI/ML Engine (211)) with the first AI/ML Model with the first AI/ML Model configuration. The UE transmits, to the BS1, one or more UE parameters including UE speed, UE location, UE trajectory information, signal quality of BS1, and signal quality of BS2 (1310c). The BS1 or BS2 may refer to a BS as described above in conjunction with FIGS. 3 and/or 6. After sending the UE parameters, the UE receives a first signaling, from the BS1, including information for switching the AI/ML Engine to the Non-AI/ML Signal Processing Module. The first signaling is transmitted by a BS1 based on the determination of a potential handover of the UE from the coverage of BS1 to the coverage of a second base station (BS2). The determination of handover is made based on the UE parameters. The BS1 use the AI/ML engine and positioning module to predict the future location of the UE by using the received UE parameters and/or reference signals transmitted by the UE in the uplink. If the future location is identified to be in a coverage of base station (for example, BS2) other than the BS1, BS1 may initiate a handover process or predict initiation of a handover process after a time offset in the BS1 and transmit the first signaling to the UE. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. When the first signaling is received, the UE may still be present in the coverage of BS1 and the first signaling may include a time offset parameter to initiate the handover process in the UE after a predefined time. The UE may adjust the received time offset parameter to initiate the handover process depending on the changes in one or more of the UE speed, trajectory, signal quality of BS1, and signal quality of BS2. The UE may use an AI/ML Model for handover prediction for adjusting the time offset parameter for initiating the handover process. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The UE may switch the AI/ML Engine to the Non-AI/ML Signal Processing Module. After switching to the Non-AI/ML Signal Processing Module, the UE start processing the information transmitted or received on signals or channels, transmitted to, or received from the BS2 using Non-AI/ML Signal Processing Module. The first signaling may be received in a handover command message received in the RRC layer. The first signaling may include an implicit signaling for switching to the Non-AI/ML Signal Processing Module. The BS2 may have a different RAT than the BS1 (for example, LTE), or BS2 may not support the AI/ML Models for processing the signals, or BS2 is not having the capability to transmit/receive the required signal configurations for supporting the UE's AI/ML Engine. Therefore, it is important for the UE to switch to the Non-AI/ML Signal Processing Module.

In accordance with an embodiment as shown in FIG. 14a, when a UE (200) (for example, a UE as described above in conjunction with FIGS. 2 and/or 5) handovers from a first BS (BS1) (300-1) to a second BS (BS2) (300-2) (for example, BS1 or BS 2 may refer to a BS as described above in conjunction with FIGS. 3 and/or 6), the UE (200) may be provided with AI/ML Model 2 information of AI/ML Model(s) used by BS2 (300-2). The UE (200) may receive handover command (1400a) for initiating the handover to the BS2 (300-2) from BS1 (300-1). AI/ML Model 2 information may be provided in a RACH response (1420a) transmitted by BS2 (300-2) in response to a PRACH (1410a) transmitted by the UE (200). AI/ML Model 2 information may include one or more of AI/ML Model version number, identifier(s) or indicator(s) (or index(s)) of AI/ML Model(s), identifier(s) or indicator(s) (or index(s) of configuration of AI/ML Model(s), identifier(s) or indicator(s) (or index(s) of a family of AI/ML Models, identifier(s) or indicator(s) (or index(s)) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s) (or index(s)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)). A UE (200) may receive a RACH response (1420a) including AI/ML Model 2 information and configure its AI/ML Model(s) according to the AI/ML Model 2 information.

In accordance with an embodiment as shown in FIG. 14a, a UE (200) (for example, a UE as described above in conjunction with FIGS. 2 and/or 5) may be provided with the update and/or re-configuration information to a single AI/ML Model, a configuration of an AI/ML Model(s), a family of AI/ML Models, a subset of a family of AI/ML Models, a subset of AI/ML Models via RACH response (1420a).

In accordance with an embodiment, when a UE (for example, a UE as described above in conjunction with FIGS. 2 and/or 5) handovers from a first BS (BS1) to a second BS (BS2) (for example, BS1 or BS 2 may refer to a BS as described above in conjunction with FIGS. 3 and/or 6), the UE may receive an information for switching the AI/ML Engine to the Non-AI/ML Signal Processing Module from the BS2. The information for switching the AI/ML Engine to the Non-AI/ML Signal Processing Module depends on the BS2 capability for supporting AI/ML Models. In an embodiment, BS2 may broadcast its capability to support the AI/ML Models in its coverage. For example, the BS2 may transmit in the MIB or one of the SIBs an indicator to indicate its support for the AI/ML Models. The UE may use the received capability information as an implicit signaling for switching from the AI/ML Engine to the Non-AI/ML Signal Processing Module. In another embodiment, BS2 may transmit an explicit signaling to UE for switching to the Non-AI/ML Signal Processing Module. The explicit signaling may be a flag bit in the physical or RRC signaling. In yet another embodiment, the UE may determine based on parameters of BS2 such as type of RAT of BS2 (for example, LTE) or type of BS2 (relay node or reduced capability base station) to switch from the AI/ML Engine to the Non-AI/ML Signal Processing Module.

In accordance with an embodiment as shown in FIG. 14b, a UE (for example, a UE as described above in conjunction with FIGS. 2 and/or 5) operates a first AI/ML Model with a first AI/ML Model configuration while in the coverage of a first base station (BS1) (1400b). The UE operates an AI/ML engine (for example, AI/ML Engine (211) with the first AI/ML Model with the first AI/ML Model configuration. The UE transmits, to the BS1, one or more UE parameters including UE speed, UE location, UE trajectory information, signal quality of BS1, and signal quality of BS2 (1410b). The BS1 or BS2 may refer to a BS as described above in conjunction with FIGS. 3 and/or 6. After sending the UE parameters, the UE receives a first signaling, from the BS1, including handover information to the second base station (BS2) (1420b). The first signaling is transmitted by a BS1 based on the determination of a potential handover of the UE from the coverage of BS1 to the coverage of a second base station (BS2). The determination of handover is made based on the UE parameters. The BS1 use the AI/ML engine and positioning module to predict the future location of the UE by using the received UE parameters and/or reference signals transmitted by the UE in the uplink. If the future location is identified to be in a coverage of base station (for example, BS2) other than the BS1, BS1 may initiate a handover process or predict initiation of a handover process after a time offset in the BS1 and transmit the first signaling to the UE. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. When the first signaling is received, the UE may still be present in the coverage of BS1 and the first signaling may include a time offset parameter to initiate the handover process in the UE after a predefined time. The UE may adjust the received time offset parameter to initiate the handover process depending on the changes in one or more of the UE speed, trajectory, signal quality of BS1, and signal quality of BS2. The UE may use an AI/ML Model for handover prediction for adjusting the time offset parameter for initiating the handover process. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The UE transmits a PRACH signal to the BS2 (1430b). The PRACH signal is transmitted based on the received first signaling. The UE receives a second signaling, from the BS2, including information of a second AI/ML Model configuration (1440b). The UE configures the first AI/ML Model with the second AI/ML Model configuration based on the received second signaling. The UE process the information transmitted or received, on signals or channels, transmitted to or received from the BS2 using the first AI/ML Model with the second AI/ML Model configuration. The first signaling may be received in a handover command message received in the RRC layer. The second signaling may be received in response to the PRACH transmitted by the UE.

In accordance with an embodiment as shown in FIG. 14c, a UE (for example, a UE as described above in conjunction with FIGS. 2 and/or 5) operates a first AI/ML Model with a first AI/ML Model configuration while in the coverage of a first base station (BS1) (1400c). The UE operates an AI/ML engine (for example, AI/ML Engine (211)) with the first AI/ML Model with the first AI/ML Model configuration. The UE transmits, to the BS1, one or more UE parameters including UE speed, UE location, UE trajectory information, signal quality of BS1, and signal quality of BS2 (1410c). The BS1 or BS2 may refer to a BS as described above in conjunction with FIGS. 3 and/or 6. After sending the UE parameters, the UE receives a first signaling, from the BS1, including handover information to the second base station (BS2) (1420c). The first signaling is transmitted by a BS1 based on the determination of a potential handover of the UE from the coverage of BS1 to the coverage of a second base station (BS2). The determination of handover is made based on the UE parameters. The BS1 use the AI/ML engine and positioning module to predict the future location of the UE by using the received UE parameters and/or reference signals transmitted by the UE in the uplink. If the future location is identified to be in a coverage of base station (for example, BS2) other than the BS1, BS1 may initiate a handover process or predict initiation of a handover process after a time offset in the BS1 and transmit the first signaling to the UE. The first signaling may be transmitted after the initiation of a handover process in the BS1 or the first signaling may be transmitted before a predefined time offset from the initiation of a handover process in the BS1. The first signaling may be transmitted by the BS1 to initiate the handover process in the UE. When the first signaling is received, the UE may still be present in the coverage of BS1 and the first signaling may include a time offset parameter to initiate the handover process in the UE after a predefined time. The UE may adjust the received time offset parameter to initiate the handover process depending on the changes in one or more of the UE speed, trajectory, signal quality of BS1, and signal quality of BS2. The UE may use an AI/ML Model for handover prediction for adjusting the time offset parameter for initiating the handover process. The first signaling may also include information of the AI/ML Model to be used for handover prediction or include information of the AI/ML Model configuration to be used for handover prediction. The information of the AI/ML Model to be used for handover prediction include identifier or index of the AI/ML Model. The information of the AI/ML Model configuration to be used for handover prediction include identifier or index of the AI/ML Model configuration. The UE transmits a PRACH signal to the BS2 (1430c). The PRACH signal is transmitted based on the received first signaling. The UE receives a second signaling, from the BS2, including information of a second AI/ML Model or a second set of AI/ML Models (1440c). The UE configures the AI/ML Engine with the second AI/ML Model or the second set of AI/ML Models based on the received second signaling. The UE process the information transmitted or received, on signals or channels, transmitted to or received from the BS2 using the second AI/ML Model or the second set of AI/ML Models. The first signaling may be received in a handover command message received in the RRC layer. The second signaling may be received in response to the PRACH transmitted by the UE.

In accordance with an embodiment as shown in FIG. 14d, a second base station (BS2 (for example, BS1 may refer to a BS as described above in conjunction with FIGS. 3 and/or 6.) receives, from a UE, a PRACH (1400d). The BS2 transmits a first signaling, to the UE, including information of a second AI/ML Model configuration (1410d). The first signaling is transmitted by the BS2 based on comparison of the UE's AI/ML Model information and a BS2 AI/ML Model information. The UE's AI/ML Model information include information of a first AI/ML Model with a first AI/ML Model configuration and BS2 AI/ML Model information include information of a first AI/ML Model with the second AI/ML Model configuration. The UE's AI/ML Model information is received by the BS2 from a first base station (BS1). The channel characteristics and the beam direction changes for the UE when the UE hands over from the coverage of BS1 to a BS2 and it would be necessary to update the AI/ML Model configuration.

In accordance with an embodiment as shown in FIG. 14e, a second base station (BS2 (for example, BS1 may refer to a BS as described above in conjunction with FIGS. 3 and/or 6.) receives, from a UE, a PRACH (1400e). The BS2 transmits a first signaling, to the UE, including information of a second AI/ML Model or a second set of AI/ML Models (1410d). The first signaling is transmitted by the BS2 based on comparison of the UE's AI/ML Model information and a BS2 AI/ML Model information. The UE's AI/ML Model information include information of a first AI/ML Model or a first set of AI/ML Models and BS2 AI/ML Model information include information of the second AI/ML Model or the second set of AI/ML Models. The UE's AI/ML Model information is received by the BS2 from a first base station (BS1). The channel characteristics and the beam direction changes for the UE when the UE hands over from the coverage of BS1 to a BS2 and it would be necessary to update the AI/ML Model configuration.

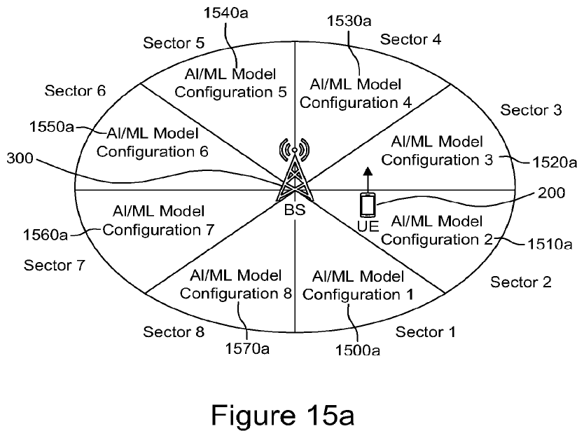

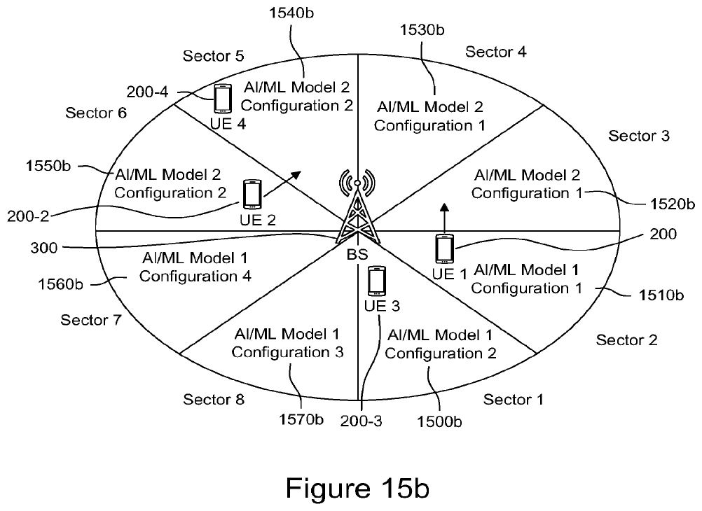

In accordance with an embodiment as shown in FIG. 15a, a BS (300) (for example, a BS as described above in conjunction with FIGS. 3 and/or 6) may be configured to support two or more sectors whereby each sector corresponds to a different AI/ML Model configuration (within the same AI/ML Model family). For example, a BS cell coverage may be divided into 8 sectors (Sector 1-8) and each sector may be assigned a different AI/ML Model configuration (1500a, 1510a, 1520a, 1530a, 1540a, 1550a, 1560a, 1570a) as shown in the figure. The AI/ML Model configuration may be selected based on the characteristics of a sector such as the presence of a building, mountain, forest, number of UEs, average UE speeds, time of day/week, past interference data, and/or NLOS conditions. In accordance with an embodiment, UEs with a similar UE capability in a sector may be configured with the same AI/ML Model configuration (within the same AI/ML Model family). In accordance with another embodiment, UEs in a sector may be configured with an AI/ML Model configuration (within the same AI/ML Model family) depending UE specific parameters such as UE speed, UE frequency band, time of day, current interference faced on UE, and/or NLOS condition. In accordance with yet another embodiment, depending on UE mobility, different AI/ML Model configuration may be selected by a BS (300) and/or UE (200). When a UE (200) moves from one sector to another, a BS (300) may indicate a new AI/ML Model configuration in a physical layer, MAC layer, or RRC layer signaling. A UE (200) may use received signaling for selecting another AI/ML Model configuration. Signaling may include one or more of AI/ML Model identifier or indicator (or index), AI/ML Model configuration identifier or indicator (or index), sector identifier or indicator (or index), and/or AI/ML configuration parameters. The details of configuration parameters may be identified from other sections of this application.

In accordance with an embodiment as shown in FIG. 15a, when a UE (200) (for example, a UE as described above in conjunction with FIGS. 2 and/or 5) moves from one sector to another (e.g., a UE moves from sector 2 to 3 as shown in the figure) the UE (200) may select a new AI/ML Model configuration (e.g., AI/ML Model Configuration 3 (1530). A UE (200) may select another AI/ML Model configuration (1530) based on AI/ML Model performance or based on a predefined relationship between sectors and AI/ML Model configuration. In the case of a UE (200) selecting a new AI/ML Model configuration (1530) based on a predefined relationship between sectors and AI/ML Model configuration, a UE (200) may monitor changes in a sector and accordingly changes an AI/ML Model configuration. A BS (300) may indicate the sector identifier or indicator (or index) to assist a UE (300) in selecting an AI/ML Model configuration.

In accordance with an embodiment as shown in FIG. 15b, a BS (300) (for example, a BS as described above in conjunction with FIGS. 3 and/or 6) may be configured to support two or more sectors whereby each sector corresponds to a different and/or same AI/ML Model and/or AI/ML Model configuration. For example, a BS cell coverage may be divided into 8 sectors and each sector may be assigned a different and/or same AI/ML Model or AI/ML Model configuration (1500b, 1510b, 1520b, 1530b, 1540b, 1550b, 1560b, 1570b) as shown in the figure. Some sectors may have the same AI/ML Model and AI/ML Model configuration (e.g., sectors 5 and 6) (1540b, 1550b), some other sectors may have the same AI/ML Model and different AI/ML Model configurations (e.g., sectors 1 and 2) (1500b, 1510b), and some other sectors may have different AI/ML Models (e.g., sectors 2 and 3) (1510b, 1520b). The AI/ML Model or AI/ML Model configuration may be selected based on the characteristics of a sector such as the presence of a building, mountain, forest, number of UEs, average UE speeds, time of day/week, past interference data, and/or NLOS conditions. In accordance with an embodiment, UEs with a similar UE capability in a sector may be configured with the same AI/ML Model or AI/ML Model configuration. In accordance with another embodiment, UEs in a sector may be configured with an AI/ML Model or AI/ML Model configuration depending UE specific parameters such as UE speed, UE frequency band, time of day, current interference faced on UE, and/or NLOS condition. In accordance with yet another embodiment, when a UE1 (200-1) (for example, a UE as described above in conjunction with FIGS. 2 and/or 5) moves from one sector to another (e.g., sector 2 to 3) the UE1 (200-1) may select a new AI/ML Model (1520b). A UE1 (200-1) may select a new AI/ML Model (1520b) based on the performance of a currently used AI/ML Model (1510b) or based on a predefined relationship between sectors and AI/ML Models. In the case of UE1 (200-1) selecting a new AI/ML Model (1520b) based on a predefined relationship between sectors and AI/ML Model, a UE1 (200-1) may monitor a change in sector and accordingly changes AI/ML Model. A BS (300) may indicate the sector identifier or indicator (or index) to assist a UE1 (200-1) in selecting AI/ML Model. When a UE2 (200-2) (for example, a UE as described above in conjunction with FIGS. 2 and/or 5) moves from one sector to another the UE2 (200-2) keeps the same AI/ML Model configuration and/or AI/ML Model (1540b). UE2 (200-2) may keep AI/ML Model configuration and/or AI/ML Model based on the performance of the currently used AI/ML Model configuration and/or AI/ML Model (1550b) or based on a predefined relationship between sectors and AI/ML Model configuration and/or AI/ML Model. In the case of UE2 (200-2) keeping an AI/ML Model configuration and/or AI/ML Model based on a predefined relationship between sectors and AI/ML Model configuration and/or AI/ML Model, UE2 (200-2) may monitor a change in sector and accordingly keeps/change an AI/ML Model configuration and/or the AI/ML Model. A BS (300) may indicate the sector identifier or indicator (or index) to assist the UE2 (200-2) in selecting AI/ML Model configuration and/or AI/ML Model. A BS (300) may have in its coverage some UEs with the same AI/ML Model and AI/ML Model configuration (e.g., UE2 (200-2) and UE4 (200-4)), some other UEs with the same AI/ML Model and different AI/ML Model configuration (e.g., UE1 (200-1) and UE3 (200-3)), and some other UEs with different AI/ML Models (e.g., UE1 (200-1) and UE2 (200-2).

In accordance with an embodiment as shown in FIG. 15a or 15b, when a UE (200) (for example, a UE as described above in conjunction with FIGS. 2 and/or 5) moves from one sector to another the UE (200) may select another AI/ML Model configuration and/or another AI/ML Model. The UE (200) may select another AI/ML Model configuration and/or another AI/ML Model based on signaling from a BS (300) (for example, a BS as described above in conjunction with FIGS. 3 and/or 6). A BS (300) may indicate another AI/ML Model configuration and/or another AI/ML Model to assist UE (200) in selecting AI/ML Model configuration and/or AI/ML Model. A BS (300) may indicate another AI/ML Model configuration and/or another AI/ML Model by using an indicator or identifier (or index) of another AI/ML Model configuration and/or another AI/ML Model. A BS (300) may select another new AI/ML Model configuration and/or another AI/ML Model depending on a UE's movement from one sector to another sector in a BS's coverage. A BS (300) may detect UE's movement from one sector to the other sector using an AI/ML Model for predicting UE location (using Positioning Module on BS) based on UE's speed and/or trajectory information.

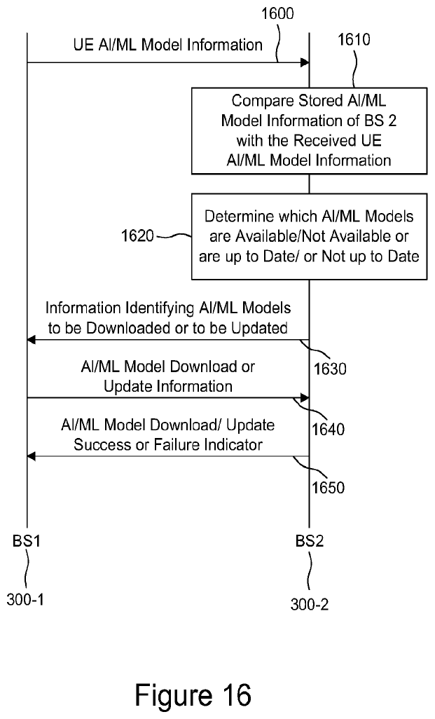

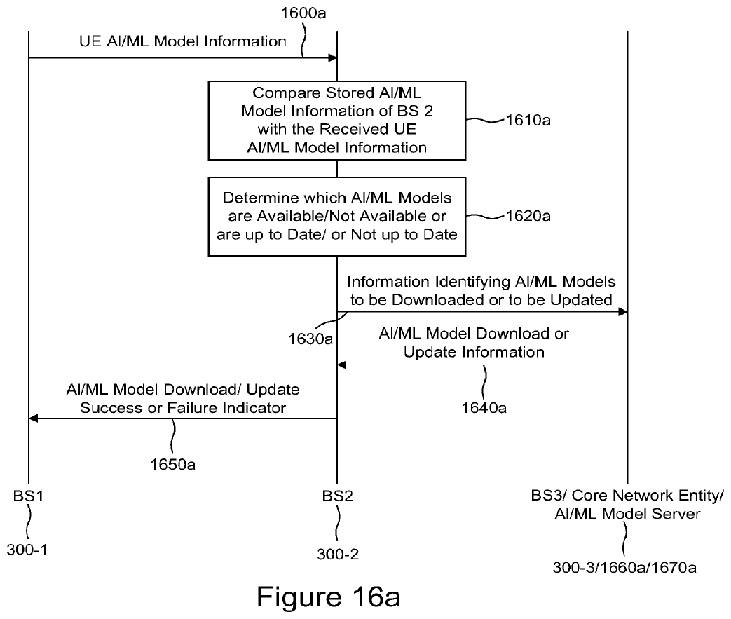

In accordance with an embodiment as shown in FIG. 16, when a UE (for example, a UE as described above in conjunction with FIGS. 2 and/or 5) handover from a first BS (BS1 (300-1)) to a second BS (BS2 (300-2) (for example, BS1 or BS 2 may refer to a BS as described above in conjunction with FIGS. 3 and/or 6), BS1 (300-1) may share the UE's AI/ML Model information (1600) with BS2 (300-2) so that the UE does not synchronize the AI/ML Model(s) on handover. UE AI/ML Model information (1600) may include one or more of AI/ML Model identifier or indicator (or index), AI/ML Model configuration identifier or indicator (or index), AI/ML Family identifier or indicator (or index), AI/ML Model configurations, UE Capabilities, activation/deactivation status of AI/ML Model(s) and/or AI/ML Model configuration(s), and/or current version information of the AI/ML Model(s). Based on the received AI/ML Model information (1600) BS2 (300-2) may compare it with its stored AI/ML Model information (1610) and determine if it has the AI/ML Model(s) available (1620) so that it can serve the UE without any undue delay. If BS2 (300-2) determines that UE supported AI/ML Model(s), AI/ML Model configuration(s) and/or AI/ML Model family(s) are available and versions are up to date (1620), BS2 (300-2) may send a confirmation message to BS1 (300-1) indicating the AI/ML Model(s), AI/ML Model configuration(s), and AI/ML Model family(s) that are available, and that the versions are up to date. If BS2 (300-2) determines that UE supported AI/ML Model(s), AI/ML Model configuration(s), and/or AI/ML Model family(s) are not available and/or versions are not up to date (1620), BS2 (300-2) may send a message containing information (1630) identifying AI/ML Model(s), AI/ML Model configuration(s) and/or AI/ML Model family(s) to be downloaded and/or to be updated by BS2 (300-2) from BS1 (300-1). Based on the received information identifying AI/ML Model(s) to be downloaded and/or to be updated by BS2 (300-2), BS1 (300-1) may send a message containing the details of AI/ML Model(s), AI/ML Model configuration(s) and/or AI/ML Model family(s) download and/or update information (1640). Details may include a URL to download and/or update AI/ML Model(s), AI/ML Model configuration(s) and/or AI/ML Model family(s). Based on the received details of AI/ML Model(s), AI/ML Model configuration(s) and/or AI/ML Model family(s) download and/or update information, BS2 (300-2) download/update the AI/ML Model(s), AI/ML Model configuration(s) and/or AI/ML Model family(s). If BS2 (300-2) successfully downloads or updates AI/ML Model(s), AI/ML Model configuration(s) and/or AI/ML Model family(s), BS2 (300-2) may send a confirmation message (1650) to BS1 (300-1) indicating the AI/ML Model(s) AI/ML Model configuration(s) and/or AI/ML Model family(s) are available, and/or versions are up to date. In case, BS2 (300-2) is not able to successfully download or update AI/ML Model(s), AI/ML Model configuration(s) and/or AI/ML Model family(s), BS2 (300-2) may send a failure message (1650) to BS1 (300-1) indicating the AI/ML Model(s), AI/ML Model configuration(s) and/or AI/ML Model family(s) that were not successfully downloaded and/or updated. In case BS2 (300-2) is not able to successfully download and/or update a subset of the AI/ML Model(s), AI/ML Model configuration(s) and/or AI/ML Model family(s), BS2 (300-2) may send a failure message (1650) to BS1 (300-1) indicating the subset of the AI/ML Models, AI/ML Model configuration(s) and/or AI/ML Model family(s) that were not successfully downloaded and/or updated.

In accordance with an alternative embodiment as shown in FIG. 16a, when a UE (for example, a UE as described above in conjunction with FIGS. 2 and/or 5) handover from a first BS (BS1 (300-1)) to a second BS (BS2 (300-2)) (for example, BS1 or BS2 may refer to a BS as described above in conjunction with FIGS. 3 and/or 6), the BS1 (300-1) may share the UE's AI/ML Model information (1600a) with BS2 (300-2) so that UE does not have to synchronize AI/ML Model(s) upon handover. UE AI/ML Model information (1600a) may include one or more of AI/ML Model identifier or indicator (or index), AI/ML Model configuration identifier or indicator (or index), AI/ML Family identifier or indicator (or index), AI/ML Model configurations, UE Capabilities, activation/deactivation status of AI/ML Model(s) and/or AI/ML Model configuration(s), and/or current version information of the AI/ML Model(s). Based on the received AI/ML Model information (1600a) BS2 (300-2) may compare with its stored AI/ML Model information (1610a) and determines if it has the AI/ML Model(s) and AI/ML Model configuration(s) available (1620a) with it so that it can serve the UE without any delay. If BS2 (300-2) determines that the UE supported AI/ML Model(s), AI/ML Model configuration(s) and/or AI/ML Model family(s) are available and/or versions are up to date, BS2 (300-2) may send a confirmation message to BS1 (300-1) indicating the AI/ML Model(s), AI/ML Model configuration(s) and/or AI/ML Model family(s) are available, and versions are up to date. If BS2 (300-2) determines that the UE supported AI/ML Model(s), AI/ML Model configuration(s) and/or AI/ML Model family(s) are not available and/or versions are not up to date (1620a), BS2 (300-2) may download/update the identified AI/ML Model(s), AI/ML Model configuration(s) and/or AI/ML Model Family(s) from a predefined location (for example, BS3 (300-3), Core Network Entity (1660a) or an AI/ML Model Server (1670a), the AI/ML Model server may refer to a central server for storing AI/ML Model(s) used in a network) without interacting with BS1 (300-1) for download/update. BS2 (300-2) may send Information identifying AI/ML models to be downloaded or to be updated (1630a) to a predefined location where AI/ML models or AI/ML Model configurations is stored such as BS3 (300-3), Core Network Entity (1660a) or an AI/ML Model Server (1670a). In response to Information identifying AI/ML models to be downloaded or to be updated (1630a), BS3 (300-3), Core Network Entity (1660a) or an AI/ML Model Server (1670a) sends AI/ML Model Download or update information (1640a) to BS2 (300-2). If BS2 (300-2) successfully downloads or update the AI/ML Model(s), AI/ML Model configuration(s) and/or AI/ML Model Family(s), BS2 (300-2) may send a confirmation message (1650a) to BS1 (300-1) indicating the AI/ML Model(s) AI/ML Model configuration(s) and/or AI/ML Model Family(s) are available, and/or versions are up to date. In case, BS2 (300-2) is not able to successfully download or update AI/ML Model(s), AI/ML Model configuration(s) and/or AI/ML Model Family(s), BS2 (300-2) may send a failure message (1650a) to BS1 (300-1) indicating the AI/ML Model(s), AI/ML Model configuration(s) and/or AI/ML Model Family(s) that were not successfully downloaded or updated. In an embodiment, BS2 (300-2) may generate a URL based on the received AI/ML Model information (1600a) from BS1 (300-1) for downloading/updating AI/ML Model(s), AI/ML Model configuration(s) and/or AI/ML Model Family(s). If BS2 (300-2) successfully downloads or update the AI/ML Model(s), AI/ML Model configuration(s) and/or AI/ML Model Family(s), BS2 (300-2) may send a confirmation message (1650a) to BS1 (300-1) indicating the AI/ML Model(s) AI/ML Model configuration(s) and/or AI/ML Model Family(s) are available, and/or versions are up to date. In case, BS2 (300-2) is not able to successfully download or update AI/ML Model(s), AI/ML Model configuration(s) and/or AI/ML Model Family(s), BS2 (300-2) may send a failure message (1650a) to BS1 (300-1) indicating the AI/ML Model(s), AI/ML Model configuration(s) and/or AI/ML Model Family(s) that were not successfully downloaded or updated. In case, BS2 (300-2) is not able to successfully download and/or update a subset of AI/ML Model(s), AI/ML Model configuration(s) and/or AI/ML Model Family(s), BS2 (300-2) may send a failure message (1650a) to BS1 indicating the subset of the AI/ML Models, AI/ML Model configuration(s) and/or AI/ML Model Family(s) that were not successfully downloaded and/or updated. Thereafter, based on the received information identifying AI/ML Model(s), AI/ML Model configuration(s) and/or AI/ML Model Family(s) which were not successfully downloaded and/or updated by BS2 (300-2), BS1 (300-1) may send a message containing the details of AI/ML Model(s), AI/ML Model configuration(s) and/or AI/ML Model Family(s) download and/or update information. Details may include a URL to download and/or update AI/ML Model(s), AI/ML Model configuration(s) and/or AI/ML Model Family(s). Based on received details of AI/ML Model(s), AI/ML Model configuration(s) and/or AI/ML Model Family(s) download and/or update information, BS2 (300-2) may download/update the AI/ML Model(s), AI/ML Model configuration(s) and/or AI/ML Model Family(s).

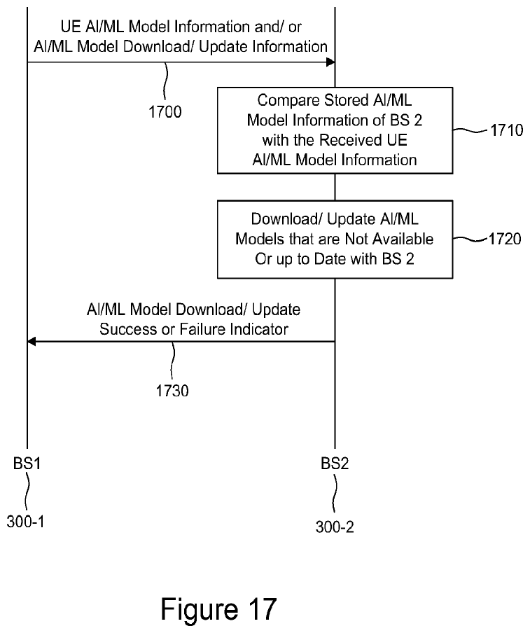

In accordance with an embodiment as shown in FIG. 17, when a UE (for example, a UE as described above in conjunction with FIGS. 2 and/or 5) handovers from a first BS (BS1 (300-1)) to a second BS (BS2 (300-2)) (for example, BS1 or BS2 may refer to a BS as described above in conjunction with FIGS. 3 and/or 6), BS1 (300-1) may send the UE's AI/ML Model information as well as details of AI/ML Model(s), AI/ML Model configuration(s) and/or AI/ML Model Family(s) download and/or update information (1700) to BS2 (300-2) so that UE does not have to synchronize the AI/ML Model(s), AI/ML Model configuration(s) and/or AI/ML Model Family(s) upon handover. UE AI/ML Model information may include one or more of AI/ML Model identifier or indicator (or index), AI/ML Model configuration identifier or indicator (or index), AI/ML Family identifier or indicator (or index), AI/ML Model configurations, UE Capabilities, activation/deactivation status of AI/ML Model(s) and/or AI/ML Model configuration(s), and/or current version information of the AI/ML Model(s). The details of AI/ML Model(s), AI/ML Model configuration(s) and/or AI/ML Model Family(s) download, and/or update information may include the URL to download and/or update the AI/ML Model(s), AI/ML Model configuration(s) and/or AI/ML Model Family(s). Based on received AI/ML Model information (1700), BS2 (300-2) may compare with stored AI/ML Model information (1710) and determine if it has AI/ML Model(s), AI/ML Model configuration(s) and/or AI/ML Model Family(s) available with it so that it can serve the UE without any delay. If BS2 (300-2) determines that UE supported AI/ML Model(s), AI/ML Model configuration(s) and/or AI/ML Model Family(s) are available and/or versions are up to date (1720), BS2 (300-2) may send a confirmation message (1730) to BS1 (300-1) indicating the AI/ML Model(s), AI/ML Model configuration(s) and/or AI/ML Model Family(s) are available, and/or versions are up to date. If BS2 (300-2) determines that UE supported AI/ML Model(s), AI/ML Model configuration(s) and/or AI/ML Model Family(s) are not available and/or versions are not up to date, BS2 (300-2) may download/update AI/ML Models, AI/ML Model configuration(s) and/or AI/ML Model Family(s) that are not available and/or up to date with BS2 (300-2). After BS2 (300-2) successfully downloads and/or updates AI/ML Model(s), AI/ML Model configuration(s) and/or AI/ML Model Family(s), BS2 (300-2) may send a confirmation message (1730) to BS1 (300-1) indicating the AI/ML Model(s), AI/ML Model configuration(s) and/or AI/ML Model Family(s) are available, and/or versions are up to date. In case, BS2 (300-2) is not able to successfully download or update AI/ML Model(s), AI/ML Model configuration(s) and/or AI/ML Model Family(s), BS2 (300-2) may send a failure message (1730) to BS1 (300-1) indicating the AI/ML Model(s), AI/ML Model configuration(s) and/or AI/ML Model Family(s) that were not successfully downloaded and/or updated. In case, BS2 (300-2) is not able to successfully download and/or update a subset of the AI/ML Model(s), and AI/ML Model family(s), BS2 (300-2) may send a failure message (1730) to BS1 (300-1) indicating the subset of the AI/ML Models, and/or AI/ML Model family(s) that were not successfully downloaded and/or updated.

### AI/ML Model Performance Monitoring Based Switching

In accordance with an embodiment, a UE (for example, a UE as described above in conjunction with FIGS. 2 and/or 5) may be configured with multiple AI/ML Models for the same functionality to cater to various types of UE operation situations such as, for example, high or low mobility (speed) operation, low or high-power operation, good or bad coverage operation, high or low interference operation. A UE may be provided with signaling by a BS (for example, a BS as described above in conjunction with FIGS. 3 and/or 6) for switching an AI/ML Model or an AI/ML Model configuration within a family of AI/ML Models. A BS may provide signaling via the RRC layer, MAC layer or physical layer. Another criterion for switching may be performance of an AI/ML Model and/or an AI/ML Model configuration. If performance of an AI/ML Model and/or an AI/ML Model configuration is below a predetermined threshold, a BS may signal to switch to another AI/ML Model and/or AI/ML Model configuration in the same family. An AI/ML Model and/or AI/ML Model configuration in a family may be assigned an identifier that is known to both UE and BS. Signaling for switching the AI/ML Model and/or AI/ML Model configuration may include the identifier for an AI/ML Model and/or AI/ML Model configuration to be switched.

In accordance with an embodiment, a UE (for example, a UE as described above in conjunction with FIGS. 2 and/or 5) may itself switch AI/ML Model(s) and/or AI/ML Model configuration without assistance from a BS (for example, a BS as described above in conjunction with FIGS. 3 and/or 6) based on the determination of various types of UE operation situations such as, for example, high or low mobility (speed) operation, low or high-power operation, good or bad coverage operation, high or low interference operation, line of sight (LOS)/non-line of sight (NLOS). A UE may determine high or low mobility (speed) operation based on comparison of UE speed with a threshold speed. A UE may determine low or high-power operation based on comparison of UE transmit power with a threshold transmit power or based on signaling received from BS indicating transmit power of the UE. A UE may determine good or bad coverage operation based on comparison of UE RSRP/RSRQ/SINR with a threshold RSRP/RSRQ/SINR. A UE may determine high or low interference operation based on comparison of UE ACK/NACK ratio or Packet error rate with a threshold ACK/NACK ratio or Packet error rate. A UE may determine line of sight (LOS)/non-line of sight (NLOS) based on comparison of a power deviation of the strongest signal path and this first-arrival signal path with a threshold value. In case of joint AI/ML operation between UE and BS, after switching the AI/ML Model and/or AI/ML Model configuration, a UE may provide an identifier of the selected AI/ML Model and/or AI/ML Model configuration to BS via uplink signaling. Associated uplink signaling may be provided via the RRC layer or physical layer.

In accordance with an embodiment, a BS (for example, a BS as described above in conjunction with FIGS. 3 and/or 6) may predict situations such as high/low UE mobility based on UE (for example, a UE as described above in conjunction with FIGS. 2 and/or 5) speed and/or trajectory information. BS may predict high/low UE mobility based on a traffic situation in the BS's cell coverage at a predicted future location determined based on a UE's speed and/or trajectory information (using a Positioning Module at BS). BS may determine a traffic situation using a live traffic map such as Google Maps and the average speed of other UEs at the predicted location. Based on the prediction, BS may transmit AI/ML Model and/or AI/ML Model configuration switch signaling to UE. A UE may receive the AI/ML Model and/or AI/ML Model configuration switch signaling and switch to an indicated AI/ML Model and/or AI/ML Model configuration. AI/ML Model and/or AI/ML Model configuration switch signaling may include an AI/ML Model and/or AI/ML Model configuration identifier or a bit indicating AI/ML Model or AI/ML Model configuration.

In accordance with an embodiment, a BS (for example, a BS as described above in conjunction with FIGS. 3 and/or 6) may predict situations such as line of sight (LOS)/non-line of sight (NLOS) based on UE (for example, a UE as described above in conjunction with FIGS. 2 and/or 5) speed and/or trajectory information. A BS may predict non-line of sight (NLOS) situation based on the geographical map and/or structures such as, for example, buildings, forest, or mountain. In a BS's cell coverage at a predicted future location determined based on the UE's speed and/or trajectory information (using a Positioning Module at BS), a BS may transmit AI/ML Model and/or AI/ML Model configuration switch signaling to UE. A UE may receive the AI/ML Model and/or AI/ML Model configuration switch signaling and accordingly may switch to the indicated AI/ML Model and/or AI/ML Model configuration. AI/ML Model switch signaling may include AI/ML Model and/or AI/ML Model configuration identifier or a bit indicating AI/ML Model and/or AI/ML Model configuration.

In accordance with an embodiment, a BS (for example, a BS as described above in conjunction with FIGS. 3 and/or 6) may predict situations such as high/low interference based on UE (for example, a UE as described above in conjunction with FIGS. 2 and/or 5) speed, and/or trajectory information. BS may estimate an interference situation based on number of other UEs at a predicted future location determined based on the UE's speed and/or trajectory information (using a Positioning Module at BS). Based on the high/low interference prediction, a BS may transmit AI/ML Model and/or AI/ML Model configuration switch signaling to a UE. A UE may receive the AI/ML Model and/or AI/ML Model configuration switch signaling and accordingly may switch to an indicated AI/ML Model and/or AI/ML Model configuration. The AI/ML Model switch signaling may include AI/ML Model and/or AI/ML Model configuration identifier or a bit indicating AI/ML Model and/or AI/ML Model configuration.

In accordance with an embodiment, a BS (for example, a BS as described above in conjunction with FIGS. 3 and/or 6) may predict situations such as good/bad coverage based on UE (for example, a UE as described above in conjunction with FIGS. 2 and/or 5) speed and/or trajectory information. A BS may predict good/bad coverage based on the historical signal strength received at other UEs in the BS's cell coverage at the predicted future location determined based on a UE's speed and/or trajectory information (using a Positioning Module at BS), BS may transmit AI/ML Model or AI/ML Model configuration switch signaling to UE. A UE may receive the AI/ML Model and/or AI/ML Model configuration switch signaling and accordingly may switch to the indicated AI/ML Model and/or AI/ML Model configuration. AI/ML Model switch signaling may include AI/ML Model and/or AI/ML Model configuration identifier or a bit(s) indicating AI/ML Model and/or AI/ML Model configuration.

UE trajectory information may include a direction vector, an indicator of linear or angular motion, a direction of motion such as North, East, South, and West (or derivative such as, for example, North-East, South-West, North-West, South-East), a direction of motion in angle from a reference direction such as North, or a trajectory information known from a Map (e.g., Google Maps or Apple Maps). UE trajectory information may be associated with a UE's current location represented either in longitude/latitude or in a reference location with respect to BS location.

### AI/ML Model Activation/Deactivation

In accordance with an embodiment, a UE (for example, a UE as described above in conjunction with FIGS. 2 and/or 5) may be configured with multiple AI/ML Models for the same functionality to cater to various types of UE operation situations such as, for example, high or low mobility (speed) operation, low or high-power operation, good or bad coverage operation, and/or high or low interference operation. A UE may be provided with signaling by a BS (for example, a BS as described above in conjunction with FIGS. 3 and/or 6) for activation/deactivation of an AI/ML Model and/or AI/ML Model configuration. A BS may provide signaling via the RRC, MAC or physical layer. Another criterion for activation/deactivation may be the performance of an AI/ML Model and/or AI/ML Model configuration. If the performance of an AI/ML Model and/or AI/ML Model configuration is above/below a predetermined threshold, a BS may signal activation/deactivation of the AI/ML Model. An AI/ML Model and/or AI/ML Model configuration in an AI/ML Model family may be assigned an identifier that may be known to both UE and BS. Signaling for activation/deactivation of the AI/ML Model or AI/ML Model configuration may include an identifier of an AI/ML Model and/or AI/ML Model configuration.

In accordance with an embodiment, the activation/deactivation signaling transmitted by a BS (for example, a BS as described above in conjunction with FIGS. 3 and/or 6) and received by a UE (for example, a UE as described above in conjunction with FIGS. 2 and/or 5) for AI/ML Model and/or AI/ML Model configuration may include a bit pattern corresponding to multiple AI/ML Models and/or AI/ML Model configurations where an individual bit may correspond to an AI/ML Model and/or AI/ML Model configuration.

### AI/ML Model Performance Monitoring Based Re-Training.

In accordance with an embodiment, re-training for AI/ML Model(s) on a UE side may be used to address performance issues, for periodic re-training, for AI/ML Model updates, and/or for synchronization of UE/BS and/or AI/ML Models. A BS (for example, a BS as described above in conjunction with FIGS. 3 and/or 6) may configure a UE (for example, a UE as described above in conjunction with FIGS. 2 and/or 5) with the predefined resource(s) (time-frequency) for transmitting reference signals (e.g., CSI-RS, DMRS, SSB, or positioning reference signals) for AI/ML Model re-training at UE. A UE may receive reference signals for re-training. A BS may configure a UE with predefined resource(s) via RRC signaling and/or physical layer signaling. Predefined resource(s) may have a staggered configuration to capture the entire frequency range and/or the configured frequency range as per UE capabilities.

In accordance with an embodiment, a BS (for example, a BS as described above in conjunction with FIGS. 3 and/or 6) may configure a UE (for example, a UE as described above in conjunction with FIGS. 2 and/or 5) with re-training data via RRC signaling, physical layer signaling and/or application layer-based retraining related data download. Re-training data may include one or more of simulated training data, compressed training data, AI/ML Model parameters (such as, for example, one or more of coefficients, weights, biases, number of AI/ML tasks, AI/ML task identifier(s), classifier (such as, for example, Regression, KNN, Vector machine, Decision Tree, and/or Principal component), and/or cluster centroids in clustering), and/or may include hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer).

In accordance with an embodiment, re-training of AI/ML Model(s) on a BS (for example, a BS as described above in conjunction with FIGS. 3 and/or 6) side may be used to address performance issues, for periodic re-training, for AI/ML Model updates, and/or synchronization of UE/BS AI/ML Models. A BS may configure a UE (for example, a UE as described above in conjunction with FIGS. 2 and/or 5) with predefined resource(s) (time/frequency) for receiving reference signals (SRS, DMRS, SSB or positioning reference signals) for AI/ML Model re-training at BS. A UE may transmit the reference signals (e.g., SRS) for re-training. A BS may configure a UE with predefined resource(s) via RRC signaling and/or physical layer signaling. Predefined resource(s) may have a staggered configuration to capture an entire frequency range and/or a configured frequency range as per UE capabilities.

In accordance with an embodiment, a BS (for example, a BS as described above in conjunction with FIGS. 3 and/or 6) may simulate re-training data for re-training the AI/ML Model(s) on BS.

### Signaling for Carrier Aggregation

In accordance with an embodiment, a UE (for example, a UE as described above in conjunction with FIGS. 2 and/or 5) may be configured with carrier aggregation, and a UE may maintain separate configurations of AI/ML Models for separate carriers as the propagation environment of UE over different carriers may have different characteristics. When a UE is configured for carrier aggregation, the UE may be provided with RRC signaling by a BS (for example, a BS as described above in conjunction with FIGS. 3 and/or 6) indicating the AI/ML Model configurations of carriers depending on the UE capabilities. For example, RRC signaling, transmitted by the BS and received by the UE, may indicate to UE one or more of AI/ML Model Family 1 (AI/ML Model 1 Configuration 1) and/or AI/ML Model Family 2 (AI/ML Model 1 Configuration 1) in the RRC configuration for component carrier 1 (CC1) and one or more of AI/ML Model Family 1 (AI/ML Model 1 Configuration 2) and/or AI/ML Model Family 2 (AI/ML Model 1 Configuration 2) in the RRC configuration for component carrier 2 (CC2). A UE may maintain AI/ML Model configurations for CC1 and/or CC2 and use corresponding configuration while communicating over CC1 and/or CC2. AI/ML Model configuration may include may include one or more of the AI/ML Model version number, identifier(s) or indicator(s) (or index(s)) of AI/ML Model(s), identifier(s) or indicator(s) (or index(s) of configuration of AI/ML Model(s), identifier(s) or indicator(s) (or index(s)) of a family of AI/ML Models, identifier(s) or indicator(s) (or index(s)) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)).

In accordance with an embodiment, a UE (for example, a UE as described above in conjunction with FIGS. 2 and/or 5) configured with carrier aggregation may be provided with RRC signaling by a BS (for example, a BS as described above in conjunction with FIGS. 3 and/or 6) indicating AI/ML Model configurations. RRC signaling, transmitted by the BS and received by the UE, may include one or more of AI/ML Model version number, identifier(s) or indicator(s) (or index(s)) of AI/ML Model(s), identifier(s) or indicator(s) (or index(s)) of configuration of AI/ML Model(s), identifier(s) or indicator(s) (or index(s)) of a family of AI/ML Models, identifier(s) or indicator(s) (or index(s)) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s) (or index(s), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)).

In accordance with an embodiment, a UE (for example, a UE as described above in conjunction with FIGS. 2 and/or 5) configured with carrier aggregation may be provided with a signaling by a BS (for example, a BS as described above in conjunction with FIGS. 3 and/or 6) indicating AI/ML Model configurations. The signaling, transmitted by the BS, and received by the UE, may include information of a plurality of carriers (or cell indices) configured with a common AI/ML Model configuration. For example: in a heterogenous network deployment carriers associated with a Micro cell may be provided a common first AI/ML Model configuration and carriers associated with a Macro cell may be provided a common second AI/ML Model configuration. Another example may include a dual connectivity deployment where carriers associated with a first base station may be provided a common first AI/ML Model configuration and carriers associated with a second base station may be provided a common second AI/ML Model configuration. The signaling may be provided via RRC, physical or MAC layer. The signaling may include one or more of cell indices or an indicator of cell indices, cell group indicator (or index) indicating group of cells configured for a common AI/ML Model configuration, AI/ML Model version number(s), identifier(s) or indicator(s) (or index(s) of AI/ML Model(s), identifier(s) or indicator(s) (or index(s)) of configuration of AI/ML Model(s), identifier(s) or indicator(s) (or index(s) of a family of AI/ML Models, identifier(s) or indicator(s) (or index(s)) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s) (or index(s)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer).

In accordance with an embodiment, a UE (for example, a UE as described above in conjunction with FIGS. 2 and/or 5) configured with carrier aggregation may be provided with a first signaling by a BS (for example, a BS as described above in conjunction with FIGS. 3 and/or 6) indicating AI/ML Model configurations. The first signaling, transmitted by the BS, and received by the UE, may include information of a plurality of carriers (or cell indices) configured with a common AI/ML Model configuration. For example, the first signaling may refer to an RRC signaling. Subsequently, the BS transmits, and the UE receive, a second signaling indicating the plurality of carriers (or cell indices) to activate the use of common AI/ML Model configuration. Based on the second signaling, the UE activates the common AI/ML Model configuration, configures the AI/ML engine (211) for processing the transmission/reception of signals/channels corresponding to the plurality of carriers. The second signaling may refer to a physical or a MAC layer signaling.

In accordance with an embodiment, a UE (for example, a UE as described above in conjunction with FIGS. 2 and/or 5) configured with carrier aggregation may be provided with a first signaling by a BS (for example, a BS as described above in conjunction with FIGS. 3 and/or 6) indicating a plurality of AI/ML Model configurations. The first signaling, transmitted by the BS, and received by the UE, may include information of a plurality of carriers (or cell indices) configured with a plurality of common AI/ML Model configurations. For example, the first signaling may refer to an RRC signaling. Subsequently, the BS transmits, and the UE receive, a second signaling indicating the plurality of carriers (or cell indices) and a first common AI/ML Model configuration among the plurality of common AI/ML Model configurations to activate the use of the first common AI/ML Model configuration. Based on the second signaling, the UE activates the first common AI/ML Model configuration, configures the AI/ML engine (211) for processing the transmission/reception of signals/channels corresponding to the plurality of carriers. The second signaling may refer to a physical or a MAC layer signaling.

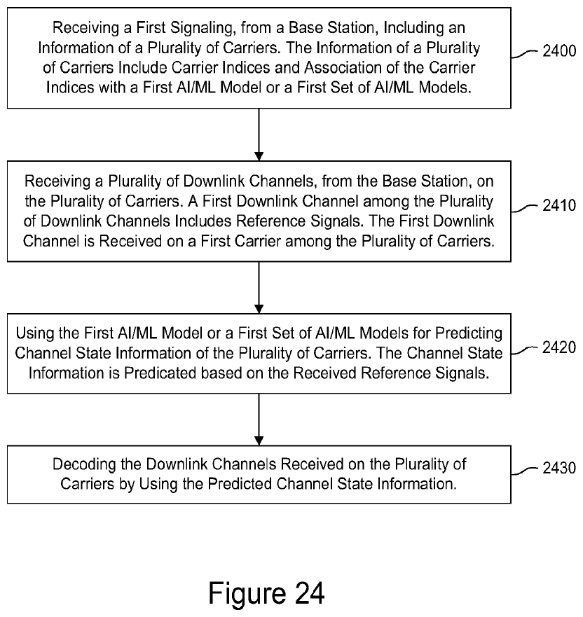

In accordance with an embodiment as shown in FIG. 24, a UE (for example, a UE as described above in conjunction with FIGS. 2 and/or 5) configured with carrier aggregation receives a first signaling from a base station (for example, a BS as described above in conjunction with FIGS. 3 and/or 6), including an information of a plurality of carriers. The information of a plurality of carriers include carrier indices and association of the carrier indices with a first AI/ML Model or a first set of AI/ML Models (2400). The first signaling may refer to an RRC signaling. After receiving the first signaling, the UE configures itself with carrier aggregation and configures the AI/ML engine with the first AI/ML Model or the first set of AI/ML Models. The UE receives a plurality of downlink channels, from the base station, on the plurality of carriers. A first downlink channel among the plurality of downlink channels includes reference signals. The first downlink channel is received on a first carrier among the plurality of carriers (2410). The UE uses the first AI/ML Model or the first set of AI/ML Models for predicting channel state information of the plurality of carriers. The channel state information is predicted based on the received reference signals (2420). The UE uses the reference signals received on the first carrier to predict the channel state of other carriers using the first AI/ML Model or the first set of AI/ML Models. Since the plurality of carriers are transmitted from the same base station and received by the same UE, the redundancy in channel characteristics across carriers may be exploited using the first AI/ML Model or the first set of AI/ML Models. The reference signals are received only on the first carrier, or the reference signals received on the first carrier has a denser reference signal configuration as compared to a reference signal configuration received on the other carriers. The reference signal configuration refers to the reference signal pattern. Example reference signals may include CSI-RS, DMRS, or SSB signals. The first carrier may be configured to be carrier with the smallest cell index, or it may be the carrier predefined by the base station for predicting the channel state information for the plurality of carriers. The UE decodes the downlink channels received on the plurality of carriers by using the predicted channel state information (2430). The UE may use the estimated channel state information for decoding the downlink channels received on the first carrier and use the predicted channel state information for decoding the downlink channels received on the other carriers, or the UE may use the predicted channel state information for decoding the downlink channels received on all the carriers.

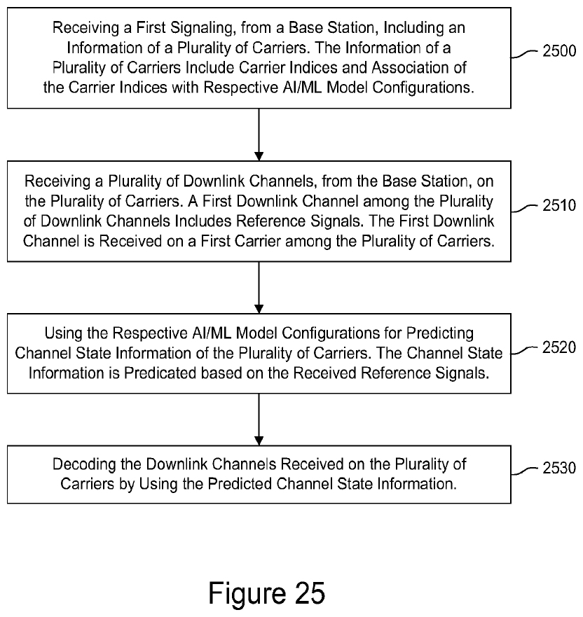

In accordance with an embodiment as shown in FIG. 25, a UE (for example, a UE as described above in conjunction with FIGS. 2 and/or 5) configured with carrier aggregation receives a first signaling from a base station (for example, a BS as described above in conjunction with FIGS. 3 and/or 6), including an information of a plurality of carriers. The information of a plurality of carriers include carrier indices and association of the carrier indices with respective AI/ML Model configurations (2500). The respective AI/ML Model configuration for each carrier may be defined based on the carrier frequencies. For example, carriers in FR1 range may have a different AI/ML Model configuration from the carriers in the FR2 range. Some carriers may have the same AI/ML Model configuration. The description of AI/ML Model configuration may be identified from other sections of the present disclosure. The first signaling may refer to an RRC signaling. After receiving the first signaling, the UE configures itself with carrier aggregation and configures the AI/ML engine for each carrier with the respective AI/ML Model configuration. The UE receives a plurality of downlink channels, from the base station, on the plurality of carriers. A first downlink channel among the plurality of downlink channels includes reference signals. The first downlink channel is received on a first carrier among the plurality of carriers (2510). The UE uses the respective AI/ML Model configurations for predicting channel state information of the plurality of carriers. The channel state information is predicted based on the received reference signals (2520). The UE uses the reference signals received on the first carrier to predict the channel state of other carriers using the respective AI/ML Model configurations. Since the plurality of carriers are transmitted from the same base station and received by the same UE, the redundancy in channel characteristics across carriers may be exploited using the respective AI/ML Model configurations. The reference signals are received only on the first carrier, or the reference signals received on the first carrier has a denser reference signal configuration as compared to a reference signal configuration received on the other carriers. The reference signal configuration refers to the reference signal pattern. Example reference signals may include CSI-RS, DMRS, or SSB signals. The first carrier may be configured to be carrier with the smallest cell index, or it may be the carrier predefined by the base station for predicting the channel state information for the plurality of carriers. The UE decodes the downlink channels received on the plurality of carriers by using the predicted channel state information (2530). The UE may use the estimated channel state information for decoding the downlink channels received on the first carrier and use the predicted channel state information for decoding the downlink channels received on the other carriers, or the UE may use the predicted channel state information for decoding the downlink channels received on all the carriers.

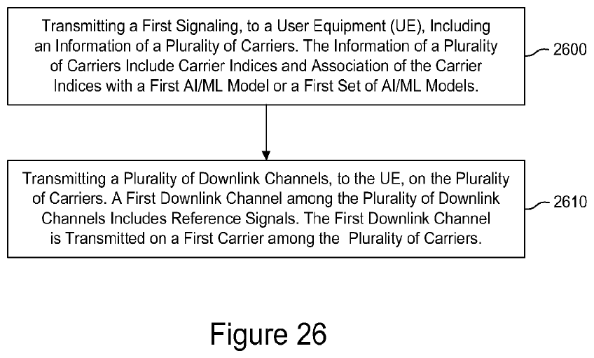

In accordance with an embodiment as shown in FIG. 26, a base station (for example, a BS as described above in conjunction with FIGS. 3 and/or 6), configures a UE (for example, a UE as described above in conjunction with FIGS. 2 and/or 5) with carrier aggregation by transmitting a first signaling including an information of a plurality of carriers. The information of a plurality of carriers include carrier indices and association of the carrier indices with a first AI/ML Model or a first set of AI/ML Models (2600). The first signaling may refer to an RRC signaling. The first signaling is used by the UE to configures itself with carrier aggregation and configures its AI/ML engine with the first AI/ML Model or the first set of AI/ML Models. The base station transmits a plurality of downlink channels, to the UE, on the plurality of carriers. A first downlink channel among the plurality of downlink channels includes reference signals. The first downlink channel is transmitted on a first carrier among the plurality of carriers (2610). The UE uses the first AI/ML Model or the first set of AI/ML Models for predicting channel state information of the plurality of carriers. The channel state information is predicted based on the transmitted reference signals. The UE uses the reference signals transmitted on the first carrier to predict the channel state of other carriers using the first AI/ML Model or the first set of AI/ML Models. Since the plurality of carriers are transmitted from the same base station and received by the same UE, the redundancy in channel characteristics across carriers may be exploited using the first AI/ML Model or the first set of AI/ML Models. The reference signals are transmitted only on the first carrier, or the reference signals transmitted on the first carrier has a denser reference signal configuration as compared to a reference signal configuration received on the other carriers. The reference signal configuration refers to the reference signal pattern. Example reference signals may include CSI-RS, DMRS, or SSB signals. The first carrier may be configured to be carrier with the smallest cell index, or it may be the carrier predefined by the base station for predicting the channel state information for the plurality of carriers.

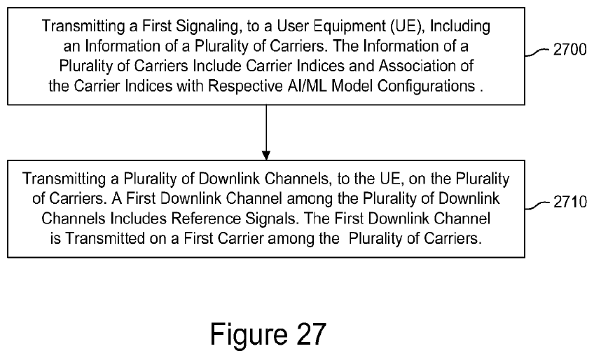

In accordance with an embodiment as shown in FIG. 27, a base station (for example, a BS as described above in conjunction with FIGS. 3 and/or 6), configures a UE (for example, a UE as described above in conjunction with FIGS. 2 and/or 5) with carrier aggregation by transmitting a first signaling including an information of a plurality of carriers. The information of a plurality of carriers include carrier indices and association of the carrier indices with respective AI/ML Model configurations (2700). The respective AI/ML Model configuration for each carrier may be defined based on the carrier frequencies. For example, carriers in FR1 range may have a different AI/ML Model configuration from the carriers in the FR2 range. Some carriers may have the same AI/ML Model configuration. The description of AI/ML Model configuration may be identified from other sections of the present disclosure. The first signaling may refer to an RRC signaling. The first signaling is used by the UE to configures itself with carrier aggregation and configures its AI/ML engine with the respective AI/ML Model configurations. The base station transmits a plurality of downlink channels, to the UE, on the plurality of carriers. A first downlink channel among the plurality of downlink channels includes reference signals. The first downlink channel is transmitted on a first carrier among the plurality of carriers (2710). The UE uses the respective AI/ML Model configurations for predicting channel state information of each of the plurality of carriers. The channel state information is predicted based on the transmitted reference signals. The UE uses the reference signals transmitted on the first carrier to predict the channel state of other carriers using the respective AI/ML Model configurations. Since the plurality of carriers are transmitted from the same base station and received by the same UE, the redundancy in channel characteristics across carriers may be exploited using the respective AI/ML Model configurations. The reference signals are transmitted only on the first carrier, or the reference signals transmitted on the first carrier has a denser reference signal configuration as compared to a reference signal configuration received on the other carriers. The reference signal configuration refers to the reference signal pattern. Example reference signals may include CSI-RS, DMRS, or SSB signals. The first carrier may be configured to be carrier with the smallest cell index, or it may be the carrier predefined by the base station for predicting the channel state information for the plurality of carriers.

### Signaling for Bandwidth Parts (BWPs)

In accordance with an embodiment, a UE (for example, a UE as described above in conjunction with FIGS. 2 and/or 5) configured with multiple BWPs may maintain separate configurations of AI/ML Models for BWPs as the propagation environment of UE over different BWPs may have different characteristics. A UE configured for BWPs may be provided with RRC signaling by a BS (for example, a BS as described above in conjunction with FIGS. 3 and/or 6) indicating the AI/ML Model configurations of one or more BWPs depending on the UE capabilities. For example, RRC signaling may indicate to UE one or more of AI/ML Model Family 1 (AI/ML Model 1 Configuration 1) and/or AI/ML Model Family 2 (AI/ML Model 1 Configuration 1) in the RRC configuration for BWP1 and one or more of AI/ML Model Family 1 (AI/ML Model 1 Configuration 2) and/or AI/ML Model Family 2 (AI/ML Model 1 Configuration 2) in the RRC configuration for BWP2. A UE may maintain the AI/ML Model configurations for both BWP1 and BWP2 and use the corresponding configuration while communicating over BWP1 and/or BWP2. AI/ML Model configuration may include one or more of the AI/ML Model version number, identifier(s) or indicator(s) (or index(s)) of AI/ML Model(s), identifier(s) or indicator(s) (or index(s) of configuration of AI/ML Model(s), identifier(s) or indicator(s) (or index(s)) of a family of AI/ML Models, identifier(s) or indicator(s) (or index(s)) of a set of AI/ML Models, and/or identifier(s) or indicator(s) (or index(s) of a set of families of AI/ML Models, details of performance metric being used, AI/ML Model parameters (such as, for example, one or more of coefficients, weights, biases, number of AI/ML tasks, AI/ML task identifier(s) (or index(s)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer).

In accordance with an embodiment, a UE (for example, a UE as described above in conjunction with FIGS. 2 and/or 5) configured with multiple BWPs may be provided with RRC signaling by a BS (for example, a BS as described above in conjunction with FIGS. 3 and/or 6) indicating AI/ML Model configurations. RRC signaling may include one or more of the AI/ML Model version number, identifier(s) or indicator(s) (or index(s)) of AI/ML Model(s), identifier(s) or indicator(s) (or index(s)) of configuration of AI/ML Model(s), identifier(s) or indicator(s) (or index(s) of a family of AI/ML Models, identifier(s) or indicator(s) (or index(s) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s) (or index (a)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)).

In accordance with an embodiment, a UE (for example, a UE as described above in conjunction with FIGS. 2 and/or 5) configured with a plurality of BWPs may be provided with a first signaling by a BS (for example, a BS as described above in conjunction with FIGS. 3 and/or 6) indicating a plurality of AI/ML Model configurations each corresponding to a BWP. The first signaling, transmitted by the BS, and received by the UE, may include information of a plurality of BWPs (or BWP IDs) each BWP configured with an AI/ML Model configuration. For example, the first signaling may refer to an RRC signaling. Subsequently, the BS transmits, and the UE receive, a second signaling indicating a BWP (or BWP ID) among the BWPs and/or a first AI/ML Model configuration among the plurality of AI/ML Model configurations to activate the use of the first AI/ML Model configuration. Based on the second signaling, the UE activates the first/ML Model configuration, configures the AI/ML engine (211) for processing the transmission/reception of signals/channels corresponding to the indicated BWP. The second signaling may refer to a physical or a MAC layer signaling.

### Signaling for Dual Connectivity

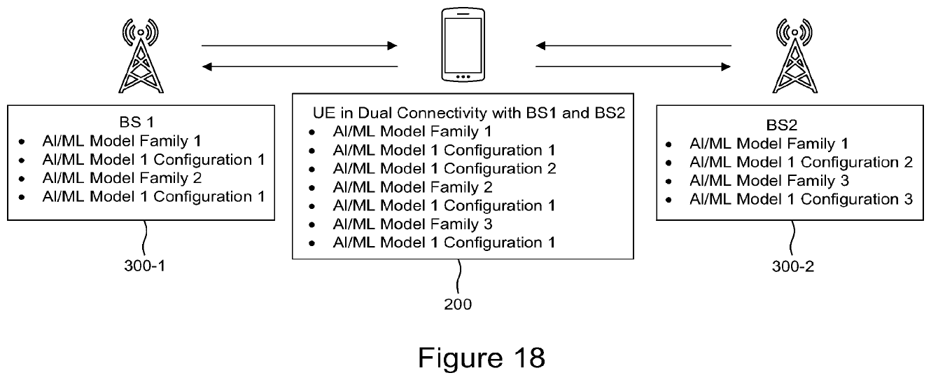

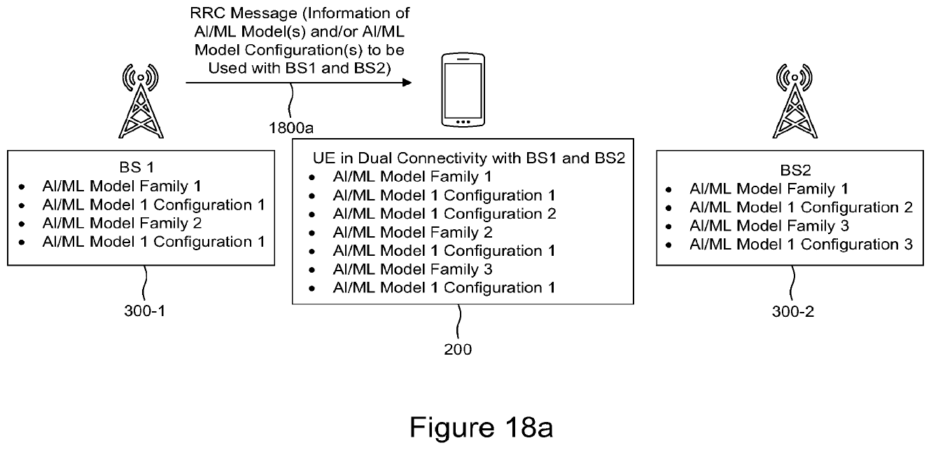

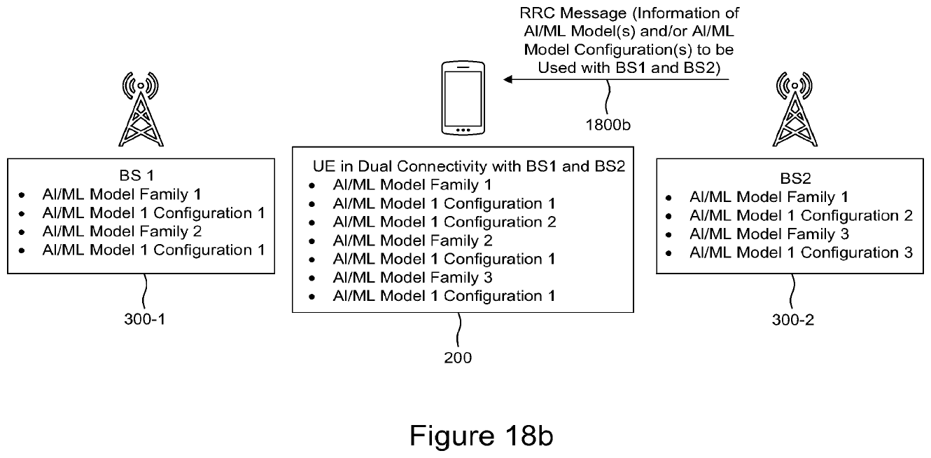

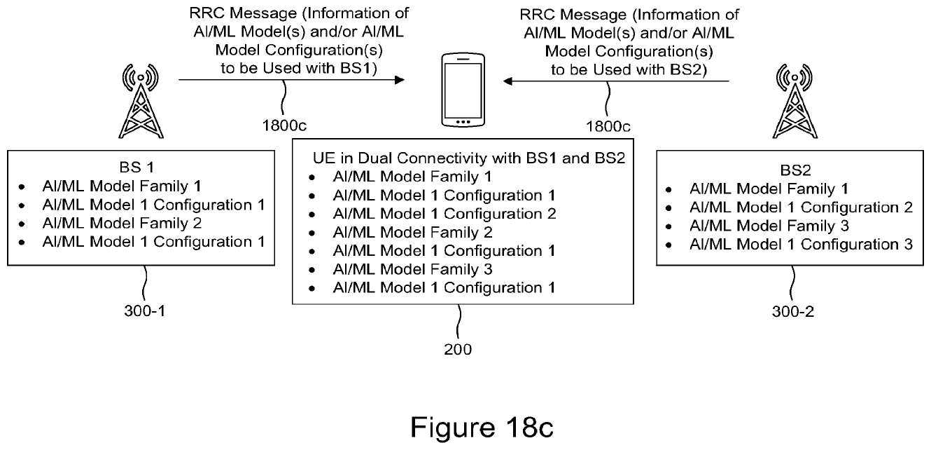

In accordance with an embodiment as shown in FIG. 18, a UE (for example, a UE as described above in conjunction with FIGS. 2 and/or 5) may be configured in a dual connectivity mode whereby it can simultaneously transmit/receive to/from a first base station (BS1 (300-1) and a second BS (BS2 (300-2)) (for example, BS1 or BS2 may refer to a BS as described above in conjunction with FIGS. 3 and/or 6). In a dual connectivity mode, a UE (200) may maintain separate configurations of AI/ML Models while communicating with two base stations given the propagation environment of UE (200) and BS1 (300-1) may be different from the UE (200) and BS2 (300-2). A UE (200) configured for dual connectivity may be provided with an RRC message (or signaling) indicating AI/ML Model configurations of BS1 (300-1) and BS2 (300-2) depending on the UE capabilities. For example, an RRC message (or signaling) may indicate to UE (200) one or more of AI/ML Model Family 1 (AI/ML Model 1 Configuration 1) and/or AI/ML Model Family 2 (AI/ML Model 1 Configuration 1) in the RRC configuration for BS1 (300-1) and/or one or more of AI/ML Model Family 1 (AI/ML Model 1 Configuration 2) and/or AI/ML Model Family 3 (AI/ML Model 1 Configuration 1) in the RRC configuration for BS2 (300-2). A UE (200) may maintain AI/ML Model configurations for both BS1 (300-1) and BS2 (300-2) and use the corresponding configuration while communicating with BS1 (300-1) and/or BS2 (300-2). The AI/ML Model configuration may include one or more of the AI/ML Model version number, identifier(s) or indicator(s) (or index(s)) of AI/ML Model(s), identifier(s) or indicator(s) (or index(s) of configuration of AI/ML Model(s), identifier(s) or indicator(s) (or index(s)) of a family of AI/ML Models, identifier(s) or indicator(s) (or index(s) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s) (or index(s), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)).

In accordance with an embodiment, a UE (200) (for example, a UE as described above in conjunction with FIGS. 2 and/or 5) configured with a dual connectivity mode whereby it can simultaneously transmit/receive to/from a first base station (BS1 (300-1)) and a second BS (BS2 (300-2) for example, BS1 or BS2 may refer to a BS as described above in conjunction with FIGS. 3 and/or 6) receives a first signaling from BS1 (300-1) indicating a first plurality of AI/ML Model configurations corresponding to BS1 (300-1) and a second plurality of AI/ML Model configurations corresponding to BS2 (300-2). For example, the first signaling may refer to an RRC signaling. Subsequently, the BS1 (300-1) transmits, and the UE (200) receive, a second signaling indicating a first AI/ML Model configuration among the first plurality of AI/ML Model configurations to activate the use of the first AI/ML Model configuration. Based on the second signaling, the UE activates the first/ML Model configuration, configures the AI/ML engine (211) for processing the transmission/reception of signals/channels related to the BS1 (300-1). The second signaling may refer to a physical or a MAC layer signaling. The BS2 (300-2) transmits, and the UE (200) receive, a third signaling indicating a second AI/ML Model configuration among the second plurality of AI/ML Model configurations to activate the use of the second AI/ML Model configuration. Based on the third signaling, the UE activates the second AI/ML Model configuration, configures the AI/ML engine (211) for processing the transmission/reception of signals/channels related to the BS2 (300-2). The third signaling may refer to a physical or a MAC layer signaling.

In accordance with an embodiment, a UE (200) (for example, a UE as described above in conjunction with FIGS. 2 and/or 5) configured with a dual connectivity mode whereby it can simultaneously transmit/receive to/from a first base station (BS1 (300-1)) and a second BS (BS2 (300-2) for example, BS1 or BS2 may refer to a BS as described above in conjunction with FIGS. 3 and/or 6) receives a first signaling from BS1 (300-1) indicating a first plurality of AI/ML Model configurations corresponding to BS1 (300-1) and receives a second signaling from BS2 (300-2) indicating a second plurality of AI/ML Model configurations corresponding to BS2 (300-2). For example, the first signaling and the second signaling may refer to RRC signalings. Subsequently, the BS1 (300-1) transmits, and the UE (200) receive, a third signaling indicating a first AI/ML Model configuration among the first plurality of AI/ML Model configurations to activate the use of the first AI/ML Model configuration. Based on the third signaling, the UE activates the first/ML Model configuration, configures the AI/ML engine (211) for processing the transmission/reception of signals/channels related to the BS1 (300-1). The third signaling may refer to a physical or a MAC layer signaling. The BS2 (300-2) transmits, and the UE (200) receive, a fourth signaling indicating a second AI/ML Model configuration among the second plurality of AI/ML Model configurations to activate the use of the second AI/ML Model configuration. Based on the fourth signaling, the UE activates the second AI/ML Model configuration, configures the AI/ML engine (211) for processing the transmission/reception of signals/channels related to the BS2 (300-2). The fourth signaling may refer to a physical or a MAC layer signaling.

In accordance with an embodiment as shown in FIG. 18a, a UE (for example, a UE as described above in conjunction with FIGS. 2 and/or 5) may be provided with RRC message (1800a) (or signaling) indicating AI/ML Model(s) and/or AI/ML Model configuration(s) of BS1 (300-1) and BS2 (300-2) (for example, BS1 or BS2 may refer to a BS as described above in conjunction with FIGS. 3 and/or 6) depending on UE capabilities by BS1 (300-1). For example, RRC message (1800a) (or signaling) may be provided by BS1 (300-1) to indicate to UE (200) one or more of AI/ML Model Family 1 (AI/ML Model 1 Configuration 1) and/or AI/ML Model Family 2 (AI/ML Model 1 Configuration 1) in the RRC configuration for BS1 (300-1) and one or more of AI/ML Model Family 1 (AI/ML Model 1 Configuration 2) and/or AI/ML Model Family 3 (AI/ML Model 1 Configuration 1) in the RRC configuration for BS2 (300-2). A UE (200) may maintain the AI/ML Model configurations for both BS1 (300-1) and BS2 (300-2) and use the corresponding configuration while communicating with BS1 (300-1) and/or BS2 (300-2). The RRC message (1800a) (or signaling) may include one or more message(s) sent by BS1 (300-1) to UE (200).

In accordance with an embodiment as shown in FIG. 18b, a UE (for example, a UE as described above in conjunction with FIGS. 2 and/or 5) may be provided with an RRC message (1800b) (or signaling) indicating AI/ML Model(s) and/or AI/ML Model configuration(s) of BS1 (300-1) and/or BS2 (300-2) (for example, BS1 or BS2 may refer to a BS as described above in conjunction with FIGS. 3 and/or 6) depending on the UE capabilities by BS2 (300-2). For example, an RRC message (1800b) (or signaling) may be provided by BS2 (300-2) to indicate to UE (200) one or more of AI/ML Model Family 1 (AI/ML Model 1 Configuration 1) and/or AI/ML Model Family 2 (AI/ML Model 1 Configuration 1) in the RRC configuration for BS1 (300-1) and one or more of AI/ML Model Family 1 (AI/ML Model 1 Configuration 2) and/or AI/ML Model Family 3 (AI/ML Model 1 Configuration 1) in the RRC configuration for BS2 (300-2). A UE (200) may maintain the AI/ML Model configurations for both BS1 (300-1) and BS2 (300-2) and use the corresponding configuration while communicating with BS1 (300-1) and/or BS2 (300-2). An RRC message (1800b) (or signaling) may include one or more message(s) sent by BS2 (300-2) to UE (200).

In accordance with an embodiment as shown in FIG. 18c, a UE (for example, a UE as described above in conjunction with FIGS. 2 and/or 5) may be provided with an RRC message (1800c, 1810c) (or signaling) indicating the AI/ML Model configurations of BS1 (300-1) and BS2 (300-2) (for example, BS1 or BS2 may refer to a BS as described above in conjunction with FIGS. 3 and/or 6) depending on the UE capabilities by BS1 (300-1) and BS2 (300-2) respectively. For example, an RRC message (1800c) (or signaling) may be provided by BS1 (300-1) to indicate to UE (200) one or more of AI/ML Model Family 1 (AI/ML Model 1 Configuration 1) and/or AI/ML Model Family 2 (AI/ML Model 1 Configuration 1) in the RRC configuration for BS1 (300-1) and/or the RRC message (1810c) (or signaling) may be provided by BS2 (300-2) to indicate to one or more of UE AI/ML Model Family 1 (AI/ML Model 1 Configuration 2) and/or AI/ML Model Family 3 (AI/ML Model 1 Configuration 1) in the RRC configuration for BS2 (300-2). A UE (200) may maintain the AI/ML Model configurations for BS1 (300-1) and/or BS2 (300-2) and use the corresponding configuration while communicating with BS1 (300-1) and/or BS2 (300-2). An RRC message (1800c, 1810c) (or signaling) may include one or more message(s) sent by BS1 (300-1) and/or BS2 (300-2) to UE (200).

In accordance with an embodiment, a UE (for example, a UE as described above in conjunction with FIGS. 2 and/or 5) configured with dual connectivity (as shown in FIG. 18, 18a, 18b or 18c) may be provided with an RRC message (1800a, 1800b, 1800c, 1810c) (or signaling) indicating the AI/ML Model configurations. An RRC message (1800a, 1800b, 1800c, 1810c) (or signaling) may include one or more of the AI/ML Model version number, identifier(s) or indicator(s) (or index(s)) of AI/ML Model(s), identifier(s) or indicator(s) (or index(s)) of configuration of AI/ML Model(s), identifier(s) or indicator(s) (or index(s)) of a family of AI/ML Models, identifier(s) or indicator(s) (or index(s) of a set of AI/ML Models, and/or identifier(s) or indicator(s) (or index(s)) of a set of families of AI/ML Models, details of performance metric being used, AI/ML Model parameters (such as, for example, one or more of coefficients, weights, biases, number of AI/ML tasks, AI/ML task identifier(s) (or index(s)), classifier (such as, for example, Regression, KNN, Vector machine, Decision Tree, or Principal component), cluster centroids in clustering), and/or hyper-parameters (such as, for example, number of layers, number of hidden layers, type of neural network (e.g., DNN, CNN, RNN, or LSTM), number of nodes per layer, number of activation units per layer, choice of a loss function, batch size, pooling size, choice of activation function (e.g., Sigmoid, ReLU, or Tan h), choice of optimization algorithm (e.g., gradient descent, stochastic gradient descent, or Adam optimizer)).

### AI/ML Based Early Handover Command

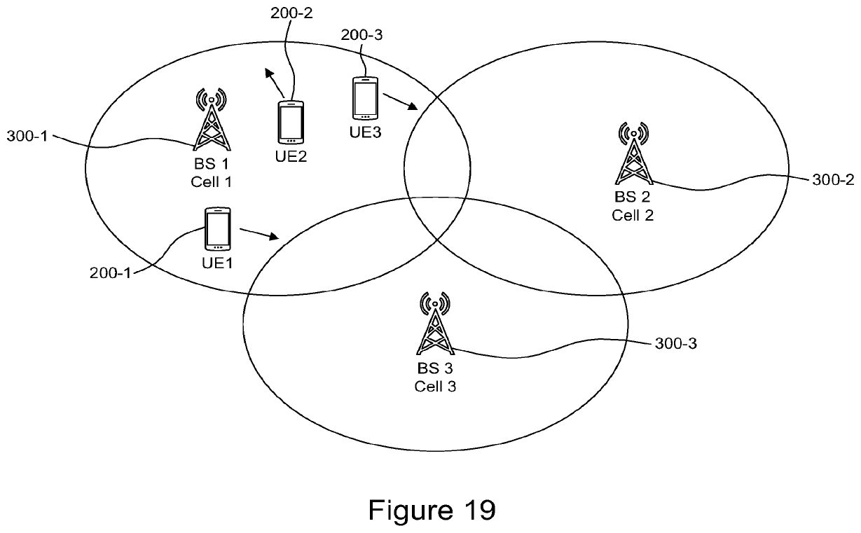

In accordance with an embodiment as shown in FIG. 19, AI/ML Model(s) may be implemented to predict early handover decisions. As shown in FIG. 19, depending on the speed and/or trajectory of UE 1 (200-1) (for example, UE1, UE2 or UE3 may refer to a UE as described above in conjunction with FIGS. 2 and/or 5), a first base station (BS1 (300-1)) (for example, BS1, BS2 or BS3 may refer to a BS as described above in conjunction with FIGS. 3 and/or 6) may predict (using a Positioning Module at BS) that UE1 (200-1) is going to handover to Cell 3 and, in advance, BS1 (300-1) may send the Handover command to the UE1 (200-1) in an RRC re-configuration message including one or more of a target cell ID, a new C-RNTI, and the security algorithm identifiers of a third base station (BS3 (300-3)) for the selected security algorithms, among other fields of a handover command. BS1 (300-1) may implement an AI/ML Model which may use UEs speed and/or trajectory information for predicting the handover decision. BS1 (300-1) may receive the speed and/or trajectory information from UEs (including UE 1 (200-1)), or BS1 (300-1) may itself estimate the speed and/or trajectory information from the information received from UEs (for example, UE1 (200-1), UE2 (200-2), or UE3 (200-3) such as, for example, reference signals (e.g., DMRS or SRS) or angle of arrival/departure. BS1 (300-1) may then provide received/estimated speed and/or trajectory information to an AI/ML Model of a Positioning Module for predicting the future UE locations. If a predicted UE location indicates the UE in the cell different from the Cell1 of BS1 (300-1), BS1 (300-1) may generate a handover command and send it to the UE. For example, BS1 (300-1) may predict the location of UE3 (200-3) to be in Cell 2 after time t1 seconds. BS1 (300-1) may generate and send the handover command before t1-x seconds, where x may be determined such that UE3 (200-3) may not have to perform neighbor cell measurements and send the measurement report to BS1 (300-1), saving the UE3 (200-3) resources and power along with the network resources for sending the measurement report. If UE3 (200-3) receives the handover command while performing neighbor cell measurements, UE3 (200-3) may ignore sending the measurement report. In the case of UE2 (200-2), BS1 (300-1) may predict the location of UE2 (200-2) to be in Cell 1 even after t1 seconds. BS1 (300-1) may avoid sending the handover command and continue monitoring the UE2 (200-2) speed and/or trajectory for predicting the UE2 (200-2) location for making handover decisions.

Further, in accordance with an embodiment as shown in FIG. 19, before sending a handover command (determined based on UE Speed and/or trajectory information) to a UE (for example, a UE as described above in conjunction with FIGS. 2 and/or 5), BS1 (300-1) (for example, BS1 (300-1), BS2 (300-2) or BS3 (300-3) may refer to a BS as described above in conjunction with FIGS. 3 and/or 6) may prepare a second base station (BS2 (300-2) and/or BS3 (300-2) for handover by sending the handover request (for example, Handover Request for UE1 (200-1) to BS3 (300-3) and/or Handover Request for UE3 (300-3) to BS2 (300-2)) containing one or more of UE history information, UE context information, GUAMI, target cell ID, and/or list of PDU sessions. After receiving acknowledgment from BS2 (300-2) and/or BS3 (300-3), BS1 (300-1) may send a handover command to UE3 (200-3) and/or UE1 (200-1). BS1 (300-1) may also send the SN Status Transfer message to BS2 (300-2) and/or BS3 (300-3) to transfer uplink and downlink PDCP SN and Hyper Frame Number (HFN) status of UE 3 (300-3) and/or UE 1 (200-1). BS1 (300-1) may start buffering the DL data coming from UPF and forward to BS2 (300-2) and/or BS3 (300-3). In accordance with an aspect as shown in FIG. 19, after a handover request from BS1 (300-1) is accepted by BS2 (300-2) and/or BS3 (300-3), BS1 (300-1) may send the details of the contention free random access (RACH) preambles to UE1 (200-1) and/or UE3 (200-3) for performing the RACH procedure with the respective BS3 (300-3) and/or BS2 (300-2). BS1 (300-1) may receive the RACH preambles from BS3 (300-3) and/or BS2 (300-2), and/or it may generate them from information received from BS3 (300-3) and/or BS2 (300-2). UE1 (200-1) and/or UE3 (300-3) may use the received preambles from BS1 (300-1) and perform the respective RACH procedures.

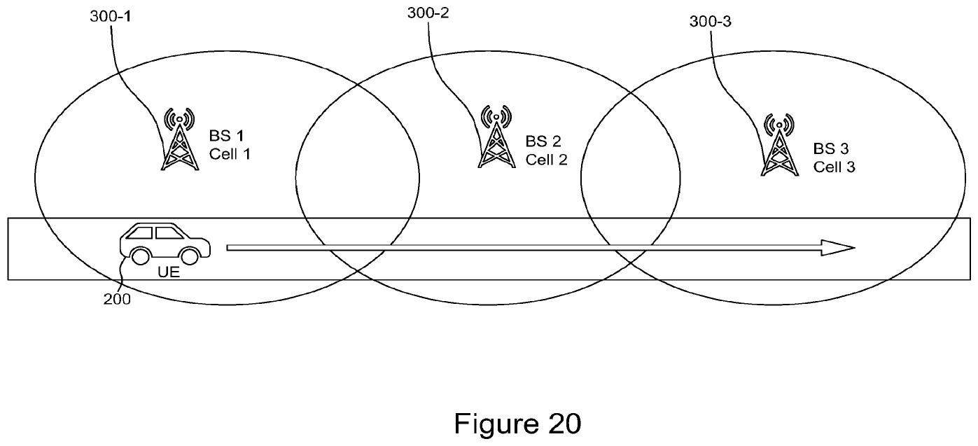

In accordance with an embodiment as shown in FIG. 20, the AI/ML Model(s) may be implemented to predict early handover decision depending on UE (200) (for example, a UE as described above in conjunction with FIGS. 2 and/or 5) speed and/or trajectory. A first base station (BS1 (300-1)) (for example, BS1 (300-1), BS2 (300-2) or BS3 (300-3) may refer to a BS as described above in conjunction with FIGS. 3 and/or 6) may predict that a first user equipment (UE (200) is about to handover to BS2 (300-2) and in advance, BS1 (300-1) may send a Handover command in an RRC re-configuration message including one or more of a target cell ID, a new C-RNTI, and the security algorithm identifiers of BS2 (300-2) for the selected security algorithms, among other fields of a handover command. BS1 (300-1) may implement an AI/ML Model which may use UEs speed and/or trajectory information for predicting the handover decision. BS1 (300-1) may receive the speed and/or trajectory information from a UE (200), or the BS1 (300-1) may receive speed and/or trajectory information from a core network entity or a location server. In FIG. 20, a UE (200) may refer to a smartphone, tablet, mobile device with cellular connectivity or a car/Drone/UAV/Train/Ship/Vehicle with cellular connectivity and a map application running on a UE (200). A UE (200) may allow secure access to its map application to BS1 (300-1), to a core network entity connected with BS1 (300-1), or to a location server in connection to a core network entity connected with BS1 (300-1). BS1 (300-1) may receive the UE speed and/or trajectory information from the UE's map application, from a core network entity connected to BS1 (300-1), or from a location server in connection to a core network entity connected to BS1 (300-1). The secure access to map application may include encryption-based security, restricted access to only relevant details such as UE speed and/or trajectory, and/or any security or access control mechanism for protecting user privacy. BS1 (300-1) may provide received speed and/or trajectory information to the AI/ML Model for predicting the future UE location, and if the predicted UE location indicates a UE (200) in the cell different from the Cell1 of BS1 (300-1), BS1 (300-1) may generate a handover command send it to the UE (200). For example, the BS1 (300-1) may predict the location of UE (200) to be in Cell 2 of BS2 (300-2) after time t1 seconds. BS1 (300-1) may generate and send the handover command before t1-x seconds, where x may be determined such that UE (200) may not have to perform neighbor cell measurements and send the measurement report to BS1 (300-1), saving the UE resources and power along with the network resources for sending the measurement report. If a UE (200) receives a handover command while performing the neighbor cell measurements, the UE (200) may ignore sending the measurement report.

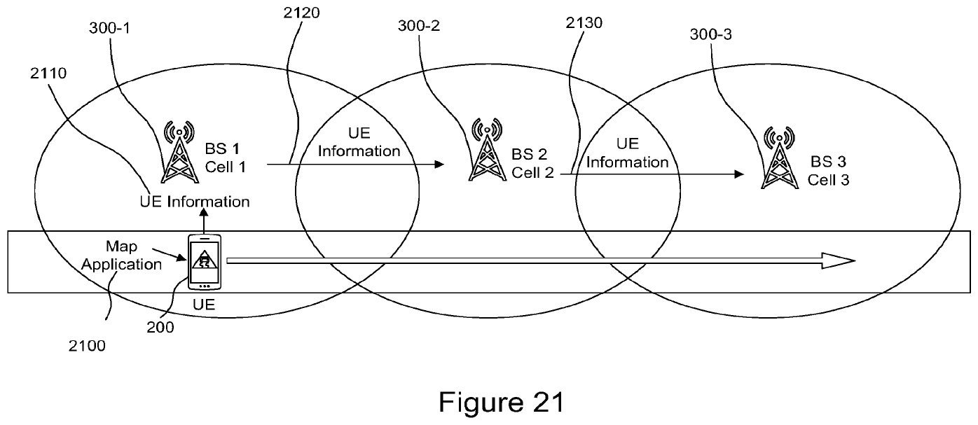

In accordance with an embodiment as shown in FIG. 21, a UE's (200) (for example, a UE as described above in conjunction with FIGS. 2 and/or 5) map application (2100) may share UE information (2110) containing the details of UE's destination address/location, UE speed and/or trajectory information with BS1 (300-1) (for example, BS1 (300-1), BS2 (300-2) or BS3 (300-3) may refer to a BS as described above in conjunction with FIGS. 3 and/or 6) at the start or after a time offset from the start of UE's journey. A UE (200) may share UE information (2110) with BS1 (300-1), and BS1 (300-1) may forward the received UE information (or modified UE information) (2120) to BS2 (300-2). BS1 (300-1) may determine BS2 (300-2) for forwarding the UE information (2120) based on the identification of the next base station on UE's route to its destination. Similarly, BS2 (300-2) may forward UE information (2130) to BS3 (300-3) so that it reaches all the base stations on the route. BS1 (300-1) may forward the details to BS2 (300-2) during a handover preparation step. In a variation to this embodiment, the BS1 (300-1) may receive the UE information (2110) from the map application server of the UE's map application (2100) (e.g., Google Maps server) via an API.

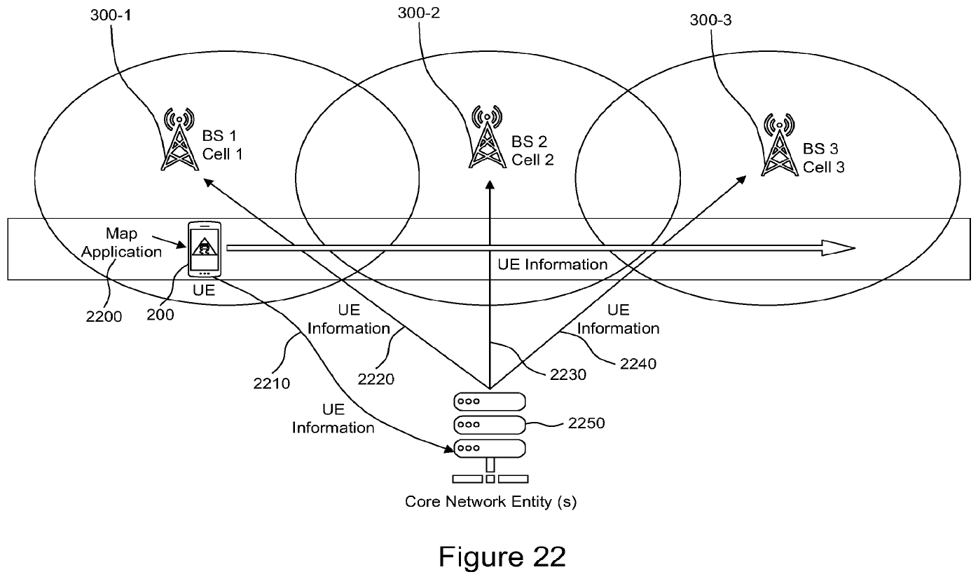

In accordance with an embodiment as shown in FIG. 22, a UE's (200) (for example, a UE as described above in conjunction with FIGS. 2 and/or 5) map application (2200) may share UE information (2210) containing the details of UE's destination address/location, UE speed and/or trajectory information, with a core network entity(s) connected with BS1 (300-1) (for example, BS1 (300-1), BS2 (300-2), or BS3 (300-3) may refer to a BS as described above in conjunction with FIGS. 3 and/or 6), at the start or after a time offset from the start of UE's journey. The core network entity(s) (2250) may share received UE information (or modified UE information) (2210) with base stations located on the UE's route to a destination such as BS1 (300-1), BS2 (300-2), and BS3 (300-3). A core network entity(s) (2250) may share UE information (2220, 2230, 2240) with base stations in advance of UE's arrival to the coverage of the respective base station. A core network entity(s) (2250) may share UE information (2220, 2230, 2240) with one base station at a time. In a variation to this embodiment, a core network entity(s) (2250) may receive the UE information (2210) from the map application server of the UE's map application (2200) (e.g., Google Maps server) via an API.

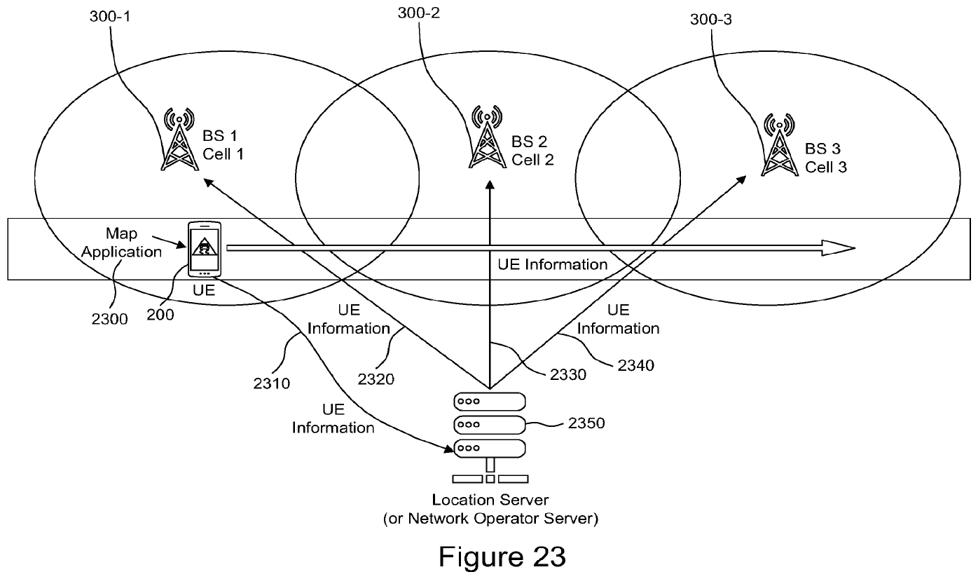

In accordance with an embodiment as shown in FIG. 23, a UE's (200) (for example, a UE as described above in conjunction with FIGS. 2 and/or 5) map application (2300) shares UE information (2310) containing the details of UE's destination address/location, UE speed and/or trajectory information with a location server (or a network operator's server) (2350) connected to the BS1 (300-1) (for example, BS1 (300-1), BS2 (300-2), or BS3 (300-3) may refer to a BS as described above in conjunction with FIGS. 3 and/or 6) at the start or after a time offset from the start of a UE's journey. A location server (or a network operator's server) (2350) may share the details of received UE information (or modified UE information) (2310) with base stations located on a UE's route to a destination such as BS1 (300-1), BS2 (300-2), and BS3 (300-3). The location server (or a network operator's server) (2350) may share UE information (2320, 2330, 2340) with base stations in advance of UE's arrival to the coverage of the respective base station. A location server (or a network operator's server) (2350) may share UE information (2320, 2330, 2340) with one base station at a time. In a variation to this embodiment, the location server (or a network operator's server) (2350) may receive UE information (2310) from the map application server of the UE's map application (2300) (e.g., Google Maps server) via an API.

### UE Speed and Trajectory-Based BS Decisions

In accordance with an embodiment, a BS (for example, a BS as described above in conjunction with FIGS. 3 and/or 6) may predict situations such as high/low UE mobility based on a UE's (for example, a UE as described above in conjunction with FIGS. 2 and/or 5) speed and/or trajectory information. BS may predict a high/low UE mobility situation, based on a traffic situation in the BS's cell coverage at the predicted future location determined based on a UE's speed and/or trajectory information (using a Positioning Module at BS). BS may determine the traffic situation using a live traffic map such as Google Maps or Apple Maps and the average speed of other UEs at the predicted location. Based on the prediction of high/low UE mobility situation, BS may transmit signaling to a UE indicating one or more parameters such as, for example, resource scheduling information, MIMO parameters (such as, for example, number of layers, number of antenna ports, or number of codewords), Modulation and Coding Scheme, Bandwidth part(s), UE Transmit Power, waveform type (CP-OFDM or DFST-s-OFDM), numerology/sub-carrier spacing, and/or information of UE transmit/receive Beam pairs. UE may receive the updated signaling, extract received parameters, and use the extracted parameter in UE's transmit/receive operation with a BS. Updated signaling may be received on the physical layer, MAC layer or RRC layer.

In accordance with an embodiment, BS (for example, a BS as described above in conjunction with FIGS. 3 and/or 6) may predict situations such as line of sight (LOS)/non-line of sight (NLOS) based on the UE (for example, a UE as described above in conjunction with FIGS. 2 and/or 5) speed and/or trajectory information. A BS may predict a non-line of sight (NLOS) situation based on determination of structures such as, for example, buildings, forest, tunnels, underpass, or mountains, in the BS's cell coverage at the predicted future location determined based on the UE's speed and/or trajectory information (using a Positioning Module at BS). Based on the prediction of the line of sight (LOS)/non-line of sight (NLOS) situations, BS may transmit updated signaling to UE indicating one or more parameters such as, for example, resource scheduling information, MIMO parameters (such as, for example, number of layers, number of antenna ports, number of codewords), Modulation and Coding Scheme, Bandwidth part(s), UE Transmit Power, waveform type (CP-OFDM or DFST-s-OFDM), numerology/sub-carrier spacing, and/or information of UE transmit/receive Beam pairs. A UE may receive the updated signaling, extract the received parameters, and use the extracted parameter in UE's transmit/receive operation with the BS. Signaling may be received on the physical layer, MAC layer or RRC layer.

In accordance with an embodiment, a BS (for example, a BS as described above in conjunction with FIGS. 3 and/or 6) may predict situations such as high/low interference based on UE (for example, a UE as described above in conjunction with FIGS. 2 and/or 5) speed, and/or trajectory information. A BS may predict an interference situation based on number of other UEs at the predicted future location determined based on the UE's speed and/or trajectory information (using a Positioning Module at BS). Based on the prediction of high/low interference situation, a BS may transmit updated signaling to UE indicating one or more parameters such as, for example, resource scheduling information, MIMO parameters (such as, for example, number of layers, number of antenna ports, or number of codewords), Modulation and Coding Scheme, Bandwidth part(s), UE Transmit Power, waveform type (CP-OFDM or DFST-s-OFDM), numerology/sub-carrier spacing, and/or information of UE transmit/receive Beam pairs. A UE may receive the signaling, extract the received parameters, and use the extracted parameter in UE's transmit/receive operation with the BS. Signaling may be received on the physical layer, MAC layer or RRC layer.

In accordance with an embodiment, a BS (for example, a BS as described above in conjunction with FIGS. 3 and/or 6) may predict situations such as good/bad coverage based on the UE (for example, a UE as described above in conjunction with FIGS. 2 and/or 5) speed and/or trajectory information. A BS may predict a good/bad coverage situation based on the historical signal strength received at other UEs in the BS's cell coverage at the predicted future location determined based on the UE's speed and/or trajectory information (using a Positioning Module at BS). Based on the prediction of good/bad coverage situation, a BS may transmit updated signaling to a UE indicating one or more parameters such as, for example, resource scheduling information, MIMO parameters (such as, for example, number of layers, number of antenna ports, or number of codewords), Modulation and Coding Scheme, Bandwidth part(s), UE Transmit Power, waveform type (CP-OFDM or DFST-s-OFDM), numerology/sub-carrier spacing, and/or information of UE transmit/receive Beam pairs. A UE may receive updated signaling, extract the received parameters, and use the extracted parameter in UE's transmit/receive operation with a BS. Updated signaling may be received on the physical layer, MAC layer or RRC layer.

What is claimed is:

1. A method performed by a user equipment (UE) comprising:
operating a first AI/ML Model with a first AI/ML Model configuration in the coverage of a first base station (BS1);
transmitting, to the BS1, one or more UE parameters; and
receiving a first signaling by the UE, from the BS1, including information regarding a second AI/ML Model configuration;
wherein the first signaling is transmitted by the BS1 based on the determination of a potential handover of the UE from the coverage of the BS1 to the coverage of the BS2;
wherein the determination of handover is made based on the UE parameters; and
wherein the one or more UE parameters include UE speed, UE location, UE trajectory information, signal quality of BS1, and signal quality of a second base station (BS2).

2. The method of claim 1, wherein the information regarding the second AI/ML Model configuration includes a second AI/ML Model configuration identifier.

3. The method of claim 1, wherein the first signaling is received in a handover command message.

4. A method performed by a user equipment (UE) comprising:
operating a first AI/ML Model with a first AI/ML Model configuration in the coverage of a first base station (BS1);
transmitting, to the BS1, one or more UE parameters;
receiving a first signaling by the UE, from the BS1, including information regarding handover to the second base station (BS2); wherein the first signaling is transmitted by the BS1 based on the determination of a potential handover of the UE from the coverage of BS1 to the coverage of a second base station (BS2); wherein the determination of handover is made based on the UE parameters; wherein the one or more UE parameters include UE speed, UE location, UE trajectory information, signal quality of BS1, and signal quality of a second base station (BS2);
transmitting by the UE, to the BS2, PRACH; and
receiving a second signaling by the UE, from the BS2, including information regarding a second AI/ML Model configuration.

5. The method of claim 4, wherein the information regarding the second AI/ML Model configuration includes a second AI/ML Model configuration identifier.

6. The method of claim 4, wherein the first signaling is received in a handover command message.

7. An apparatus comprising:
an AI/ML Engine configured to operate a first AI/ML Model with a first AI/ML Model configuration in the coverage of a first base station (BS1);
a transceiver configured to transmit, to the BS1, one or more UE parameters; wherein the one or more UE parameters include UE speed, UE location, UE trajectory information, signal quality of BS1, and signal quality of a second base station (BS2);
the transceiver configured to receive a first signaling, from the BS1, including information regarding a second AI/ML Model configuration;
wherein the first signaling is transmitted by the BS1 based on the determination of a potential handover of the UE from the coverage of the BS1 to the coverage of the BS2;
wherein the determination of handover is made based on the UE parameters.

8. The method of claim 7, wherein the information regarding the second AI/ML Model configuration includes a second AI/ML Model configuration identifier.

9. The method of claim 7, wherein the first signaling is received in a handover command message.

10. An apparatus comprising:
an AI/ML Engine configured to operate a first AI/ML Model with a first AI/ML Model configuration in the coverage of a first base station (BS1);
a transceiver configured to transmit, to the BS1, one or more UE parameters; wherein the one or more UE parameters include UE speed, UE location, UE trajectory information, signal quality of BS1, and signal quality of a second base station (BS2);
the transceiver configured to receive a first signaling, from the BS1, including handover information to the second base station (BS2); wherein the first signaling is transmitted by the BS1 based on the determination of a potential handover of the UE from the coverage of BS1 to the coverage of a second base station (BS2); wherein the determination of handover is made based on the UE parameters;
the transceiver configured to transmit, to the BS2, PRACH; and
receiving a second signaling, from the BS2, including information regarding a second AI/ML Model configuration.

11. The method of claim 10, wherein the information regarding the second AI/ML Model configuration includes a second AI/ML Model configuration identifier.

12. The method of claim 10, wherein the first signaling is received in a handover command message.
